(19) United States
(12) Patent Application Publication
(10) Pub. No.: US 2026/0052292 A1
(43) Pub. Date: Feb. 19, 2026

(54) PROVIDING MOODSCAPES AND OTHER MEDIA EXPERIENCES

(71) Applicant: Sonos, Inc., Goleta, CA (US)

(72) Inventors: Dayn Wilberding, Portland, OR (US); Shilpa Sarode, Cambridge, MA (US); Adam Kumpf, Delaware, OH (US)

(21) Appl. No.: 19/370,227

(22) Filed: Oct. 27, 2025

Related U.S. Application Data
(63) Continuation of application No. PCT/US2024/026459, filed on Apr. 26, 2024.
(60) Provisional application No. 63/498,609, filed on Apr. 27, 2023.

(51) Int. Cl. H04N 21/472; G06F 3/16; H04N 21/437; H04N 21/45

(52) U.S. Cl. CPC H04N 21/47202; G06F 3/165; H04N 21/437; H04N 21/4516

(57) ABSTRACT

Systems and methods for moodscape sharing via a media playback system are provided. One or more moodscape input parameters are received from a social media provider. Based on the one or more moodscape input parameters and one or more system characteristics of the media playback system, the one or more moodscape input parameters are mapped to one or more playback device outputs of the media playback system. The media playback system then causes one or more playback devices to play back content based on the playback device outputs.

### CROSS-REFERENCE TO RELATED APPLICATIONS

This application is a continuation of International Application No. PCT/US2024/026459, filed Apr. 26, 2024, which claims the benefit of priority to U.S. Patent Application No. 63/498,609, filed Apr. 27, 2023, each of which is incorporated herein by reference in its entirety.

### FIELD OF THE DISCLOSURE

The present disclosure is related to consumer goods and, more particularly, to methods, systems, products, features, services, and other elements directed to media playback or some aspect thereof.

### BACKGROUND

Options for accessing and listening to digital audio in an out-loud setting were limited until in 2002, when SONOS, Inc. began development of a new type of playback system. Sonos then filed one of its first patent applications in 2003, entitled “Method for Synchronizing Audio Playback between Multiple Networked Devices,” and began offering its first media playback systems for sale in 2005. The Sonos Wireless Home Sound System enables people to experience music from many sources via one or more networked playback devices. Through a software control application installed on a controller (e.g., smartphone, tablet, computer, voice input device), one can play what she wants in any room having a networked playback device. Media content (e.g., songs, podcasts, video sound) can be streamed to playback devices such that each room with a playback device can play back corresponding different media content. In addition, rooms can be grouped together for synchronous playback of the same media content, and/or the same media content can be heard in all rooms synchronously.

### BRIEF DESCRIPTION OF THE DRAWINGS

Features, aspects, and advantages of the presently disclosed technology may be better understood with regard to the following description, appended claims, and accompanying drawings, as listed below. A person skilled in the relevant art will understand that the features shown in the drawings are for purposes of illustrations, and variations, including different and/or additional features and arrangements thereof, are possible.

FIG. 1A is a partial cutaway view of an environment having a media playback system configured in accordance with aspects of the disclosed technology.

FIG. 1B is a schematic diagram of the media playback system of FIG. 1A and one or more networks.

FIG. 1C is a block diagram of a playback device.

FIG. 1D is a block diagram of a playback device.

FIG. 1E is a block diagram of a network microphone device.

FIG. 1F is a block diagram of a network microphone device.

FIG. 1G is a block diagram of a playback device.

FIG. 1H is a partially schematic diagram of a control device.

FIGS. 1I through 1L are schematic diagrams of corresponding media playback system zones.

FIG. 1M is a schematic diagram of media playback system areas.

FIG. 2A is a front isometric view of a playback device configured in accordance with aspects of the disclosed technology.

FIG. 2B is a front isometric view of the playback device of FIG. 3A without a grille.

FIG. 2C is an exploded view of the playback device of FIG. 2A.

FIG. 3A is a front view of a network microphone device configured in accordance with aspects of the disclosed technology.

FIG. 3B is a side isometric view of the network microphone device of FIG. 3A.

FIG. 3C is an exploded view of the network microphone device of FIGS. 3A and 3B.

FIG. 3D is an enlarged view of a portion of FIG. 3B.

FIG. 3E is a block diagram of the network microphone device of FIGS. 3A-3D

FIG. 3F is a schematic diagram of an example voice input.

FIGS. 4A-4D are schematic diagrams of a control device in various stages of operation in accordance with aspects of the disclosed technology.

FIG. 5 is a front view of a control device.

FIG. 6 is a message flow diagram of a media playback system.

FIG. 7A shows an example system configured for wireless streaming of audio/visual content according to some embodiments.

FIG. 7B shows an example system configured for wireless streaming of audio/visual content according to some embodiments.

FIG. 8 shows an example system configured for wireless streaming of audio/visual content according to some embodiments.

FIG. 9 shows an example system configured for wireless streaming of audio/visual content according to some embodiments.

FIG. 10 is a schematic view of a media playback environment for sharing moodscapes.

FIG. 11 illustrates an example method for processing a subscription request received from a user.

FIG. 12 illustrates an example method for broadcasting content and parameters.

FIG. 13 illustrates an example method for receiving content and parameters and configuring associated playback devices.

FIG. 14 is a table diagram representing mappings, between provider devices and/or parameters and a user's devices, which can be used, for example, to determine which parameter values should be sent to which user systems.

FIG. 15 is a functional block diagram of a system for playback of generative media content in accordance with examples of the present technology.

FIG. 16 is a functional block diagram for a generative media module in accordance with aspects of the present technology.

FIG. 17 is an example architecture for storing and retrieving generative media content in accordance with aspects of the present technology.

FIG. 18 is a functional block diagram illustrating data exchange in a system for playback of generative media content in accordance with aspects of the present technology.

FIG. 19 is a schematic diagram of an example distributed generative media playback system in accordance with aspects of the present technology.

FIG. 20 is a schematic diagram of another example distributed generative media playback system in accordance with aspects of the present technology.

FIGS. 21-26 are flow diagrams of methods for playback of generative media content in accordance with aspects of the present technology.

The drawings are for the purpose of illustrating example embodiments, but those of ordinary skill in the art will understand that the technology disclosed herein is not limited to the arrangements and/or instrumentality shown in the drawings.

### DETAILED DESCRIPTION

### I. Overview

Social media systems allow “providers,” such as celebrities, athletes, gamers, artists, family members, friends, museums, sports teams, etc., an unprecedented ability to grant access to fans, enthusiasts, family members, friends, etc. (“users” or “subscribers”) all over the world into the provider's day-to-day activities, life events, and so on. In conventional social media systems, however, this information is typically highly curated and may not provide users with any insight into what the provider is currently experiencing, in terms of particular content, a particular environment, and/or moment in time. Rather than seeing an INSTAGRAM image or a TIKTOK video, a user or subscriber may instead wish to tailor aspects of her particular environment(s) (e.g., sights, sounds, scents, etc.) and/or media playback to what the provider (e.g., friend, celebrity, athlete) is currently experiencing.

The disclosed playback devices, media playback systems, and/or methods improve upon conventional social media systems by providing a moodscape sharing system to tailor a user or subscriber's environment to match (or more closely match) the social media provider's environment, such as the social media provider's current environment or the social media provider's environment when a piece of content (e.g., audio, video, gaming, and/or extended reality (augmented reality (AR), virtual reality (VR), mixed reality (MR)), and so on) was consumed, created, or shared by the provider. For example, information about a provider's environment and the provider's emotional state (aspects of the provider's environment and emotional state and underlying content corresponding to the provider's “moodscape”) while listening to a new or favorite album can be recorded and/or shared with subscribers so that the provider's moodscape can be recreated for the user at a remote location, such as the user's home, vehicle, etc.

In some examples, a user can subscribe to receive access to certain content and/or parameters associated with one or more moods, environments, ambiences, etc. (i.e., “moodscapes”) of a particular provider. In some examples, the content includes media content to which the provider is currently listening and/or viewing or otherwise consuming or interacting with. For instance, the underlying media content may include a track, album, playlist, queue, podcast, video clip, generative visuals, movie, television show, streaming video content, etc. that the provider is listening to and/or viewing at a particular time. Moodscape parameters may include indications of the provider's mood, physical state, etc., and/or content the provider is consuming and/or generating, etc. In some examples, the moodscape parameters include contextual or environmental data relating to the provider's environment. In certain examples, for instance, the contextual or environment can comprise multisensory environmental factors such as light or scent. In this way, the provider's environment can be recreated or at least partially simulated, and the provider's mood at least partially ascertained by users in particular user locations remote from the provider's location.

In some examples, one or more first systems at a provider location, can coordinate the detection, collection, and/or transmission of moodscape parameters at the provider location. One or more second systems at a user's location can receive the content and parameters and map them to particular available devices at the user's location. For instance, a celebrity may be listening to a particular playlist, in a room with a particular temperature and/or humidity level, and with a particular light setting, aromas, etc. This information can be identified and captured in real-time by a variety of sensors and/or accessed directly via an interface of the device(s) that generate or alter those conditions. For example, the one or more first systems at the provider location, such as a playback device, lighting system or light sensor, scent generator system, and so on can provide information about the playlist, the currently playing song, and parameters related to the current environment. In some examples, one or more systems may also capture information about the provider herself, such as her mood, emotional state, physical state, etc. After this information is captured, the information can be made available to subscribers by, for example, sending this information directly to subscribers, sending this information to a moodscape sharing system for storage and/or transmission to subscribers, and so on. In some examples, a user can obtain or purchase a subscription to a provider's moodscape. After the user's subscription status is verified, she can receive provider data including, for instance, parameters indicative of the provider's condition, the provider's current environment, content the provider is consuming and/or generating, and so on.

In some embodiments, for example, the disclosed media playback system comprises one or more playback devices, at least one network interface, at least one processor, and data storage having instructions stored thereon that, when executed by the one or more processors, cause the media playback system to perform operations. These operations may comprise receiving, via the at least one network interface, one or more moodscape input parameters. Based on the one or more moodscape input parameters and one or more system characteristics of the media playback system, the one or more moodscape input parameters are mapped to one or more playback device outputs. Furthermore, the one or more playback devices of the media playback system are caused to play back content based on the playback device outputs.

In some embodiments, multiple playback device outputs may be mapped to a single device or parameter provided by a provider. For example, a user may have multiple playback devices for simulating lighting in the user's environment based on lighting in the provider's environment, such as a number of smart light bulb, a television, a computer monitor, and so on. In these cases, a user system may distribute responsibility for simulating the provider's environment in any number of ways. For example, the user system may synchronize the various playback devices, so they mirror each other or otherwise illuminate with the same color, brightness, etc. simultaneously. As another example, the user system may send the lighting parameters to lighting devices that are in the same room as the user or that are otherwise within a predetermined proximity from the user (e.g., 10 feet, 15 feet, etc.) using, for example, GPS, proximity, or other location data while ignoring the other devices. In some cases, the provider may include positional or directional information for one or more parameters that the user system can use as a basis for adjusting the user's environment by, for example, sending lighting parameters to devices based on their direction from the user and/or position relative to the user. In this manner, the user system's approximation of the provider's environment can be improved over time.

In some embodiments, the user's system may include one or more sensors that can be used to monitor the user's environment as it is being used to simulate the provider's environment. Accordingly, the user system can measure how closely the user's environment is to the provider's environment and make adjustments to improve the simulation over time. For example, a provider's lighting settings, audio volume setting, humidity settings, etc. may change the provider's environment in one way but the same setting may have a more drastic or less drastic effect in the user's environment due to, for example, the size, composition, number of people in the environment, etc. Accordingly, the user system can change (e.g., increase or decrease) intensity levels periodically to more closely match the provider's environment. If, for example, the provider's stereo volume is set to 7 out of 10 then the volume of an audio device in the user's environment may be set to 70 out of 100. However, if a sensor in the provider's environment is reading a sound intensity of 75 decibels at or near the provider while a sensor in the user's environment is reading a sound intensity of 65 decibels at our near the user, the user system may increase the volume in the user's environment until the sensor in the user's environment reads a sound intensity of (or closer to) 75 decibels. Similarly, a user system can use sensors in the user's system to monitor other conditions and adjust accordingly. In some cases, the user system may set and store an “adjustment factor” (e.g., absolute difference, percentage, etc.) when these adjustments are made that can be retrieved and applied when simulating a provider's environment. In this manner, the user system can improve its ability to simulate a provider's environment over time. Furthermore, a user may set maximum “adjustment factors” or levels for one or more parameters or devices to accommodate user or environmental concerns (e.g., to prevent the volume from going above a user's (or user's neighbor's) comfort level).

While some examples described herein may refer to functions performed by given actors such as “users,” “listeners,” and/or other entities, it should be understood that this is for purposes of explanation only. The claims should not be interpreted to require action by any such example actor unless explicitly required by the language of the claims themselves.

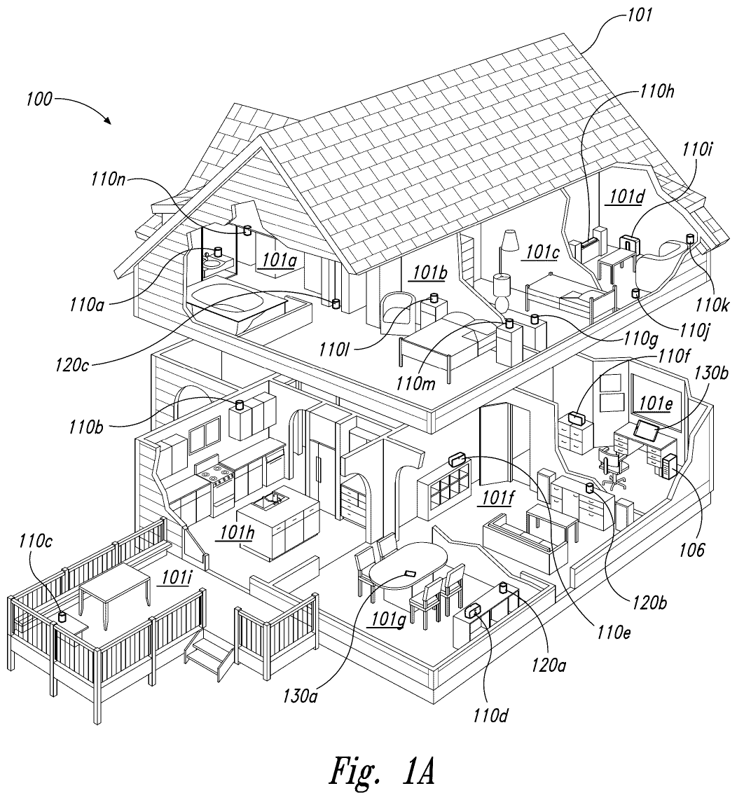

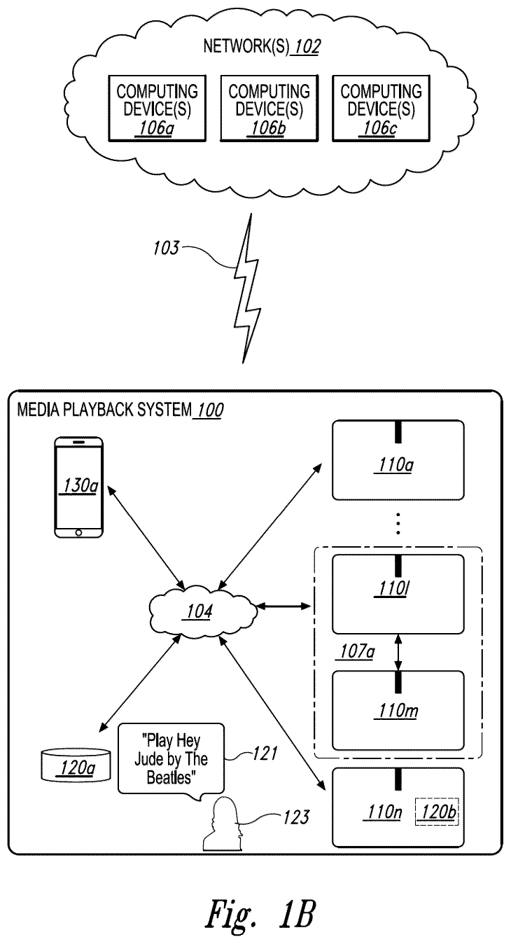

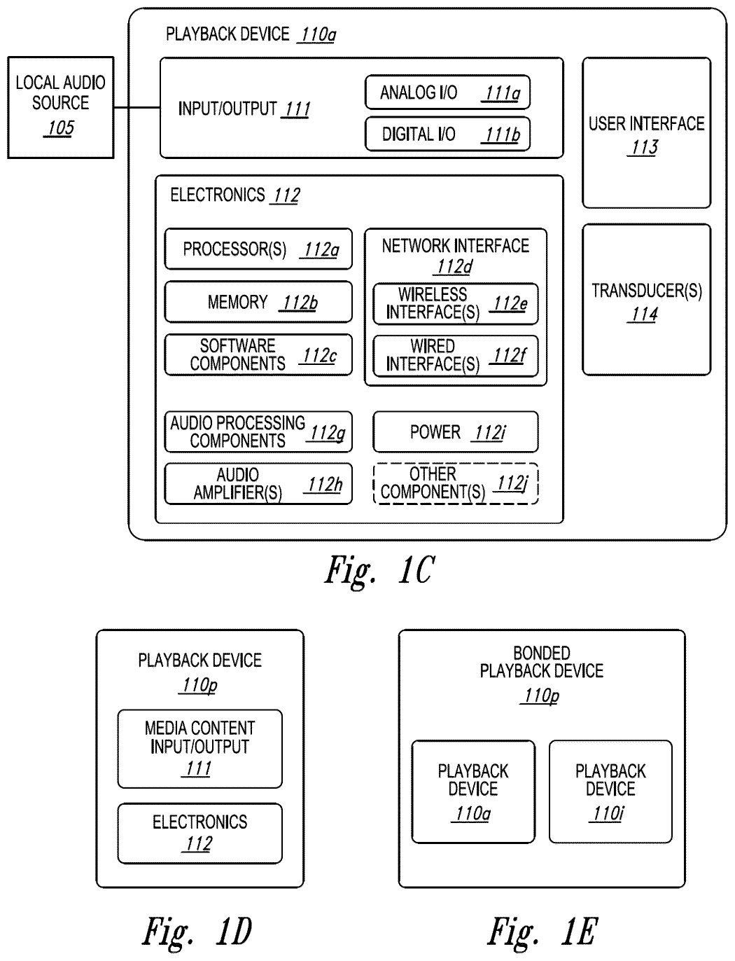

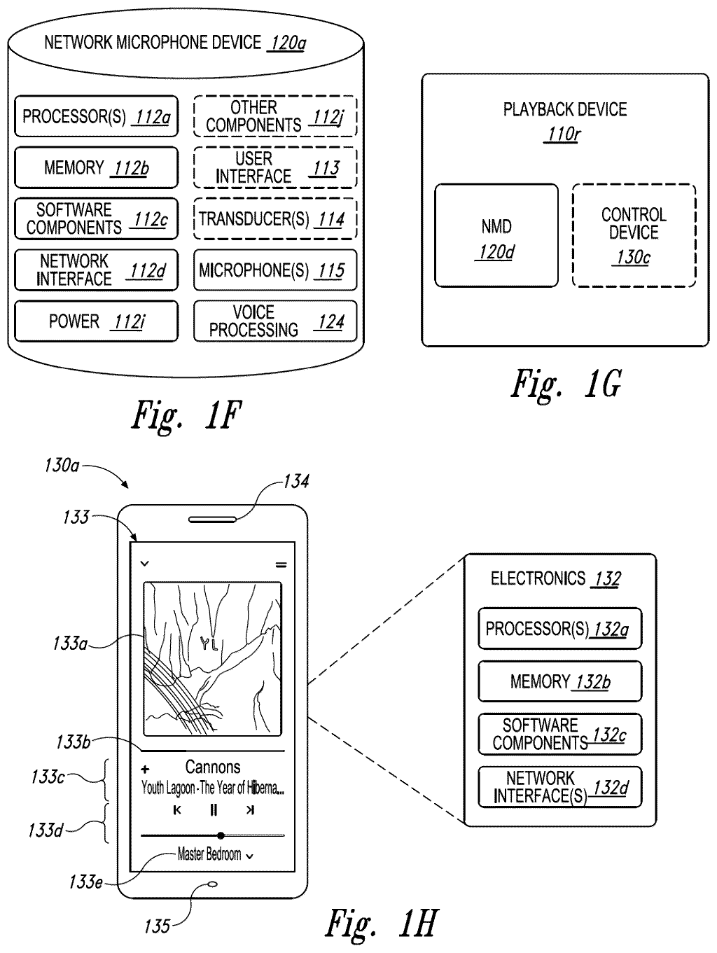

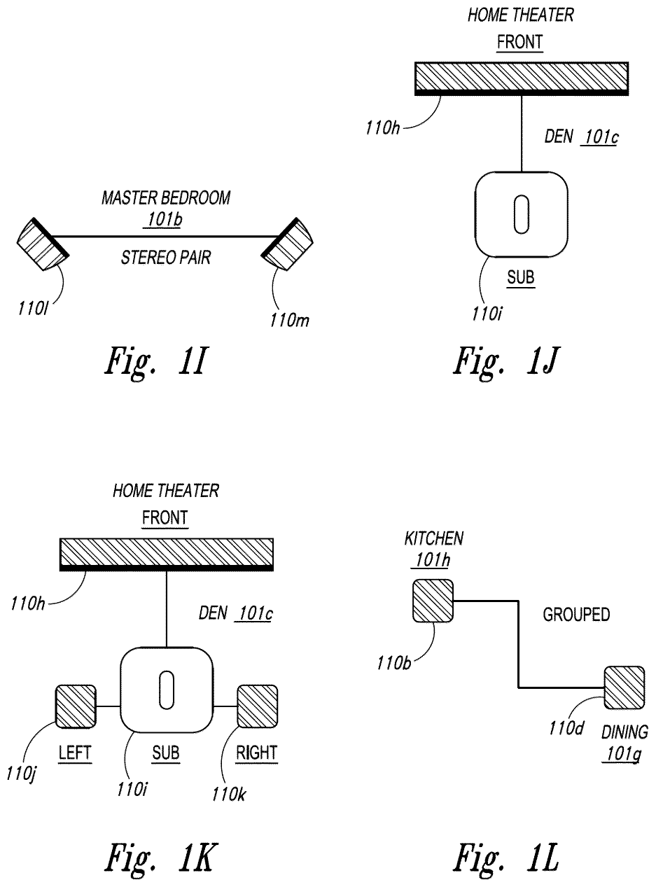

In the Figures, identical reference numbers identify generally similar, and/or identical, elements. To facilitate the discussion of any particular element, the most significant digit or digits of a reference number refers to the Figure in which that element is first introduced. For example, element 110a is first introduced and discussed with reference to FIG. 1A. Many of the details, dimensions, angles, and other features shown in the Figures are merely illustrative of particular embodiments of the disclosed technology. Accordingly, other embodiments can have other details, dimensions, angles, and features without departing from the spirit or scope of the disclosure. In addition, those of ordinary skill in the art will appreciate that further embodiments of the various disclosed technologies can be practiced without several of the details described below.

Generative media content is content that is dynamically synthesized, created, and/or modified based on an algorithm, whether implemented in software or a physical model. The generative media content can change over time based on the algorithm alone or in conjunction with contextual data (e.g., user sensor data, environmental sensor data, occurrence data). In various examples, such generative media content can include generative audio (e.g., music, ambient soundscapes, etc.), generative visual imagery (e.g., lighting, abstract visual designs that dynamically change shape, color, etc.), generative scent, generative tactile output (e.g., vibrations, haptic output, etc.), or any other suitable media content or combination thereof. As explained elsewhere herein, generative media can be created at least in part via an algorithm and/or non human system that utilizes a rule-based calculation to produce novel media content.

Because generative media content can be dynamically modified in real-time, it enables unique user experiences that are not available using conventional media playback of pre-recorded content. For example, generative audio can be endless and/or dynamic audio that is varied as inputs (e.g., input parameters associated with user input, sensor data, media source data, or any other suitable input data) to the algorithm change. In some examples, generative audio can be used to direct a user's mood toward a desired emotional state, with one or more characteristics of the generative audio varying in response to real-time measurements reflective of the user's emotional state. As used in examples of the present technology, the system can provide generative audio based on the current and/or desired emotional states of a user, based on a user's activity level, based on the number of users present within an environment, or any other suitable input parameter.

As another example, generative audio can be created and/or modified based on one or more inputs, such as a user's location, or activity, the number of users present in a room, time of day, or any other input (e.g., as determined by one or more sensors or by a user input). For example, when a single user is sitting at her desk in a calm state, the media playback system may automatically produce generative audio content suitable for focused study or work, whereas when multiple users are present in a room in an excited state with lots of movement, the same media playback system may automatically produce generative audio suitable for a social gathering or dance party. In various examples, audio characteristics that can be dynamically modified for producing generative audio can include selection of audio samples or clips, tempo, bass/treble/mid-range volume, spatial filtering of audio output, or any other suitable audio characteristics. The audio characteristics may be changed by using different tones or sounds, timing of the tones or sounds, and/or audio samples that may have the desired qualities. In some instances, characteristics may be changed by filtering or modulating playback of content as well, such as equalization, phase, or reverb/delay. During the listening experience, the audio characteristics of the generative music can be changed based on a number of inputs, such as time of day, geographic location, weather, or various user inputs, such as inferred mood, collective level of activity, or physiological inputs such as heart rate or the like.

In some instances, generative media content such as a soundscape can be associated with data stored in one or more blockchain databases and/or layers. A non-fungible token (NFT), for instance, generally comprises a data file stored on a blockchain that is associated with a digital or tangible asset (e.g., a song or album, visual artwork, literary work). While the NFT may refer to a digital work of art, for example, the NFT itself does not generally include the digital artwork itself since the file sizes required may be unwieldy (or too costly) to store on a blockchain layer. Instead, the NFT may comprise metadata (e.g., a URL or other locator) pointing to where the digital artwork is located and/or how to access the artwork. In various examples, an NFT or other data stored via a blockchain or other distributed ledger technology can be used for media content creation. For instance, in some examples an NFT serves as an input to a generative media engine, such that the resulting generative media content has properties that depend at least in part on the particular NFT or other blockchain data.

### II. Suitable Operating Environment

FIG. 1A is a partial cutaway view of a media playback system 100 distributed in an environment 101 (e.g., a house). The media playback system 100 comprises one or more playback devices 110 (identified individually as playback devices 110a-n), one or more network microphone devices (“NMDs”), 120 (identified individually as NMDs 120a-c), and one or more control devices 130 (identified individually as control devices 130a and 130b).

As used herein the term “playback device” can generally refer to an output device configured to receive, process, and output data of a media playback system. For example, a playback device can be a network device that receives and processes audio content. In some embodiments, a playback device includes one or more transducers or speakers powered by one or more amplifiers. As another example, a playback device can comprise and/or be integrated into an extended reality device (e.g., an augmented, virtual, and/or mixed reality device), a device or system for controlling climate, such as a humidifier or thermostat, a vehicle or vehicle subsystem, a scent generator, a lighting device or system, a video display, and so on. In some embodiments the playback device includes one of (or neither of) the speaker and the amplifier. For instance, a playback device can comprise one or more amplifiers configured to drive one or more speakers external to the playback device via a corresponding wire or cable.

Moreover, as used herein the term NMD (i.e., a “network microphone device”) can generally refer to a network device that is configured for audio detection. In some embodiments, an NMD is a stand-alone device configured primarily for audio detection. In other embodiments, an NMD is incorporated into a playback device (or vice versa).

The term “control device” can generally refer to a network device configured to perform functions relevant to facilitating user access, control, and/or configuration of the media playback system 100.

Each of the playback devices 110 is configured to receive audio signals or data from one or more media sources (e.g., one or more remote servers, one or more local devices) and play back the received audio signals or data as sound. The one or more NMDs 120 are configured to receive spoken word commands, and the one or more control devices 130 are configured to receive user input. In response to the received spoken word commands and/or user input, the media playback system 100 can play back audio via one or more of the playback devices 110. In certain embodiments, the playback devices 110 are configured to commence playback of media content in response to a trigger. For instance, one or more of the playback devices 110 can be configured to play back a morning playlist upon detection of an associated trigger condition (e.g., presence of a user in a kitchen, detection of a coffee machine operation). In some embodiments, for example, the media playback system 100 is configured to play back audio from a first playback device (e.g., the playback device 100a) in synchrony with a second playback device (e.g., the playback device 100b). Interactions between the playback devices 110, NMDs 120, and/or control devices 130 of the media playback system 100 configured in accordance with the various embodiments of the disclosure are described in greater detail below with respect to FIGS. 1B-6.

In the illustrated embodiment of FIG. 1A, the environment 101 comprises a household having several rooms, spaces, and/or playback zones, including (clockwise from upper left) a master bathroom 101a, a master bedroom 101b, a second bedroom 101c, a family room or den 101d, an office 101e, a living room 101f, a dining room 101g, a kitchen 101h, and an outdoor patio 101i. While certain embodiments and examples are described below in the context of a home environment, the technologies described herein may be implemented in other types of environments. In some embodiments, for example, the media playback system 100 can be implemented in one or more commercial settings (e.g., a restaurant, mall, airport, hotel, a retail or other store), one or more vehicles (e.g., a sports utility vehicle, bus, car, a ship, a boat, an airplane), multiple environments (e.g., a combination of home and vehicle environments), and/or another suitable environment where multi-zone audio may be desirable.

The media playback system 100 can comprise one or more playback zones, some of which may correspond to the rooms in the environment 101. The media playback system 100 can be established with one or more playback zones, after which additional zones may be added, or removed to form, for example, the configuration shown in FIG. 1A. Each zone may be given a name according to a different room or space such as the office 101e, master bathroom 101a, master bedroom 101b, the second bedroom 101c, kitchen 101h, dining room 101g, living room 101f, and/or the balcony 101i. In some aspects, a single playback zone may include multiple rooms or spaces. In certain aspects, a single room or space may include multiple playback zones.

In the illustrated embodiment of FIG. 1A, the master bathroom 101a, the second bedroom 101c, the office 101e, the living room 101f, the dining room 101g, the kitchen 101h, and the outdoor patio 101i each include one playback device 110, and the master bedroom 101b and the den 101d include a plurality of playback devices 110. In the master bedroom 101b, the playback devices 110l and 110m may be configured, for example, to play back audio content in synchrony as individual ones of playback devices 110, as a bonded playback zone, as a consolidated playback device, and/or any combination thereof. Similarly, in the den 101d, the playback devices 110h-j can be configured, for instance, to play back audio content in synchrony as individual ones of playback devices 110, as one or more bonded playback devices, and/or as one or more consolidated playback devices. Additional details regarding bonded and consolidated playback devices are described below with respect to FIGS. 1B, 1E, and 1I-1M.

In some aspects, one or more of the playback zones in the environment 101 may each be playing different audio content. For instance, a user may be grilling on the patio 101i and listening to hip hop music being played by the playback device 110c while another user is preparing food in the kitchen 101h and listening to classical music played by the playback device 110b. In another example, a playback zone may play the same audio content in synchrony with another playback zone. For instance, the user may be in the office 101e listening to the playback device 110f playing back the same hip hop music being played back by playback device 110c on the patio 101i. In some aspects, the playback devices 110c and 110f play back the hip hop music in synchrony such that the user perceives that the audio content is being played seamlessly (or at least substantially seamlessly) while moving between different playback zones. Additional details regarding audio playback synchronization among playback devices and/or zones can be found, for example, in U.S. Pat. No. 8,234,395 entitled, “System and method for synchronizing operations among a plurality of independently clocked digital data processing devices,” which is incorporated herein by reference in its entirety.

a. Suitable Media Playback System

FIG. 1B is a schematic diagram of the media playback system 100 and a cloud network 102. For ease of illustration, certain devices of the media playback system 100 and the cloud network 102 are omitted from FIG. 1B. One or more communication links 103 (referred to hereinafter as “the links 103”) communicatively couple the media playback system 100 and the cloud network 102.

The links 103 can comprise, for example, one or more wired networks, one or more wireless networks, one or more wide area networks (WAN), one or more local area networks (LAN), one or more personal area networks (PAN), one or more telecommunication networks (e.g., one or more Global System for Mobiles (GSM) networks, Code Division Multiple Access (CDMA) networks, Long-Term Evolution (LTE) networks, 5G communication network networks, and/or other suitable data transmission protocol networks), etc. The cloud network 102 is configured to deliver media content (e.g., audio content, video content, photographs, social media content) to the media playback system 100 in response to a request transmitted from the media playback system 100 via the links 103. In some embodiments, the cloud network 102 is further configured to receive data (e.g., voice input data) from the media playback system 100 and correspondingly transmit commands and/or media content to the media playback system 100.

The cloud network 102 comprises computing devices 106 (identified separately as a first computing device 106a, a second computing device 106b, and a third computing device 106c). The computing devices 106 can comprise individual computers or servers, such as, for example, a media streaming service server storing audio and/or other media content, a voice service server, a social media server, a media playback system control server, etc. In some embodiments, one or more of the computing devices 106 comprise modules of a single computer or server. In certain embodiments, one or more of the computing devices 106 comprise one or more modules, computers, and/or servers. Moreover, while the cloud network 102 is described above in the context of a single cloud network, in some embodiments the cloud network 102 comprises a plurality of cloud networks comprising communicatively coupled computing devices. Furthermore, while the cloud network 102 is shown in FIG. 1B as having three of the computing devices 106, in some embodiments, the cloud network 102 comprises fewer (or more than) three computing devices 106.

The media playback system 100 is configured to receive media content from the networks 102 via the links 103. The received media content can comprise, for example, a Uniform Resource Identifier (URI) and/or a Uniform Resource Locator (URL). For instance, in some examples, the media playback system 100 can stream, download, or otherwise obtain data from a URI or a URL corresponding to the received media content. A network 104 communicatively couples the links 103 and at least a portion of the devices (e.g., one or more of the playback devices 110, NMDs 120, and/or control devices 130) of the media playback system 100. The network 104 can include, for example, a wireless network (e.g., a WiFi network, a Bluetooth, a Z-Wave network, a ZigBee, and/or other suitable wireless communication protocol network) and/or a wired network (e.g., a network comprising Ethernet, Universal Serial Bus (USB), and/or another suitable wired communication). As those of ordinary skill in the art will appreciate, as used herein, “WiFi” can refer to several different communication protocols including, for example, Institute of Electrical and Electronics Engineers (IEEE) 802.11a, 802.11b, 802.11g, 802.11n, 802.11ac, 802.11ac, 802.11ad, 802.11af, 802.11ah, 802.11ai, 802.11aj, 802.11aq, 802.11ax, 802.11ay, 802.15, etc. transmitted at 2.4 Gigahertz (GHz), 5 GHz, and/or another suitable frequency.

In some embodiments, the network 104 comprises a dedicated communication network that the media playback system 100 uses to transmit messages between individual devices and/or to transmit media content to and from media content sources (e.g., one or more of the computing devices 106). In certain embodiments, the network 104 is configured to be accessible only to devices in the media playback system 100, thereby reducing interference and competition with other household devices. In other embodiments, however, the network 104 comprises an existing household communication network (e.g., a household WiFi network). In some embodiments, the links 103 and the network 104 comprise one or more of the same networks. In some aspects, for example, the links 103 and the network 104 comprise a telecommunication network (e.g., an LTE network, a 5G network). Moreover, in some embodiments, the media playback system 100 is implemented without the network 104, and devices comprising the media playback system 100 can communicate with each other, for example, via one or more direct connections, PANs, telecommunication networks, and/or other suitable communication links.

In some embodiments, audio content sources may be regularly added or removed from the media playback system 100. In some embodiments, for example, the media playback system 100 performs an indexing of media items when one or more media content sources are updated, added to, and/or removed from the media playback system 100. The media playback system 100 can scan identifiable media items in some or all folders and/or directories accessible to the playback devices 110, and generate or update a media content database comprising metadata (e.g., title, artist, album, track length) and other associated information (e.g., URIs, URLs) for each identifiable media item found. In some embodiments, for example, the media content database is stored on one or more of the playback devices 110, network microphone devices 120, and/or control devices 130.

In the illustrated embodiment of FIG. 1B, the playback devices 110l and 110m comprise a group 107a. The playback devices 110l and 110m can be positioned in different rooms in a household and be grouped together in the group 107a on a temporary or permanent basis based on user input received at the control device 130a and/or another control device 130 in the media playback system 100. When arranged in the group 107a, the playback devices 110l and 110m can be configured to play back the same or similar audio content in synchrony from one or more audio content sources. In certain embodiments, for example, the group 107a comprises a bonded zone in which the playback devices 110l and 110m comprise left audio and right audio channels, respectively, of multi-channel audio content, thereby producing or enhancing a stereo effect of the audio content. In some embodiments, the group 107a includes additional playback devices 110. In other embodiments, however, the media playback system 100 omits the group 107a and/or other grouped arrangements of the playback devices 110. Additional details regarding groups and other arrangements of playback devices are described in further detail below with respect to FIGS. 1-I through IM.

The media playback system 100 includes the NMDs 120a and 120d, each comprising one or more microphones configured to receive voice utterances from a user. In the illustrated embodiment of FIG. 1B, the NMD 120a is a standalone device and the NMD 120d is integrated into the playback device 110n. The NMD 120a, for example, is configured to receive voice input 121 from a user 123. In some embodiments, the NMD 120a transmits data associated with the received voice input 121 to a voice assistant service (VAS) configured to (i) process the received voice input data and (ii) transmit a corresponding command to the media playback system 100. In some aspects, for example, the computing device 106c comprises one or more modules and/or servers of a VAS (e.g., a VAS operated by one or more of SONOS®, AMAZON®, GOOGLE® APPLE®, MICROSOFT®). The computing device 106c can receive the voice input data from the NMD 120a via the network 104 and the links 103. In response to receiving the voice input data, the computing device 106c processes the voice input data (i.e., “Play Hey Jude by The Beatles”), and determines that the processed voice input includes a command to play a song (e.g., “Hey Jude”). The computing device 106c accordingly transmits commands to the media playback system 100 to play back “Hey Jude” by the Beatles from a suitable media service (e.g., via one or more of the computing devices 106) on one or more of the playback devices 110.

b. Suitable Playback Devices

FIG. 1C is a block diagram of the playback device 110a comprising an input/output 111. The input/output 111 can include an analog I/O 111a (e.g., one or more wires, cables, and/or other suitable communication links configured to carry analog signals) and/or a digital I/O 111b (e.g., one or more wires, cables, or other suitable communication links configured to carry digital signals). In some embodiments, the analog I/O 111a is an audio line-in input connection comprising, for example, an auto-detecting 3.5 mm audio line-in connection. In some embodiments, the digital I/O 111b comprises a Sony/Philips Digital Interface Format (S/PDIF) communication interface and/or cable and/or a Toshiba Link (TOSLINK) cable. In some embodiments, the digital I/O 111b comprises an High-Definition Multimedia Interface (HDMI) interface and/or cable. In some embodiments, the digital I/O 111b includes one or more wireless communication links comprising, for example, a radio frequency (RF), infrared, WiFi, Bluetooth, or another suitable communication protocol. In certain embodiments, the analog I/O 111a and the digital 111b comprise interfaces (e.g., ports, plugs, jacks) configured to receive connectors of cables transmitting analog and digital signals, respectively, without necessarily including cables.

The playback device 110a, for example, can receive media content (e.g., audio content comprising music and/or other sounds) from a local audio source 105 via the input/output 111 (e.g., a cable, a wire, a PAN, a Bluetooth connection, an ad hoc wired or wireless communication network, and/or another suitable communication link). The local audio source 105 can comprise, for example, a mobile device (e.g., a smartphone, a tablet, a laptop computer) or another suitable audio component (e.g., a television, a desktop computer, an amplifier, a phonograph, a Blu-ray player, a memory storing digital media files). In some aspects, the local audio source 105 includes local music libraries on a smartphone, a computer, a networked-attached storage (NAS), and/or another suitable device configured to store media files. In certain embodiments, one or more of the playback devices 110, NMDs 120, and/or control devices 130 comprise the local audio source 105. In other embodiments, however, the media playback system omits the local audio source 105 altogether. In some embodiments, the playback device 110a does not include an input/output 111 and receives all audio content via the network 104.

The playback device 110a further comprises electronics 112, a user interface 113 (e.g., one or more buttons, knobs, dials, touch-sensitive surfaces, displays, touchscreens), and one or more transducers 114 (referred to hereinafter as “the transducers 114”). The electronics 112 is configured to receive audio from an audio source (e.g., the local audio source 105) via the input/output 111, one or more of the computing devices 106a-c via the network 104 (FIG. 1B)), amplify the received audio, and output the amplified audio for playback via one or more of the transducers 114. In some embodiments, the playback device 110a optionally includes one or more microphones 115 (e.g., a single microphone, a plurality of microphones, a microphone array) (hereinafter referred to as “the microphones 115”). In certain embodiments, for example, the playback device 110a having one or more of the optional microphones 115 can operate as an NMD configured to receive voice input from a user and correspondingly perform one or more operations based on the received voice input.

In the illustrated embodiment of FIG. 1C, the electronics 112 comprise one or more processors 112a (referred to hereinafter as “the processors 112a”), memory 112b, software components 112c, a network interface 112d, one or more audio processing components 112g (referred to hereinafter as “the audio components 112g”), one or more audio amplifiers 112h (referred to hereinafter as “the amplifiers 112h”), and power 112i (e.g., one or more power supplies, power cables, power receptacles, batteries, induction coils, Power-over Ethernet (POE) interfaces, and/or other suitable sources of electric power). In some embodiments, the electronics 112 optionally include one or more other components 112j (e.g., one or more sensors, video displays, touchscreens, battery charging bases).

The processors 112a can comprise clock-driven computing component(s) configured to process data, and the memory 112b can comprise a computer-readable medium (e.g., a tangible, non-transitory computer-readable medium, data storage loaded with one or more of the software components 112c) configured to store instructions for performing various operations and/or functions. The processors 112a are configured to execute the instructions stored on the memory 112b to perform one or more of the operations. The operations can include, for example, causing the playback device 110a to retrieve audio data from an audio source (e.g., one or more of the computing devices 106a-c (FIG. 1B)), and/or another one of the playback devices 110. In some embodiments, the operations further include causing the playback device 110a to send audio data to another one of the playback devices 110a and/or another device (e.g., one of the NMDs 120). Certain embodiments include operations causing the playback device 110a to pair with another of the one or more playback devices 110 to enable a multi-channel audio environment (e.g., a stereo pair, a bonded zone).

The processors 112a can be further configured to perform operations causing the playback device 110a to synchronize playback of audio content with another of the one or more playback devices 110. As those of ordinary skill in the art will appreciate, during synchronous playback of audio content on a plurality of playback devices, a listener will preferably be unable to perceive time-delay differences between playback of the audio content by the playback device 110a and the other one or more other playback devices 110. Additional details regarding audio playback synchronization among playback devices can be found, for example, in U.S. Pat. No. 8,234,395, which was incorporated by reference above.

In some embodiments, the memory 112b is further configured to store data associated with the playback device 110a, such as one or more zones and/or zone groups of which the playback device 110a is a member, audio sources accessible to the playback device 110a, and/or a playback queue that the playback device 110a (and/or another of the one or more playback devices) can be associated with. The stored data can comprise one or more state variables that are periodically updated and used to describe a state of the playback device 110a. The memory 112b can also include data associated with a state of one or more of the other devices (e.g., the playback devices 110, NMDs 120, control devices 130) of the media playback system 100. In some aspects, for example, the state data is shared during predetermined intervals of time (e.g., every 5 seconds, every 10 seconds, every 60 seconds) among at least a portion of the devices of the media playback system 100, so that one or more of the devices have the most recent data associated with the media playback system 100.

The network interface 112d is configured to facilitate a transmission of data between the playback device 110a and one or more other devices on a data network such as, for example, the links 103 and/or the network 104 (FIG. 1B). The network interface 112d is configured to transmit and receive data corresponding to media content (e.g., audio content, video content, text, photographs) and other signals (e.g., non-transitory signals) comprising digital packet data including an Internet Protocol (IP)-based source address and/or an IP-based destination address. The network interface 112d can parse the digital packet data such that the electronics 112 properly receives and processes the data destined for the playback device 110a.

In the illustrated embodiment of FIG. 1C, the network interface 112d comprises one or more wireless interfaces 112e (referred to hereinafter as “the wireless interface 112e”). The wireless interface 112e (e.g., a suitable interface comprising one or more antennae) can be configured to wirelessly communicate with one or more other devices (e.g., one or more of the other playback devices 110, NMDs 120, and/or control devices 130) that are communicatively coupled to the network 104 (FIG. 1B) in accordance with a suitable wireless communication protocol (e.g., WiFi, Bluetooth, LTE). In some embodiments, the network interface 112d optionally includes a wired interface 112f (e.g., an interface or receptacle configured to receive a network cable such as an Ethernet, a USB-A, USB-C, and/or Thunderbolt cable) configured to communicate over a wired connection with other devices in accordance with a suitable wired communication protocol. In certain embodiments, the network interface 112d includes the wired interface 112f and excludes the wireless interface 112e. In some embodiments, the electronics 112 excludes the network interface 112d altogether and transmits and receives media content and/or other data via another communication path (e.g., the input/output 111).

The audio components 112g are configured to process and/or filter data comprising media content received by the electronics 112 (e.g., via the input/output 111 and/or the network interface 112d) to produce output audio signals. In some embodiments, the audio processing components 112g comprise, for example, one or more digital-to-analog converters (DAC), audio preprocessing components, audio enhancement components, a digital signal processors (DSPs), and/or other suitable audio processing components, modules, circuits, etc. In certain embodiments, one or more of the audio processing components 112g can comprise one or more subcomponents of the processors 112a. In some embodiments, the electronics 112 omits the audio processing components 112g. In some aspects, for example, the processors 112a execute instructions stored on the memory 112b to perform audio processing operations to produce the output audio signals.

The amplifiers 112h are configured to receive and amplify the audio output signals produced by the audio processing components 112g and/or the processors 112a. The amplifiers 112h can comprise electronic devices and/or components configured to amplify audio signals to levels sufficient for driving one or more of the transducers 114. In some embodiments, for example, the amplifiers 112h include one or more switching or class-D power amplifiers. In other embodiments, however, the amplifiers include one or more other types of power amplifiers (e.g., linear gain power amplifiers, class-A amplifiers, class-B amplifiers, class-AB amplifiers, class-C amplifiers, class-D amplifiers, class-E amplifiers, class-F amplifiers, class-G and/or class H amplifiers, and/or another suitable type of power amplifier). In certain embodiments, the amplifiers 112h comprise a suitable combination of two or more of the foregoing types of power amplifiers. Moreover, in some embodiments, individual ones of the amplifiers 112h correspond to individual ones of the transducers 114. In other embodiments, however, the electronics 112 includes a single one of the amplifiers 112h configured to output amplified audio signals to a plurality of the transducers 114. In some other embodiments, the electronics 112 omits the amplifiers 112h.

The transducers 114 (e.g., one or more speakers and/or speaker drivers) receive the amplified audio signals from the amplifier 112h and render or output the amplified audio signals as sound (e.g., audible sound waves having a frequency between about 20 Hertz (Hz) and 20 kilohertz (kHz)). In some embodiments, the transducers 114 can comprise a single transducer. In other embodiments, however, the transducers 114 comprise a plurality of audio transducers. In some embodiments, the transducers 114 comprise more than one type of transducer. For example, the transducers 114 can include one or more low frequency transducers (e.g., subwoofers, woofers), mid-range frequency transducers (e.g., mid-range transducers, mid-woofers), and one or more high frequency transducers (e.g., one or more tweeters). As used herein, “low frequency” can generally refer to audible frequencies below about 500 Hz, “mid-range frequency” can generally refer to audible frequencies between about 500 Hz and about 2 kHz, and “high frequency” can generally refer to audible frequencies above 2 kHz. In certain embodiments, however, one or more of the transducers 114 comprise transducers that do not adhere to the foregoing frequency ranges. For example, one of the transducers 114 may comprise a mid-woofer transducer configured to output sound at frequencies between about 200 Hz and about 5 kHz.

By way of illustration, SONOS, Inc. presently offers (or has offered) for sale certain playback devices including, for example, a “SONOS ONE,” “PLAY: 1,” “PLAY: 3,” “PLAY: 5,” “PLAYBAR,” “PLAYBASE,” “CONNECT: AMP,” “CONNECT,” and “SUB.” Other suitable playback devices may additionally or alternatively be used to implement the playback devices of example embodiments disclosed herein. Additionally, one of ordinary skilled in the art will appreciate that a playback device is not limited to the examples described herein or to SONOS product offerings. In some embodiments, for example, one or more playback devices 110 comprises wired or wireless headphones (e.g., over-the-ear headphones, on-ear headphones, in-ear earphones). In other embodiments, one or more of the playback devices 110 comprise a docking station and/or an interface configured to interact with a docking station for personal mobile media playback devices. In certain embodiments, a playback device may be integral to another device or component such as a television, a lighting fixture, or some other device for indoor or outdoor use. In some embodiments, a playback device omits a user interface and/or one or more transducers. For example, FIG. 1D is a block diagram of a playback device 110p comprising the input/output 111 and electronics 112 without the user interface 113 or transducers 114.

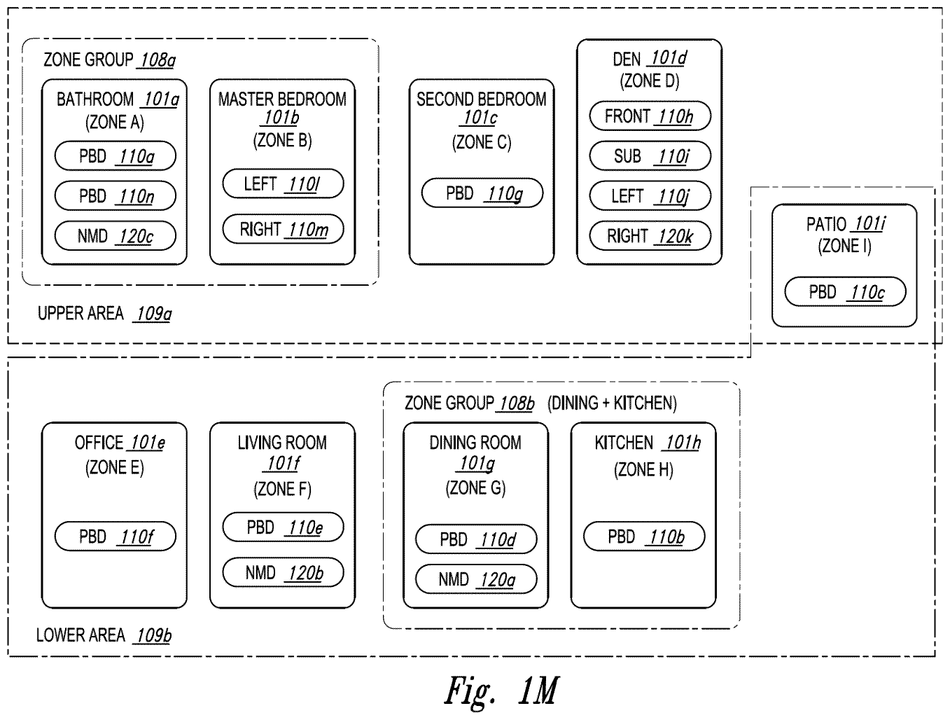

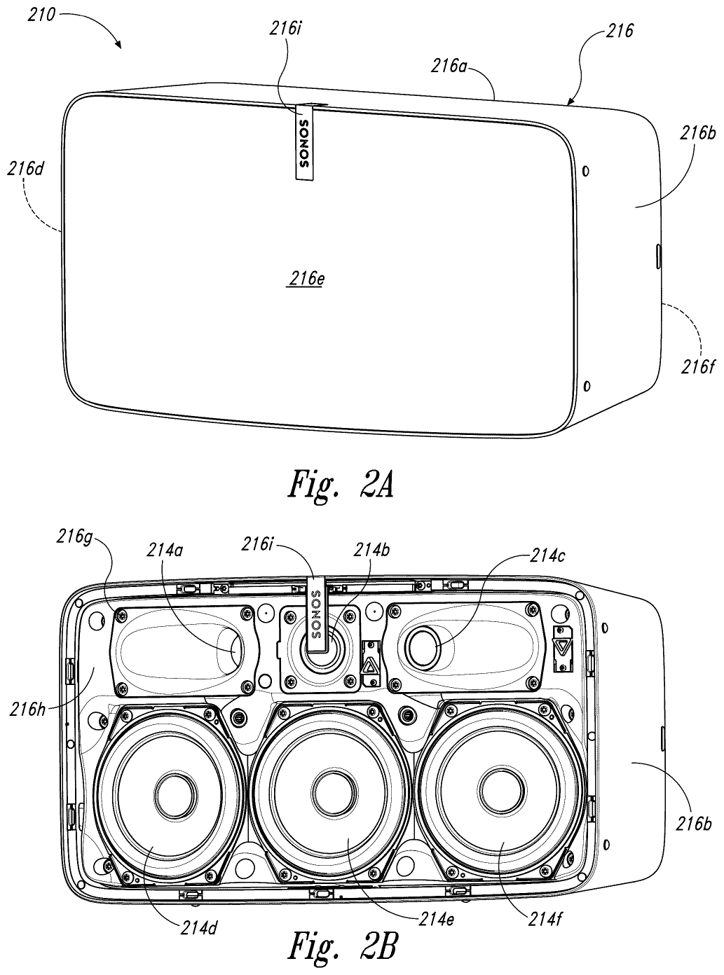

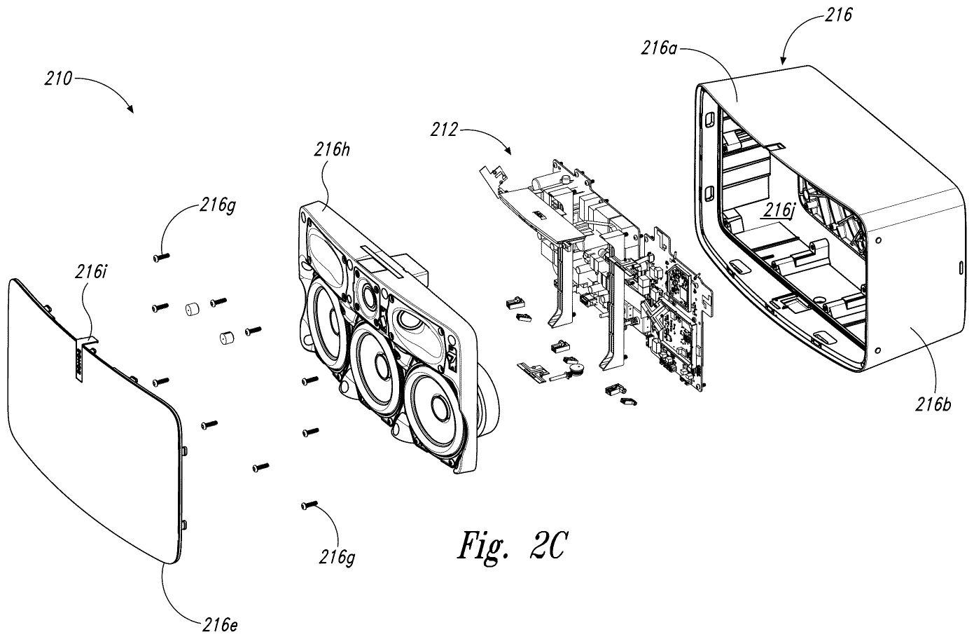

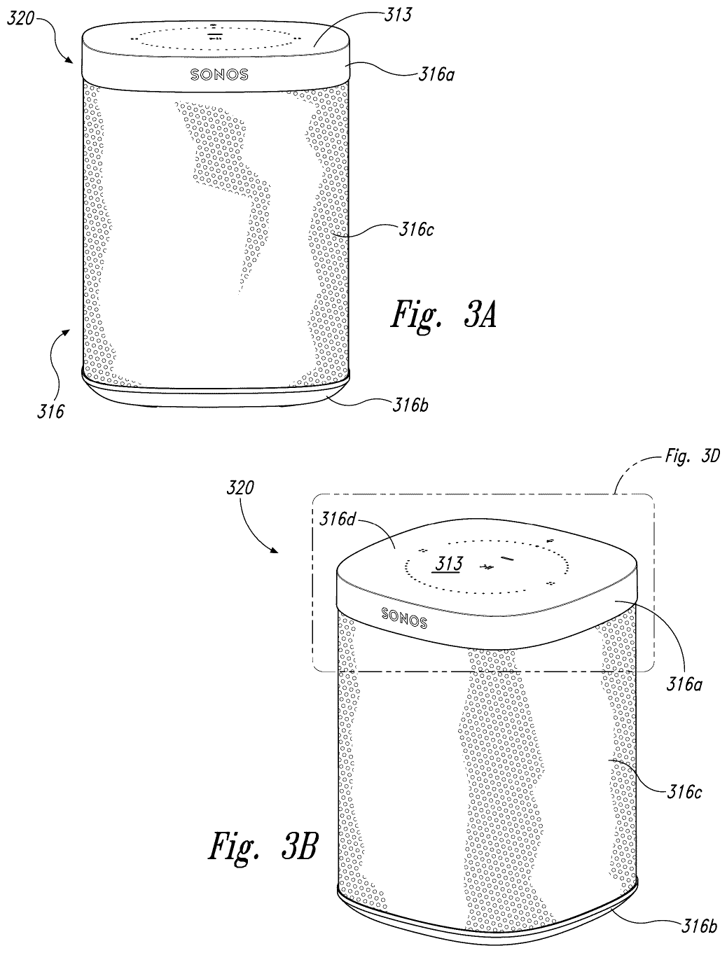

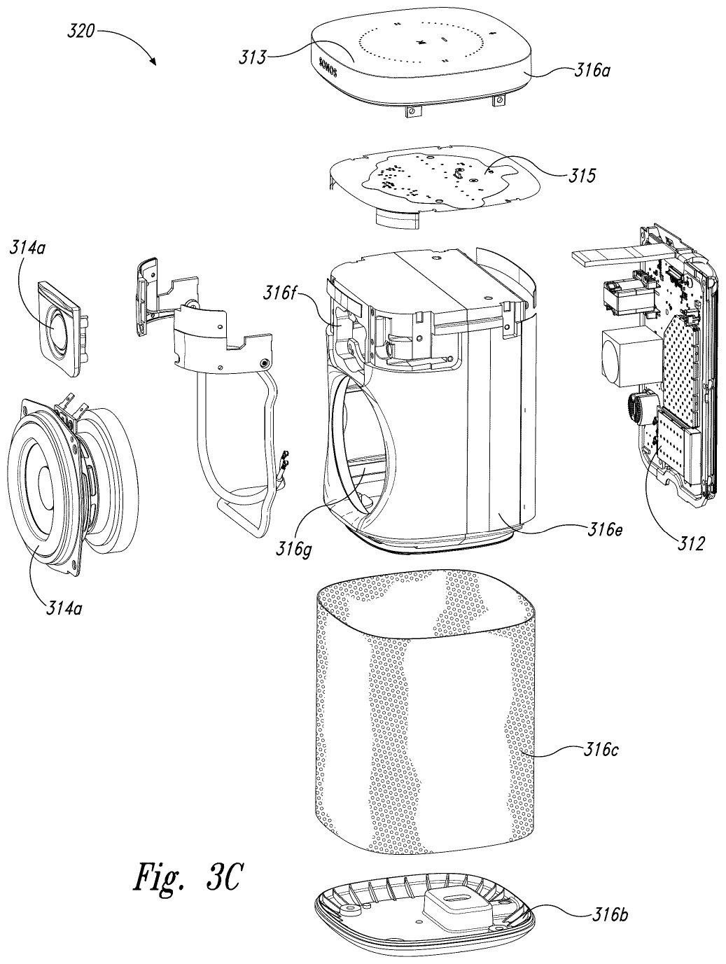

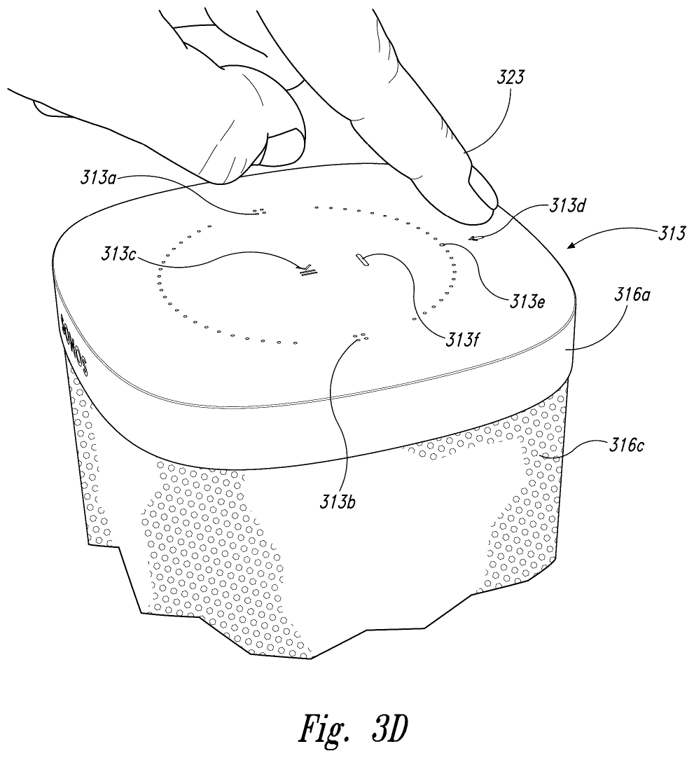

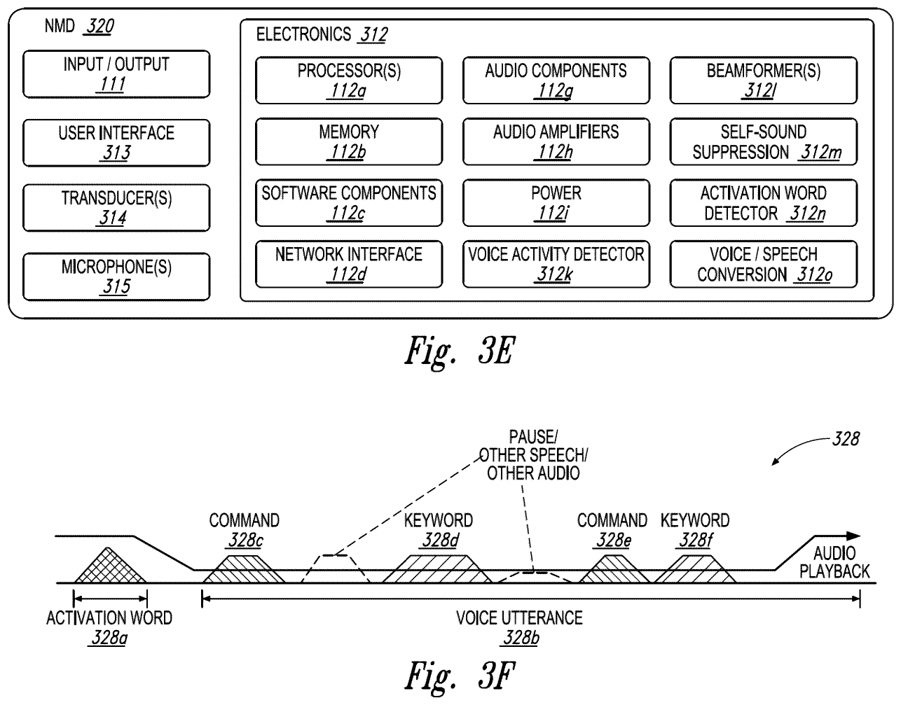

FIG. 1E is a block diagram of a bonded playback device 110q comprising the playback device 110a (FIG. 1C) sonically bonded with the playback device 110i (e.g., a subwoofer) (FIG. 1A). In the illustrated embodiment, the playback devices 110a and 110i are separate ones of the playback devices 110 housed in separate enclosures. In some embodiments, however, the bonded playback device 110q comprises a single enclosure housing both the playback devices 110a and 110i. The bonded playback device 110q can be configured to process and reproduce sound differently than an unbonded playback device (e.g., the playback device 110a of FIG. 1C) and/or paired or bonded playback devices (e.g., the playback devices 110l and 110m of FIG. 1B). In some embodiments, for example, the playback device 110a is full-range playback device configured to render low frequency, mid-range frequency, and high frequency audio content, and the playback device 110i is a subwoofer configured to render low frequency audio content. In some aspects, the playback device 110a, when bonded with the first playback device, is configured to render only the mid-range and high frequency components of a particular audio content, while the playback device 110i renders the low frequency component of the particular audio content. In some embodiments, the bonded playback device 110q includes additional playback devices and/or another bonded playback device. Additional playback device embodiments are described in further detail below with respect to FIGS. 2A-3D.

c. Suitable Network Microphone Devices (NMDs)

FIG. 1F is a block diagram of the NMD 120a (FIGS. 1A and 1B). The NMD 120a includes one or more voice processing components 124 (hereinafter “the voice components 124”) and several components described with respect to the playback device 110a (FIG. 1C) including the processors 112a, the memory 112b, and the microphones 115. The NMD 120a optionally comprises other components also included in the playback device 110a (FIG. 1C), such as the user interface 113 and/or the transducers 114. In some embodiments, the NMD 120a is configured as a media playback device (e.g., one or more of the playback devices 110), and further includes, for example, one or more of the audio components 112g (FIG. 1C), the amplifiers 114, and/or other playback device components. In certain embodiments, the NMD 120a comprises an Internet of Things (IoT) device such as, for example, a thermostat, alarm panel, fire and/or smoke detector, etc. In some embodiments, the NMD 120a comprises the microphones 115, the voice processing 124, and only a portion of the components of the electronics 112 described above with respect to FIG. 1B. In some aspects, for example, the NMD 120a includes the processor 112a and the memory 112b (FIG. 1B), while omitting one or more other components of the electronics 112. In some embodiments, the NMD 120a includes additional components (e.g., one or more sensors, cameras, thermometers, barometers, hygrometers).

In some embodiments, an NMD can be integrated into a playback device. FIG. 1G is a block diagram of a playback device 110r comprising an NMD 120d. The playback device 110r can comprise many or all of the components of the playback device 110a and further include the microphones 115 and voice processing 124 (FIG. 1F). The playback device 110r optionally includes an integrated control device 130c. The control device 130c can comprise, for example, a user interface (e.g., the user interface 113 of FIG. 1B) configured to receive user input (e.g., touch input, voice input) without a separate control device. In other embodiments, however, the playback device 110r receives commands from another control device (e.g., the control device 130a of FIG. 1B). Additional NMD embodiments are described in further detail below with respect to FIGS. 3A-3F.

Referring again to FIG. 1F, the microphones 115 are configured to acquire, capture, and/or receive sound from an environment (e.g., the environment 101 of FIG. 1A) and/or a room in which the NMD 120a is positioned. The received sound can include, for example, vocal utterances, audio played back by the NMD 120a and/or another playback device, background voices, ambient sounds, etc. The microphones 115 convert the received sound into electrical signals to produce microphone data. The voice processing 124 receives and analyzes the microphone data to determine whether a voice input is present in the microphone data. The voice input can comprise, for example, an activation word followed by an utterance including a user request. As those of ordinary skill in the art will appreciate, an activation word is a word or other audio cue that signifying a user voice input. For instance, in querying the AMAZON® VAS, a user might speak the activation word “Alexa.” Other examples include “Ok, Google” for invoking the GOOGLE® VAS and “Hey, Siri” for invoking the APPLE® VAS.

After detecting the activation word, voice processing 124 monitors the microphone data for an accompanying user request in the voice input. The user request may include, for example, a command to control a third-party device, such as a thermostat (e.g., NEST® thermostat), an illumination device (e.g., a PHILIPS HUE® lighting device), or a media playback device (e.g., a Sonos® playback device). For example, a user might speak the activation word “Alexa” followed by the utterance “set the thermostat to 68 degrees” to set a temperature in a home (e.g., the environment 101 of FIG. 1A). The user might speak the same activation word followed by the utterance “turn on the living room” to turn on illumination devices in a living room area of the home. The user may similarly speak an activation word followed by a request to play a particular song, an album, or a playlist of music on a playback device in the home. Additional description regarding receiving and processing voice input data can be found in further detail below with respect to FIGS. 3A-3F.

d. Suitable Control Devices

FIG. 1H is a partially schematic diagram of the control device 130a (FIGS. 1A and 1B). As used herein, the term “control device” can be used interchangeably with “controller” or “control system.” Among other features, the control device 130a is configured to receive user input related to the media playback system 100 and, in response, cause one or more devices in the media playback system 100 to perform an action(s) or operation(s) corresponding to the user input. In the illustrated embodiment, the control device 130a comprises a smartphone (e.g., an iPhone™ an Android phone) on which media playback system controller application software is installed. In some embodiments, the control device 130a comprises, for example, a tablet (e.g., an iPad™), a computer (e.g., a laptop computer, a desktop computer), and/or another suitable device (e.g., a television, an automobile audio head unit, an IoT device). In certain embodiments, the control device 130a comprises a dedicated controller for the media playback system 100. In other embodiments, as described above with respect to FIG. 1G, the control device 130a is integrated into another device in the media playback system 100 (e.g., one more of the playback devices 110, NMDs 120, and/or other suitable devices configured to communicate over a network).

The control device 130a includes electronics 132, a user interface 133, one or more speakers 134, and one or more microphones 135. The electronics 132 comprise one or more processors 132a (referred to hereinafter as “the processors 132a”), a memory 132b, software components 132c, and a network interface 132d. The processor 132a can be configured to perform functions relevant to facilitating user access, control, and configuration of the media playback system 100. The memory 132b can comprise data storage that can be loaded with one or more of the software components executable by the processor 302 to perform those functions. The software components 132c can comprise applications and/or other executable software configured to facilitate control of the media playback system 100. The memory 112b can be configured to store, for example, the software components 132c, media playback system controller application software, and/or other data associated with the media playback system 100 and the user.

The network interface 132d is configured to facilitate network communications between the control device 130a and one or more other devices in the media playback system 100, and/or one or more remote devices. In some embodiments, the network interface 132 is configured to operate according to one or more suitable communication industry standards (e.g., infrared, radio, wired standards including IEEE 802.3, wireless standards including IEEE 802.11a, 802.11b, 802.11g, 802.11n, 802.11ac, 802.15, 4G, LTE). The network interface 132d can be configured, for example, to transmit data to and/or receive data from the playback devices 110, the NMDs 120, other ones of the control devices 130, one of the computing devices 106 of FIG. 1B, devices comprising one or more other media playback systems, etc. The transmitted and/or received data can include, for example, playback device control commands, state variables, playback zone and/or zone group configurations. For instance, based on user input received at the user interface 133, the network interface 132d can transmit a playback device control command (e.g., volume control, audio playback control, audio content selection) from the control device 304 to one or more of the playback devices 100. The network interface 132d can also transmit and/or receive configuration changes such as, for example, adding/removing one or more playback devices 100 to/from a zone, adding/removing one or more zones to/from a zone group, forming a bonded or consolidated player, separating one or more playback devices from a bonded or consolidated player, among others. Additional description of zones and groups can be found below with respect to FIGS. 1I through 1M.

The user interface 133 is configured to receive user input and can facilitate ‘control of the media playback system 100. The user interface 133 includes media content art 133a (e.g., album art, lyrics, videos), a playback status indicator 133b (e.g., an elapsed and/or remaining time indicator), media content information region 133c, a playback control region 133d, and a zone indicator 133e. The media content information region 133c can include a display of relevant information (e.g., title, artist, album, genre, release year) about media content currently playing and/or media content in a queue or playlist. The playback control region 133d can include selectable (e.g., via touch input and/or via a cursor or another suitable selector) icons to cause one or more playback devices in a selected playback zone or zone group to perform playback actions such as, for example, play or pause, fast forward, rewind, skip to next, skip to previous, enter/exit shuffle mode, enter/exit repeat mode, enter/exit cross fade mode, etc. The playback control region 133d may also include selectable icons to modify equalization settings, playback volume, and/or other suitable playback actions. In the illustrated embodiment, the user interface 133 comprises a display presented on a touch screen interface of a smartphone (e.g., an iPhone™ an Android phone). In some embodiments, however, user interfaces of varying formats, styles, and interactive sequences may alternatively be implemented on one or more network devices to provide comparable control access to a media playback system.

The one or more speakers 134 (e.g., one or more transducers) can be configured to output sound to the user of the control device 130a. In some embodiments, the one or more speakers comprise individual transducers configured to correspondingly output low frequencies, mid-range frequencies, and/or high frequencies. In some aspects, for example, the control device 130a is configured as a playback device (e.g., one of the playback devices 110). Similarly, in some embodiments the control device 130a is configured as an NMD (e.g., one of the NMDs 120), receiving voice commands and other sounds via the one or more microphones 135.

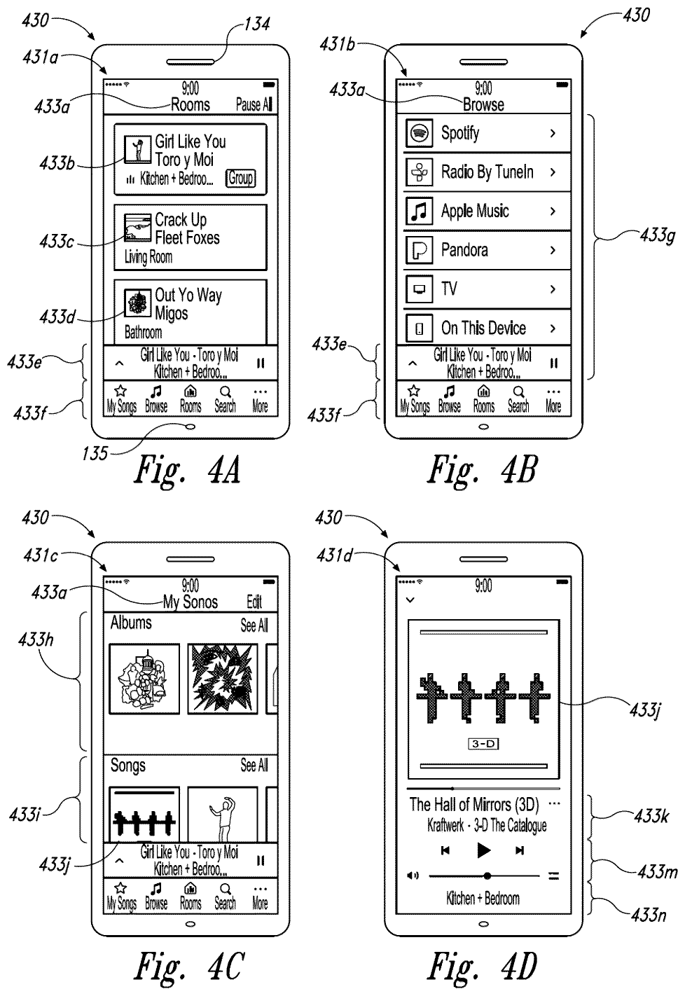

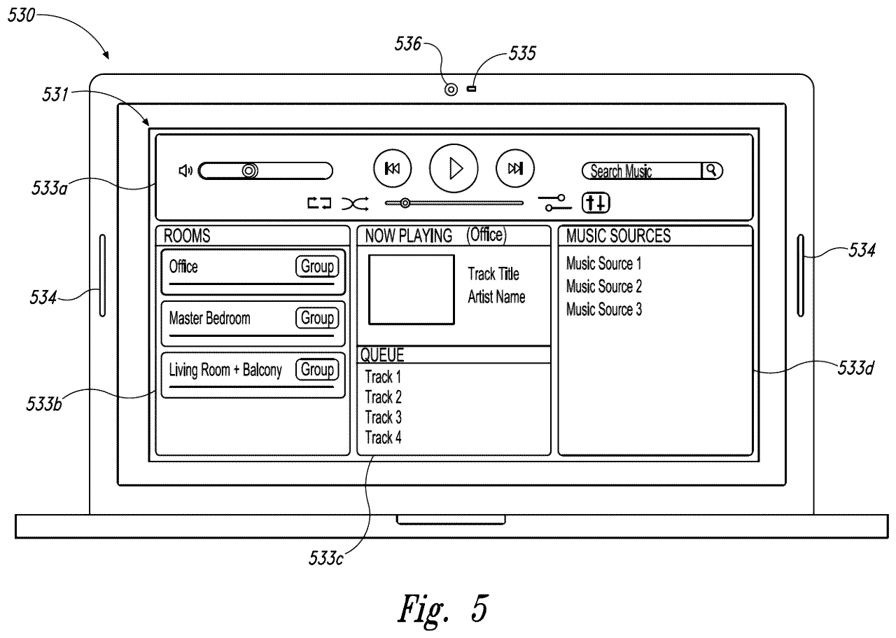

The one or more microphones 135 can comprise, for example, one or more condenser microphones, electret condenser microphones, dynamic microphones, and/or other suitable types of microphones or transducers. In some embodiments, two or more of the microphones 135 are arranged to capture location information of an audio source (e.g., voice, audible sound) and/or configured to facilitate filtering of background noise. Moreover, in certain embodiments, the control device 130a is configured to operate as playback device and an NMD. In other embodiments, however, the control device 130a omits the one or more speakers 134 and/or the one or more microphones 135. For instance, the control device 130a may comprise a device (e.g., a thermostat, an IoT device, a network device) comprising a portion of the electronics 132 and the user interface 133 (e.g., a touch screen) without any speakers or microphones. Additional control device embodiments are described in further detail below with respect to FIGS. 4A-4D and 5.

e. Suitable Playback Device Configurations

FIGS. 1I through 1M show example configurations of playback devices in zones and zone groups. Referring first to FIG. 1M, in one example, a single playback device may belong to a zone. For example, the playback device 110g in the second bedroom 101c (FIG. 1A) may belong to Zone C. In some implementations described below, multiple playback devices may be “bonded” to form a “bonded pair” which together form a single zone. For example, the playback device 110l (e.g., a left playback device) can be bonded to the playback device 110l (e.g., a left playback device) to form Zone A. Bonded playback devices may have different playback responsibilities (e.g., channel responsibilities). In another implementation described below, multiple playback devices may be merged to form a single zone. For example, the playback device 110h (e.g., a front playback device) may be merged with the playback device 110i (e.g., a subwoofer), and the playback devices 110j and 110k (e.g., left and right surround speakers, respectively) to form a single Zone D. In another example, the playback devices 110g and 110h can be merged to form a merged group or a zone group 108b. The merged playback devices 110g and 110h may not be specifically assigned different playback responsibilities. That is, the merged playback devices 110h and 110i may, aside from playing audio content in synchrony, each play audio content as they would if they were not merged.

Each zone in the media playback system 100 may be provided for control as a single user interface (UI) entity. For example, Zone A may be provided as a single entity named Master Bathroom. Zone B may be provided as a single entity named Master Bedroom. Zone C may be provided as a single entity named Second Bedroom.

Playback devices that are bonded may have different playback responsibilities, such as responsibilities for certain audio channels. For example, as shown in FIG. 1-I, the playback devices 110l and 110m may be bonded so as to produce or enhance a stereo effect of audio content. In this example, the playback device 110l may be configured to play a left channel audio component, while the playback device 110k may be configured to play a right channel audio component. In some implementations, such stereo bonding may be referred to as “pairing.”

Additionally, bonded playback devices may have additional and/or different respective speaker drivers. As shown in FIG. 1J, the playback device 110h named Front may be bonded with the playback device 110i named SUB. The Front device 110h can be configured to render a range of mid to high frequencies and the SUB device 110i can be configured render low frequencies. When unbonded, however, the Front device 110h can be configured render a full range of frequencies. As another example, FIG. 1K shows the Front and SUB devices 110h and 110i further bonded with Left and Right playback devices 110j and 110k, respectively. In some implementations, the Right and Left devices 110j and 102k can be configured to form surround or “satellite” channels of a home theater system. The bonded playback devices 110h, 110i, 110j, and 110k may form a single Zone D (FIG. 1M).

Playback devices that are merged may not have assigned playback responsibilities, and may each render the full range of audio content the respective playback device is capable of. Nevertheless, merged devices may be represented as a single UI entity (i.e., a zone, as discussed above). For instance, the playback devices 110a and 110n the master bathroom have the single UI entity of Zone A. In one embodiment, the playback devices 110a and 110n may each output the full range of audio content each respective playback devices 110a and 110n are capable of, in synchrony.

In some embodiments, an NMD is bonded or merged with another device so as to form a zone. For example, the NMD 120b may be bonded with the playback device 110e, which together form Zone F, named Living Room. In other embodiments, a stand-alone network microphone device may be in a zone by itself. In other embodiments, however, a stand-alone network microphone device may not be associated with a zone. Additional details regarding associating network microphone devices and playback devices as designated or default devices may be found, for example, in previously referenced U.S. patent application Ser. No. 15/438,749.

Zones of individual, bonded, and/or merged devices may be grouped to form a zone group. For example, referring to FIG. 1M, Zone A may be grouped with Zone B to form a zone group 108a that includes the two zones. Similarly, Zone G may be grouped with Zone H to form the zone group 108b. As another example, Zone A may be grouped with one or more other Zones C-I. The Zones A-I may be grouped and ungrouped in numerous ways. For example, three, four, five, or more (e.g., all) of the Zones A-I may be grouped. When grouped, the zones of individual and/or bonded playback devices may play back audio in synchrony with one another, as described in previously referenced U.S. Pat. No. 8,234,395. Playback devices may be dynamically grouped and ungrouped to form new or different groups that synchronously play back audio content.

In various implementations, the zones in an environment may be the default name of a zone within the group or a combination of the names of the zones within a zone group. For example, Zone Group 108b can be assigned a name such as “Dining+Kitchen”, as shown in FIG. 1M. In some embodiments, a zone group may be given a unique name selected by a user.

Certain data may be stored in a memory of a playback device (e.g., the memory 112c of FIG. 1C) as one or more state variables that are periodically updated and used to describe the state of a playback zone, the playback device(s), and/or a zone group associated therewith. The memory may also include the data associated with the state of the other devices of the media system, and shared from time to time among the devices so that one or more of the devices have the most recent data associated with the system.

In some embodiments, the memory may store instances of various variable types associated with the states. Variables instances may be stored with identifiers (e.g., tags) corresponding to type. For example, certain identifiers may be a first type “al” to identify playback device(s) of a zone, a second type “b1” to identify playback device(s) that may be bonded in the zone, and a third type “c1” to identify a zone group to which the zone may belong. As a related example, identifiers associated with the second bedroom 101c may indicate that the playback device is the only playback device of the Zone C and not in a zone group. Identifiers associated with the Den may indicate that the Den is not grouped with other zones but includes bonded playback devices 110h-110k. Identifiers associated with the Dining Room may indicate that the Dining Room is part of the Dining+Kitchen zone group 108b and that devices 110b and 110d are grouped (FIG. 1L). Identifiers associated with the Kitchen may indicate the same or similar information by virtue of the Kitchen being part of the Dining+Kitchen zone group 108b. Other example zone variables and identifiers are described below.

In yet another example, the media playback system 100 may variables or identifiers representing other associations of zones and zone groups, such as identifiers associated with Areas, as shown in FIG. 1M. An area may involve a cluster of zone groups and/or zones not within a zone group. For instance, FIG. 1M shows an Upper Area 109a including Zones A-D, and a Lower Area 109b including Zones E-I. In one aspect, an Area may be used to invoke a cluster of zone groups and/or zones that share one or more zones and/or zone groups of another cluster. In another aspect, this differs from a zone group, which does not share a zone with another zone group. Further examples of techniques for implementing Areas may be found, for example, in U.S. application Ser. No. 15/682,506 filed Aug. 21, 2017 and titled “Room Association Based on Name,” and U.S. Pat. No. 8,483,853 filed Sep. 11, 2007, and titled “Controlling and manipulating groupings in a multi-zone media system.” Each of these applications is incorporated herein by reference in its entirety. In some embodiments, the media playback system 100 may not implement Areas, in which case the system may not store variables associated with Areas.

### III. Example Systems and Devices

FIG. 2A is a front isometric view of a playback device 210 configured in accordance with aspects of the disclosed technology. FIG. 2B is a front isometric view of the playback device 210 without a grille 216e. FIG. 2C is an exploded view of the playback device 210. Referring to FIGS. 2A-2C together, the playback device 210 comprises a housing 216 that includes an upper portion 216a, a right or first side portion 216b, a lower portion 216c, a left or second side portion 216d, the grille 216e, and a rear portion 216f. A plurality of fasteners 216g (e.g., one or more screws, rivets, clips) attaches a frame 216h to the housing 216. A cavity 216j (FIG. 2C) in the housing 216 is configured to receive the frame 216h and electronics 212. The frame 216h is configured to carry a plurality of transducers 214 (identified individually in FIG. 2B as transducers 214a-f). The electronics 212 (e.g., the electronics 112 of FIG. 1C) is configured to receive audio content from an audio source and send electrical signals corresponding to the audio content to the transducers 214 for playback.

The transducers 214 are configured to receive the electrical signals from the electronics 112, and further configured to convert the received electrical signals into audible sound during playback. For instance, the transducers 214a-c (e.g., tweeters) can be configured to output high frequency sound (e.g., sound waves having a frequency greater than about 2 kHz). The transducers 214d-f (e.g., mid-woofers, woofers, midrange speakers) can be configured output sound at frequencies lower than the transducers 214a-c (e.g., sound waves having a frequency lower than about 2 kHz). In some embodiments, the playback device 210 includes a number of transducers different than those illustrated in FIGS. 2A-2C. For example, as described in further detail below with respect to FIGS. 3A-3C, the playback device 210 can include fewer than six transducers (e.g., one, two, three). In other embodiments, however, the playback device 210 includes more than six transducers (e.g., nine, ten). Moreover, in some embodiments, all or a portion of the transducers 214 are configured to operate as a phased array to desirably adjust (e.g., narrow or widen) a radiation pattern of the transducers 214, thereby altering a user's perception of the sound emitted from the playback device 210.

In the illustrated embodiment of FIGS. 2A-2C, a filter 216i is axially aligned with the transducer 214b. The filter 216i can be configured to desirably attenuate a predetermined range of frequencies that the transducer 214b outputs to improve sound quality and a perceived sound stage output collectively by the transducers 214. In some embodiments, however, the playback device 210 omits the filter 216i. In other embodiments, the playback device 210 includes one or more additional filters aligned with the transducers 214b and/or at least another of the transducers 214.

FIGS. 3A and 3B are front and right isometric side views, respectively, of an NMD 320 configured in accordance with embodiments of the disclosed technology. FIG. 3C is an exploded view of the NMD 320. FIG. 3D is an enlarged view of a portion of FIG. 3B including a user interface 313 of the NMD 320. Referring first to FIGS. 3A-3C, the NMD 320 includes a housing 316 comprising an upper portion 316a, a lower portion 316b and an intermediate portion 316c (e.g., a grille). A plurality of ports, holes, or apertures 316d in the upper portion 316a allow sound to pass through to one or more microphones 315 (FIG. 3C) positioned within the housing 316. The one or more microphones 316 are configured to received sound via the apertures 316d and produce electrical signals based on the received sound. In the illustrated embodiment, a frame 316e (FIG. 3C) of the housing 316 surrounds cavities 316f and 316g configured to house, respectively, a first transducer 314a (e.g., a tweeter) and a second transducer 314b (e.g., a mid-woofer, a midrange speaker, a woofer). In other embodiments, however, the NMD 320 includes a single transducer, or more than two (e.g., two, five, six) transducers. In certain embodiments, the NMD 320 omits the transducers 314a and 314b altogether.

Electronics 312 (FIG. 3C) includes components configured to drive the transducers 314a and 314b, and further configured to analyze audio data corresponding to the electrical signals produced by the one or more microphones 315. In some embodiments, for example, the electronics 312 comprises many or all of the components of the electronics 112 described above with respect to FIG. 1C. In certain embodiments, the electronics 312 includes components described above with respect to FIG. 1F such as, for example, the one or more processors 112a, the memory 112b, the software components 112c, the network interface 112d, etc. In some embodiments, the electronics 312 includes additional suitable components (e.g., proximity or other sensors).

Referring to FIG. 3D, the user interface 313 includes a plurality of control surfaces (e.g., buttons, knobs, capacitive surfaces) including a first control surface 313a (e.g., a previous control), a second control surface 313b (e.g., a next control), and a third control surface 313c (e.g., a play and/or pause control). A fourth control surface 313d is configured to receive touch input corresponding to activation and deactivation of the one or microphones 315. A first indicator 313e (e.g., one or more light emitting diodes (LEDs) or another suitable illuminator) can be configured to illuminate only when the one or more microphones 315 are activated. A second indicator 313f (e.g., one or more LEDs) can be configured to remain solid during normal operation and to blink or otherwise change from solid to indicate a detection of voice activity. In some embodiments, the user interface 313 includes additional or fewer control surfaces and illuminators. In one embodiment, for example, the user interface 313 includes the first indicator 313e, omitting the second indicator 313f. Moreover, in certain embodiments, the NMD 320 comprises a playback device and a control device, and the user interface 313 comprises the user interface of the control device.

Referring to FIGS. 3A-3D together, the NMD 320 is configured to receive voice commands from one or more adjacent users via the one or more microphones 315. As described above with respect to FIG. 1B, the one or more microphones 315 can acquire, capture, or record sound in a vicinity (e.g., a region within 10 m or less of the NMD 320) and transmit electrical signals corresponding to the recorded sound to the electronics 312. The electronics 312 can process the electrical signals and can analyze the resulting audio data to determine a presence of one or more voice commands (e.g., one or more activation words). In some embodiments, for example, after detection of one or more suitable voice commands, the NMD 320 is configured to transmit a portion of the recorded audio data to another device and/or a remote server (e.g., one or more of the computing devices 106 of FIG. 1B) for further analysis. The remote server can analyze the audio data, determine an appropriate action based on the voice command, and transmit a message to the NMD 320 to perform the appropriate action. For instance, a user may speak “Sonos, play Michael Jackson.” The NMD 320 can, via the one or more microphones 315, record the user's voice utterance, determine the presence of a voice command, and transmit the audio data having the voice command to a remote server (e.g., one or more of the remote computing devices 106 of FIG. 1B, one or more servers of a VAS and/or another suitable service). The remote server can analyze the audio data and determine an action corresponding to the command. The remote server can then transmit a command to the NMD 320 to perform the determined action (e.g., play back audio content related to Michael Jackson). The NMD 320 can receive the command and play back the audio content related to Michael Jackson from a media content source. As described above with respect to FIG. 1B, suitable content sources can include a device or storage communicatively coupled to the NMD 320 via a LAN (e.g., the network 104 of FIG. 1B), a remote server (e.g., one or more of the remote computing devices 106 of FIG. 1B), etc. In certain embodiments, however, the NMD 320 determines and/or performs one or more actions corresponding to the one or more voice commands without intervention or involvement of an external device, computer, or server.

FIG. 3E is a functional block diagram showing additional features of the NMD 320 in accordance with aspects of the disclosure. The NMD 320 includes components configured to facilitate voice command capture including voice activity detector component(s) 312k, beam former components 312l, acoustic echo cancellation (AEC) and/or self-sound suppression components 312m, activation word detector components 312n, and voice/speech conversion components 312o (e.g., voice-to-text and text-to-voice). In the illustrated embodiment of FIG. 3E, the foregoing components 312k-312o are shown as separate components. In some embodiments, however, one or more of the components 312k-312o are subcomponents of the processors 112a.

The beamforming and self-sound suppression components 312l and 312m are configured to detect an audio signal and determine aspects of voice input represented in the detected audio signal, such as the direction, amplitude, frequency spectrum, etc. The voice activity detector activity components 312k are operably coupled with the beamforming and AEC components 312l and 312m and are configured to determine a direction and/or directions from which voice activity is likely to have occurred in the detected audio signal. Potential speech directions can be identified by monitoring metrics which distinguish speech from other sounds. Such metrics can include, for example, energy within the speech band relative to background noise and entropy within the speech band, which is a measure of spectral structure. As those of ordinary skill in the art will appreciate, speech typically has a lower entropy than most common background noise. The activation word detector components 312n are configured to monitor and analyze received audio to determine if any activation words (e.g., wake words) are present in the received audio. The activation word detector components 312n may analyze the received audio using an activation word detection algorithm. If the activation word detector 312n detects an activation word, the NMD 320 may process voice input contained in the received audio. Example activation word detection algorithms accept audio as input and provide an indication of whether an activation word is present in the audio. Many first- and third-party activation word detection algorithms are known and commercially available. For instance, operators of a voice service may make their algorithm available for use in third-party devices. Alternatively, an algorithm may be trained to detect certain activation words. In some embodiments, the activation word detector 312n runs multiple activation word detection algorithms on the received audio simultaneously (or substantially simultaneously). As noted above, different voice services (e.g., AMAZON's ALEXA®, APPLE's SIRI®, or MICROSOFT's CORTANA®) can each use a different activation word for invoking their respective voice service. To support multiple services, the activation word detector 312n may run the received audio through the activation word detection algorithm for each supported voice service in parallel.

The speech/text conversion components 312o may facilitate processing by converting speech in the voice input to text. In some embodiments, the electronics 312 can include voice recognition software that is trained to a particular user or a particular set of users associated with a household. Such voice recognition software may implement voice-processing algorithms that are tuned to specific voice profile(s). Tuning to specific voice profiles may require less computationally intensive algorithms than traditional voice activity services, which typically sample from a broad base of users and diverse requests that are not targeted to media playback systems.

FIG. 3F is a schematic diagram of an example voice input 328 captured by the NMD 320 in accordance with aspects of the disclosure. The voice input 328 can include a activation word portion 328a and a voice utterance portion 328b. In some embodiments, the activation word 557a can be a known activation word, such as “Alexa,” which is associated with AMAZON's ALEXA®. In other embodiments, however, the voice input 328 may not include an activation word. In some embodiments, a network microphone device may output an audible and/or visible response upon detection of the activation word portion 328a. In addition or alternately, an NMB may output an audible and/or visible response after processing a voice input and/or a series of voice inputs.

The voice utterance portion 328b may include, for example, one or more spoken commands (identified individually as a first command 328c and a second command 328e) and one or more spoken keywords (identified individually as a first keyword 328d and a second keyword 328f). In one example, the first command 328c can be a command to play music, such as a specific song, album, playlist, etc. In this example, the keywords may be one or words identifying one or more zones in which the music is to be played, such as the Living Room and the Dining Room shown in FIG. 1A. In some examples, the voice utterance portion 328b can include other information, such as detected pauses (e.g., periods of non-speech) between words spoken by a user, as shown in FIG. 3F. The pauses may demarcate the locations of separate commands, keywords, or other information spoke by the user within the voice utterance portion 328b.

In some embodiments, the media playback system 100 is configured to temporarily reduce the volume of audio content that it is playing while detecting the activation word portion 557a. The media playback system 100 may restore the volume after processing the voice input 328, as shown in FIG. 3F. Such a process can be referred to as ducking, examples of which are disclosed in U.S. patent application Ser. No. 15/438,749, incorporated by reference herein in its entirety.

FIGS. 4A-4D are schematic diagrams of a control device 430 (e.g., the control device 130a of FIG. 1H, a smartphone, a tablet, a dedicated control device, an IoT device, and/or another suitable device) showing corresponding user interface displays in various states of operation. A first user interface display 431a (FIG. 4A) includes a display name 433a (i.e., “Rooms”). A selected group region 433b displays audio content information (e.g., artist name, track name, album art) of audio content played back in the selected group and/or zone. Group regions 433c and 433d display corresponding group and/or zone name, and audio content information audio content played back or next in a playback queue of the respective group or zone. An audio content region 433e includes information related to audio content in the selected group and/or zone (i.e., the group and/or zone indicated in the selected group region 433b). A lower display region 433f is configured to receive touch input to display one or more other user interface displays. For example, if a user selects “Browse” in the lower display region 433f, the control device 430 can be configured to output a second user interface display 431b (FIG. 4B) comprising a plurality of music services 433g (e.g., Spotify, Radio by Tunein, Apple Music, Pandora, Amazon, TV, local music, line-in) through which the user can browse and from which the user can select media content for play back via one or more playback devices (e.g., one of the playback devices 110 of FIG. 1A). Alternatively, if the user selects “My Sonos” in the lower display region 433f, the control device 430 can be configured to output a third user interface display 431c (FIG. 4C). A first media content region 433h can include graphical representations (e.g., album art) corresponding to individual albums, stations, or playlists. A second media content region 433i can include graphical representations (e.g., album art) corresponding to individual songs, tracks, or other media content. If the user selections a graphical representation 433j (FIG. 4C), the control device 430 can be configured to begin play back of audio content corresponding to the graphical representation 433j and output a fourth user interface display 431d fourth user interface display 431d includes an enlarged version of the graphical representation 433j, media content information 433k (e.g., track name, artist, album), transport controls 433m (e.g., play, previous, next, pause, volume), and indication 433n of the currently selected group and/or zone name.

FIG. 5 is a schematic diagram of a control device 530 (e.g., a laptop computer, a desktop computer). The control device 530 includes transducers 534, a microphone 535, and a camera 536. A user interface 531 includes a transport control region 533a, a playback status region 533b, a playback zone region 533c, a playback queue region 533d, and a media content source region 533e. The transport control region comprises one or more controls for controlling media playback including, for example, volume, previous, play/pause, next, repeat, shuffle, track position, crossfade, equalization, etc. The audio content source region 533e includes a listing of one or more media content sources from which a user can select media items for play back and/or adding to a playback queue.

The playback zone region 533b can include representations of playback zones within the media playback system 100 (FIGS. 1A and 1B). In some embodiments, the graphical representations of playback zones may be selectable to bring up additional selectable icons to manage or configure the playback zones in the media playback system, such as a creation of bonded zones, creation of zone groups, separation of zone groups, renaming of zone groups, etc. In the illustrated embodiment, a “group” icon is provided within each of the graphical representations of playback zones. The “group” icon provided within a graphical representation of a particular zone may be selectable to bring up options to select one or more other zones in the media playback system to be grouped with the particular zone. Once grouped, playback devices in the zones that have been grouped with the particular zone can be configured to play audio content in synchrony with the playback device(s) in the particular zone. Analogously, a “group” icon may be provided within a graphical representation of a zone group. In the illustrated embodiment, the “group” icon may be selectable to bring up options to deselect one or more zones in the zone group to be removed from the zone group. In some embodiments, the control device 530 includes other interactions and implementations for grouping and ungrouping zones via the user interface 531. In certain embodiments, the representations of playback zones in the playback zone region 533b can be dynamically updated as playback zone or zone group configurations are modified.

The playback status region 533c includes graphical representations of audio content that is presently being played, previously played, or scheduled to play next in the selected playback zone or zone group. The selected playback zone or zone group may be visually distinguished on the user interface, such as within the playback zone region 533b and/or the playback queue region 533d. The graphical representations may include track title, artist name, album name, album year, track length, and other relevant information that may be useful for the user to know when controlling the media playback system 100 via the user interface 531.

The playback queue region 533d includes graphical representations of audio content in a playback queue associated with the selected playback zone or zone group. In some embodiments, each playback zone or zone group may be associated with a playback queue containing information corresponding to zero or more audio items for playback by the playback zone or zone group. For instance, each audio item in the playback queue may comprise a uniform resource identifier (URI), a uniform resource locator (URL) or some other identifier that may be used by a playback device in the playback zone or zone group to find and/or retrieve the audio item from a local audio content source or a networked audio content source, possibly for playback by the playback device. In some embodiments, for example, a playlist can be added to a playback queue, in which information corresponding to each audio item in the playlist may be added to the playback queue. In some embodiments, audio items in a playback queue may be saved as a playlist. In certain embodiments, a playback queue may be empty, or populated but “not in use” when the playback zone or zone group is playing continuously streaming audio content, such as Internet radio that may continue to play until otherwise stopped, rather than discrete audio items that have playback durations. In some embodiments, a playback queue can include Internet radio and/or other streaming audio content items and be “in use” when the playback zone or zone group is playing those items.

When playback zones or zone groups are “grouped” or “ungrouped,” playback queues associated with the affected playback zones or zone groups may be cleared or re-associated. For example, if a first playback zone including a first playback queue is grouped with a second playback zone including a second playback queue, the established zone group may have an associated playback queue that is initially empty, that contains audio items from the first playback queue (such as if the second playback zone was added to the first playback zone), that contains audio items from the second playback queue (such as if the first playback zone was added to the second playback zone), or a combination of audio items from both the first and second playback queues. Subsequently, if the established zone group is ungrouped, the resulting first playback zone may be re-associated with the previous first playback queue, or be associated with a new playback queue that is empty or contains audio items from the playback queue associated with the established zone group before the established zone group was ungrouped. Similarly, the resulting second playback zone may be re-associated with the previous second playback queue, or be associated with a new playback queue that is empty, or contains audio items from the playback queue associated with the established zone group before the established zone group was ungrouped.

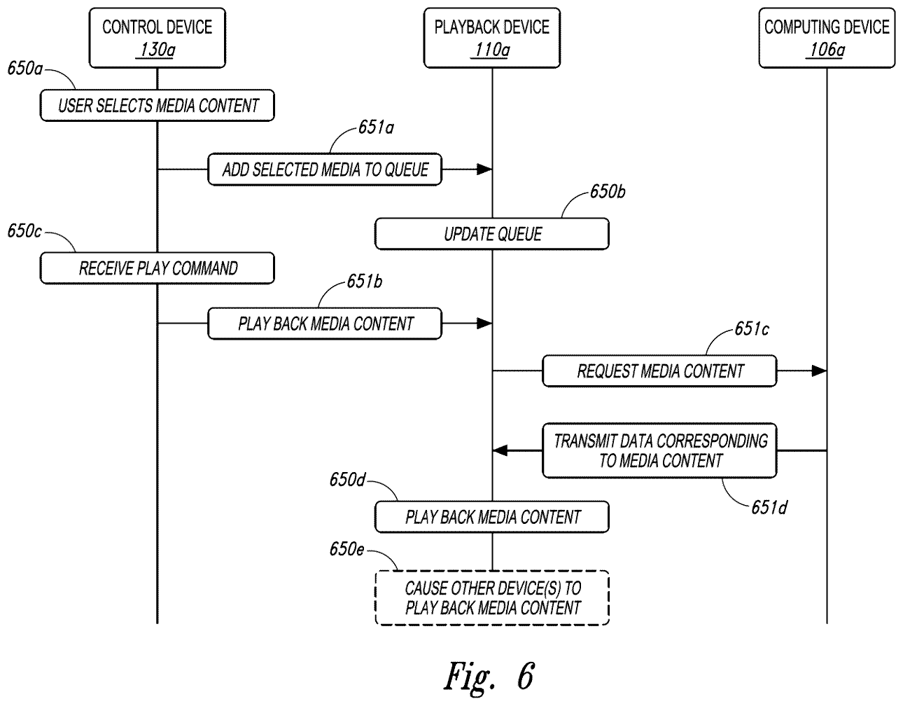

FIG. 6 is a message flow diagram illustrating data exchanges between devices of the media playback system 100 (FIGS. 1A-1M).

At step 650a, the media playback system 100 receives an indication of selected media content (e.g., one or more songs, albums, playlists, podcasts, videos, stations) via the control device 130a. The selected media content can comprise, for example, media items stored locally on or more devices (e.g., the audio source 105 of FIG. 1C) connected to the media playback system and/or media items stored on one or more media service servers (one or more of the remote computing devices 106 of FIG. 1B). In response to receiving the indication of the selected media content, the control device 130a transmits a message 651a to the playback device 110a (FIGS. 1A-1C) to add the selected media content to a playback queue on the playback device 110a.

At step 650b, the playback device 110a receives the message 651a and adds the selected media content to the playback queue for play back.

At step 650c, the control device 130a receives input corresponding to a command to play back the selected media content. In response to receiving the input corresponding to the command to play back the selected media content, the control device 130a transmits a message 651b to the playback device 110a causing the playback device 110a to play back the selected media content. In response to receiving the message 651b, the playback device 110a transmits a message 651c to the computing device 106a requesting the selected media content. The computing device 106a, in response to receiving the message 651c, transmits a message 651d comprising data (e.g., audio data, video data, a URL, a URI) corresponding to the requested media content.

At step 650d, the playback device 110a receives the message 651d with the data corresponding to the requested media content and plays back the associated media content.

At step 650e, the playback device 110a optionally causes one or more other devices to play back the selected media content. In one example, the playback device 110a is one of a bonded zone of two or more players (FIG. 1M). The playback device 110a can receive the selected media content and transmit all or a portion of the media content to other devices in the bonded zone. In another example, the playback device 110a is a coordinator of a group and is configured to transmit and receive timing information from one or more other devices in the group. The other one or more devices in the group can receive the selected media content from the computing device 106a, and begin playback of the selected media content in response to a message from the playback device 110a such that all of the devices in the group play back the selected media content in synchrony.

### IV. Technical Features Related to Wireless Streaming of Audio/Visual Content

In some embodiments, at least some aspects of the technical solutions derive from the technical structure and organization of the audio data, the playback timing, and the clock timing information that the playback devices use to play audio data in synchrony with each other or in some other groupwise fashion (e.g., in lip-synchrony with video data corresponding to the audio data), including how playback devices generate playback timing based on clock timing and play audio data based on playback timing and clock timing.

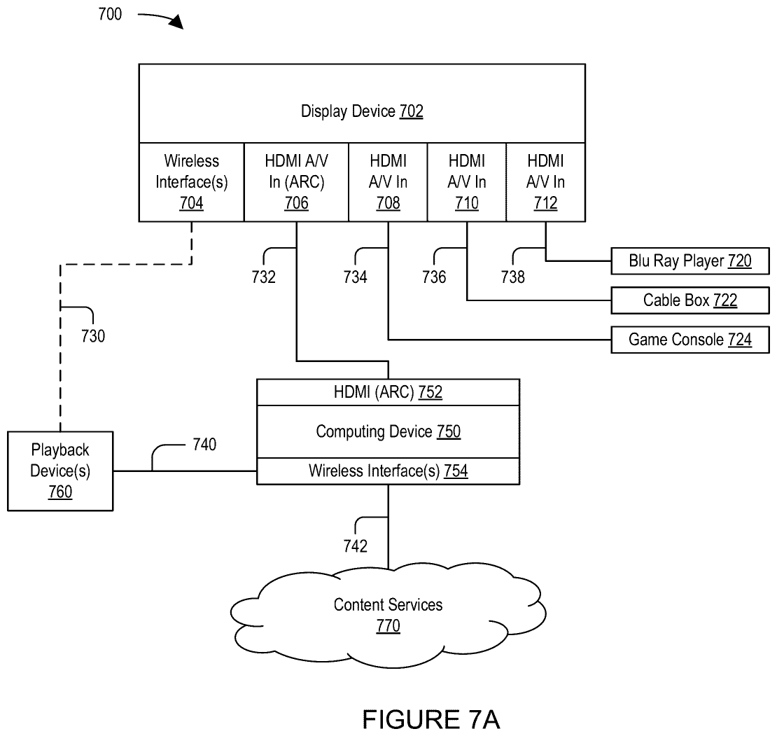

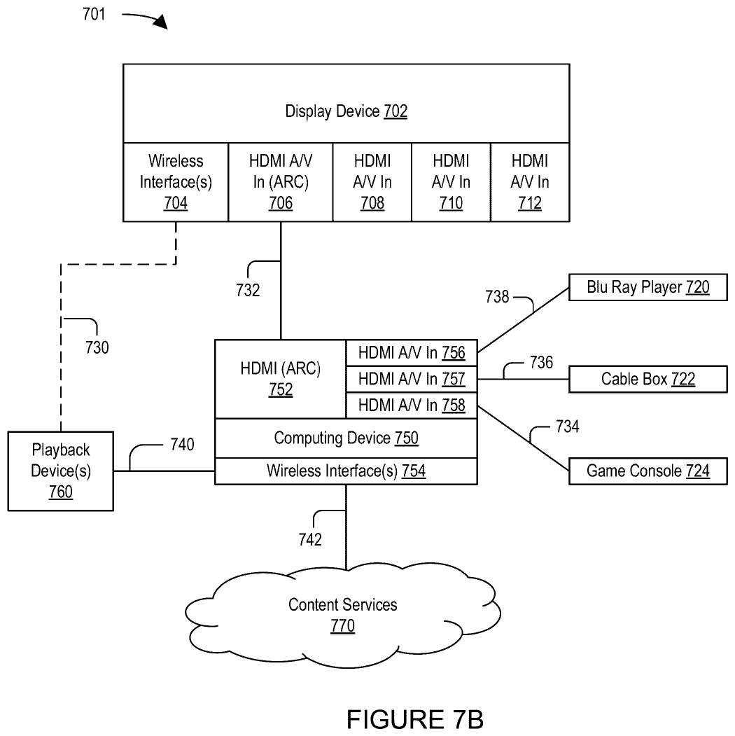

Therefore, to aid in understanding certain aspects of the disclosed technical solutions, certain technical details of the audio data, playback timing, and clock timing information, as well as how playback devices generate and/or use playback timing and clock timing for playing audio data are described below. Except where noted, the technical details of the audio data, playback timing, and clock timing information described below are the same or at least generally the same for the examples shown and described herein with reference to FIGS. 7-11.

a. Audio Data

Audio data may be any type of audio data now known or later developed. For example, in some embodiments, the audio data includes any one or more of: (i) streaming music or other audio obtained from a streaming media service, such as Spotify, Pandora, or other streaming media services; (ii) streaming music or other audio from a local music library, such as a music library stored on a user's laptop computer, desktop computer, smartphone, tablet, home server, or other computing device now known or later developed; (iii) audio data associated with video data, such as audio associated with a television program or movie received from any of a television, set-top box, Digital Video Recorder, Digital Video Disc player, streaming video service, or any other source of Audio/Visual (A/V) content now known or later developed; (iv) text-to-speech or other audible content from a voice assistant service (VAS), such as Amazon Alexa or other VAS services now known or later developed; (v) audio data from a doorbell or intercom system such as Nest, Ring, or other doorbells or intercom systems now known or later developed; and/or (vi) audio data from a telephone, video phone, video/teleconferencing system or other application configured to allow users to communicate with each other via audio and/or video.

In some embodiments, a group coordinator (sometimes referred to as a “sourcing” device) obtains any of the aforementioned types of audio data from an audio source via an interface on the group coordinator, e.g., one of the group coordinator's wired or wireless data network interfaces, a “line-in” analog interface, a digital audio interface, or any other interface suitable for receiving audio data in digital or analog format now known or later developed.

An audio source is any system, device, or application that generates, provides, or otherwise makes available any of the aforementioned audio data to a group coordinator and/or playback device. Examples of audio sources include streaming media (audio, video) services, digital media servers or other computing systems, voice assistant services (VAS), televisions, cable set-top-boxes, streaming media players (e.g., AppleTV, Roku, gaming console), CD/DVD players, doorbells, intercoms, telephones/smartphones, tablets, or any other source of audio data now known or later developed.

As mentioned earlier, a playback device that receives or otherwise obtains audio data from an audio source for playback and/or distribution to other playback devices in a playback group is sometimes referred to herein as the group coordinator or “sourcing” device for the playback group.

One function of the group coordinator of a playback group in some embodiments is to process received audio data for playback and/or distribution to group members of the playback group for groupwise playback. In some embodiments, the group coordinator transmits the processed audio data to all the other group members in the playback group via a local area network, e.g., a WiFi network and/or wired Ethernet network. In some embodiments, the group coordinator transmits the audio data to a multicast network address (e.g., an IP multicast address or other type of multicast address), and all the group member playback devices configured to play the audio data (i.e., the group members of the playback group) receive the audio data via that multicast address. In some embodiments, the group coordinator broadcasts the audio data on a wireless channel and the group members in the playback group receive the broadcast. For example, in some embodiments, the group coordinator transmits the audio data to the group members via Connectionless Slave Broadcast (CSB) Bluetooth transmission or other type of broadcast or multicast transmission.

In some embodiments, the group coordinator receives audio data from an audio source in digital form, e.g., via a stream of packets. In some embodiments, individual packets in the stream have a sequence number or other identifier that specifies an ordering of the packets. In operation, the group coordinator uses the sequence number or other identifier to detect missing packets and/or to reassemble the packets of the stream in the correct order before performing further processing. In some embodiments, the sequence number or other identifier that specifies the ordering of the packets is or at least comprises a timestamp indicating a time when the packet was created. The packet creation time can be used as a sequence number based on an assumption that packets are created in the order in which they should be subsequently played out. For example, in some embodiments, the group coordinator receives audio data from an audio source via the Internet. In some embodiments, the group coordinator may receive audio data from an audio source via an Advanced Audio Distribution Profile (A2DP) Bluetooth link.

In some embodiments, individual packets from an audio source may include both a timestamp and a sequence number. The timestamp is used to place the incoming packets of audio data in the correct order, and the sequence number is mainly used to detect packet losses. In operation, the sequence numbers increase by one for each Real-time Transport Protocol (RTP) packet transmitted from the audio source, and timestamps increase by the time “covered” by an RTP packet. In instances where a portion of audio data is split across multiple RTP packets, multiple RTP packets may have the same timestamp.

In some embodiments, the group coordinator does not change the sequence number or identifier (or timestamp, if applicable) of a received packet during processing. But in some embodiments, the group coordinator may reorder at least a first set of packets in a packet stream received from an audio source (an inbound stream) based on each packet's sequence identifier, extract audio data from the received packets, reassemble a bitstream of audio content from the received packets, and then repacketize the reassembled bitstream into an outbound set of packets (an outbound stream), where packets in the outbound stream have sequence numbers and/or timestamps that differ from the sequence numbers and/or timestamps of the packets in the first set of packets (or first stream).

In some embodiments, individual packets in the outbound stream may be a different length (i.e., shorter or longer) than individual packets in the inbound stream. In some embodiments, reassembling a bitstream from the incoming packet stream and then subsequently repacketizing the reassembled bitstream into a different set of packets facilitates uniform processing and/or transmission of audio data by the group coordinator and uniform processing by the group members that receive the audio content from the group coordinator.

However, for some delay-sensitive audio content, reassembly and repacketization may be undesirable, and therefore, in some embodiments, the group coordinator may not perform reassembly and repacketization for some (or all) audio data that it receives before playing the audio data and/or transmitting the audio data to other playback devices/group members.

b. Playback Timing

In some embodiments, the playback devices disclosed and described herein use playback timing to play audio data in synchrony with each other. In some embodiments, the playback devices additionally use the playback timing to play audio data in lip synchrony with a display device's playback of video data associated with the audio data. And in some embodiments, a television (or other display device) additionally uses the playback timing to display frames of video data in lip synchrony with playback of corresponding audio data by the audio playback devices.

An individual playback device can generate playback timing and/or playback audio data according to playback timing, based on the playback device's configuration in the playback group. The sourcing playback device (acting as a group coordinator) that generates the playback timing for audio data also transmits that generated playback timing to all the playback devices that are configured to play the audio data (the group members). In some home theater embodiments, (i) the sourcing device (acting as a group coordinator) may be any of a soundbar, a streaming media receiver, a home theater headend, or any other type of computing device configured to perform the sourcing device/group coordinator functions disclosed and described herein, and (ii) the group members may include one or more playback devices, such as a soundbar playback device, subwoofer playback device, side satellite playback device, rear satellite playback device, or any other type of computing device equipped with one or more speakers and configured to perform the group member functions disclosed and described herein.

In some embodiments, the group coordinator transmits playback timing separately from the audio data. For example, in some embodiments, the group coordinator may (i) transmit audio data to the group members via Connectionless Slave Broadcast (CSB) Bluetooth transmission and (ii) transmit playback timing for the audio content via a Bluetooth or Bluetooth Low Energy (BLE) transmission.

In some embodiments, the group coordinator transmits the playback timing to all the group members by transmitting the playback timing to a multicast network address for the playback group, and all the group members receive the playback timing via the playback group's multicast address. In some embodiments, the group coordinator transmits the playback timing to each group member by transmitting the playback timing to each group member's unicast network address.

In some embodiments, the playback timing is generated for individual frames (or packets) of audio data. In some embodiments, the audio data is packaged in a series of frames (or packets) where individual frames (or packets) comprise a portion of the audio data. In some embodiments, the playback timing for the audio data includes a playback time for each frame (or packet) of audio data. In some embodiments, the playback timing for an individual frame (or packet) is included within the frame (or packet), e.g., in the header of the frame (or packet), in an extended header of the frame (or packet), and/or in the payload portion of the frame (or packet). But as described earlier, in some embodiments, the group coordinator transmits playback timing for one or more individual frames separately from the audio data.

In some embodiments, the playback time for an individual frame (or packet) is identified within a timestamp or other indication. In such embodiments, the timestamp (or other indication) represents a time to play the one or more portions of audio data within that individual frame (or packet).

In operation, when the playback timing for an individual frame (or packet) is generated, the playback timing for that individual frame (or packet) is a future time relative to a current clock time of a reference clock at the time that the playback timing for that individual frame (or packet) is generated. As described in more detail below, the reference clock can be a “local” clock at the group coordinator or a “remote” clock at a separate network device, e.g., another playback device, a computing device, or another network device configured to provide clock timing for use by playback devices to generate playback timing and/or playback audio data.

In operation, a playback device tasked with playing particular audio data will play the portion(s) of the particular audio data within an individual frame (or packet) at the playback time specified by the playback timing for that individual frame (or packet), as adjusted to accommodate for differences between the clock timing information and a clock at the playback device that is tasked with playing the audio data, as described in more detail below.

c. Reference Clock Timing

The playback devices disclosed and described herein use clock timing from a reference clock to generate playback timing for audio data and to play audio based on the audio data and the generated playback timing.

In some embodiments, the group coordinator uses clock timing from a reference clock (e.g., a device clock, a digital-to-audio converter clock, a playback time reference clock, or any other clock) to generate playback timing for audio data that the group coordinator receives from an audio source. The reference clock can be a “local” clock at the group coordinator or a “remote” clock at a separate network device, e.g., another playback device, a computing device, or another network device configured to provide clock timing for use by (i) a group coordinator to generate playback timing and/or (ii) the group coordinator and group members to play back audio data.

In some embodiments, all of the playback devices tasked with playing particular audio data in synchrony (i.e., all the group members in a playback group) use the same clock timing from the same reference clock to play back that particular audio data in synchrony with each other. In some embodiments, playback devices use the same clock timing to play audio data that was used to generate the playback timing for the audio data.

In some embodiments, the device that generates the clock timing also transmits the clock timing to all the playback devices that need to use the clock timing for generating playback timing and/or playing back audio content. In some embodiments, the device that generates the clock timing (e.g., the group coordinator in some embodiments) transmits the clock timing to a multicast network address, and all the playback devices configured to generate playback timing and/or play audio data (e.g., the group members, and perhaps the group coordinator too if the group coordinator is not the device generating the clock timing) receive the clock timing via that multicast address. In some embodiments, the device that generates the clock timing alternatively transmits the clock timing to each unicast network address of each playback device in the playback group.

In some embodiments, the device that generates the clock timing is a playback device configured to operate as the group coordinator for the playback group. And in operation, the group coordinator of the playback group transmits the clock timing to all the group members of the playback group. In some embodiments, the group coordinator transmits the clock timing to all playback group members via a multicast network address. In some embodiments, the group coordinator transmits clock timing to individual group members via each group member's unicast network address. In some embodiments, the coordinator transmits clock timing to individual group members via a Bluetooth or Bluetooth Low Energy (BLE) transmission, or via any other transmission scheme suitable for transmitting clock timing information now known or later developed. And in some embodiments, the group coordinator and the group members all use the clock timing and the playback timing to play audio data in a groupwise manner. In some embodiments, the group coordinator and the group members all use the clock timing and the playback timing to play audio data in synchrony with each other.

In some embodiments, the device that generates the clock timing may additionally send the clock timing to a television (or other display device). In such embodiments, the television uses the clock timing and playback timing to display frames of video data associated with the audio data in lip synchrony with playback of the corresponding audio data by the audio playback devices in the playback group.

d. Generating Playback Timing by the Group Coordinator

In some embodiments, the group coordinator: (i) generates playback timing for audio data based on clock timing from a local clock at the group coordinator, and (ii) transmits the generated playback timing to all the other group members in the playback group. In operation, when generating playback timing for an individual frame (or packet), the group coordinator adds a “timing advance” to the current clock time of a local clock at the group coordinator that the group coordinator is using for generating the playback timing.

In some embodiments, the “timing advance” is based on an amount of time that is greater than or equal to the sum of (i) the network transit time required for frames and/or packets comprising audio data transmitted from the group coordinator to arrive at all the other group members and (ii) the amount of time required for all the other group members to process received frames/packets from the group coordinator for playback.

In some embodiments, the group coordinator determines a timing advance by sending one or more test packets to one or more (or perhaps all) of the other group members, and then receiving test response packets back from those one or more group members. In some embodiments, the group coordinator and the one or more group members negotiate a timing advance via multiple test and response messages in connection with configuring a playback group for groupwise playback of audio and/or audio/video content. In some embodiments with more than two group members, the group coordinator determines a timing advance by exchanging test and response messages with all of the group members, and then setting a timing advance that is sufficient for the group member having the longest total of network transmit time and packet processing time.

In some embodiments, the timing advance is less than about 50 milliseconds. In some embodiments, the timing advance is less than about 20-30 milliseconds. And in still further embodiments, the timing advance is less than about 10 milliseconds. In some embodiments, the timing advance remains constant after being determined, or at least constant for the duration of a synchronous playback session. In other embodiments, the group coordinator can change the timing advance in response to a request from a group member indicating that a greater timing advance is required (e.g., because the group member is not receiving packets comprising portions of audio data until after one or more other group members have already played the portions of audio data) or a shorter timing advance would be sufficient (e.g., because the group member is buffering more packets comprising portions of audio data than necessary to provide consistent, reliable playback).

As described in more detail below, all the playback devices in a playback group configured to play the audio data in synchrony will use the playback timing and the clock timing to play the audio data in synchrony with each other.

e. Generating Playback Timing with Clock Timing from a Remote Reference Clock

In some embodiments, the group coordinator may generate playback timing for audio data based on clock timing from a remote clock at another network device, e.g., another playback device, another computing device (e.g., a smartphone, laptop, media server, cloud server, or other computing device or computing system configurable to provide clock timing sufficient for use by the group coordinator to generate playback timing and/or playback audio data). Generating playback timing based on clock timing from a remote clock at another network device is more complicated than generating playback timing based on clock timing from a local clock in embodiments where the same clock timing is used for both (i) generating playback timing and (ii) playing audio data based on the playback timing.

In embodiments where the group coordinator generates playback timing for audio data based on clock timing from a remote clock, the playback timing for an individual frame (or packet) is based on (i) a “timing offset” between (a) a local clock at the group coordinator that the group coordinator uses for generating the playback timing and (b) the clock timing information from the remote reference clock, and (ii) a “timing advance” based on an amount of time that is greater than or equal to the sum of (a) the network transit time required for packets transmitted from the group coordinator to arrive at the group members and (b) the amount of time required for all of those group members to process frames and/or packets comprising audio data received from the group coordinator for playback.

For an individual frame (or packet) containing a portion(s) of the audio data, the group coordinator generates playback timing for that individual frame (or packet) by adding the sum of the “timing offset” and the “timing advance” to a current time of the local clock at the group coordinator that the group coordinator uses to generate the playback timing for the audio data. In operation, the “timing offset” may be a positive or a negative offset, depending on whether the local clock at the group coordinator is ahead of or behind the remote clock providing the clock timing. The “timing advance” is a positive number because it represents a future time relative to the local clock time, as adjusted by the “timing offset.”

By adding the sum of the “timing advance” and the “timing offset” to a current time of the local clock at the group coordinator that the group coordinator is using to generate the playback timing for the audio data, the group coordinator is, in effect, generating the playback timing relative to the remote clock.

In some embodiments, and as described above, the “timing advance” is based on an amount of time that is greater than or equal to the sum of (i) the network transit time required for frames and/or packets comprising audio data transmitted from the group coordinator to arrive at all other group members and (ii) the amount of time required for all the other group members to process received frames/packets from the sourcing playback device for playback.

In some embodiments, the group coordinator determines a timing advance via signaling between the group coordinator and one or more group members, as described previously. Further, in some embodiments, the timing advance is less than about 50 milliseconds, less than about 20-30 milliseconds, or less than about 10 milliseconds, depending on the audio data playback latency requirements because different audio data may have different latency requirements. For example, audio data having associated video data may have lower latency requirements than audio data that does not have associated video data because audio data associated with video data must be played in lip synchrony with its corresponding video data whereas audio data that is not associated with video data need not be synchronized with any corresponding video data. In some embodiments, the timing advance remains constant after being determined, or at least constant for the duration of a playback session. And in some embodiments, the group coordinator can change the timing advance based on further signaling between the group coordinator (generating the playback timing) and one or more group members (that are using the playback timing to play audio data).

As described in more detail below, all the playback devices configured to play the audio data in synchrony will use the playback timing and the clock timing to play the audio data in synchrony with each other.

f. Playing Audio Content Using Local Playback Timing and Local Clock Timing

In some embodiments, the group coordinator is configured to play audio data in synchrony with one or more group members. And if the group coordinator is using clock timing from a local clock at the group coordinator to generate the playback timing, then the group coordinator will play the audio data using locally generated playback timing and the locally-generated clock timing. In operation, the group coordinator plays an individual frame (or packet) comprising portions of the audio data when the local clock that the group coordinator used to generate the playback timing reaches the time specified in the playback timing for that individual frame (or packet).

For example, recall that when generating playback timing for an individual frame (or packet), the group coordinator adds a “timing advance” to the current clock time of the reference clock used for generating the playback timing. In this instance, the reference clock used for generating the playback timing is a local clock at the group coordinator. So, if the timing advance for an individual frame is, for example, 30 milliseconds, then the group coordinator plays the portion (e.g., a sample or set of samples) of audio data in an individual frame (or packet) 30 milliseconds after creating the playback timing for that individual frame (or packet).

In this manner, the group coordinator plays audio data by using locally-generated playback timing and clock timing from a local reference clock at the group coordinator. By playing the portion(s) of the audio data of an individual frame and/or packet when the clock time of the local reference clock reaches the playback timing for that individual frame or packet, the group coordinator plays that portion(s) of the audio data in that individual frame and/or packet in synchrony with other group members in the playback group.

g. Playing Audio Content using Local Playback Timing and Remote Clock Timing

As mentioned earlier, in some embodiments, a group coordinator generates playback timing for audio data based on clock timing from a remote clock, i.e., a clock at another network device separate from the group coordinator, e.g., another playback device, or another computing device (e.g., a smartphone, laptop, media server, or other computing device configurable to provide clock timing sufficient for use by a playback device to generate playback timing and/or playback audio data).

Because the group coordinator used clock timing from the remote clock to generate the playback timing for the audio data, the group coordinator also uses the clock timing from the remote clock to play the audio data. In this manner, the group coordinator plays audio data using the locally-generated playback timing and the clock timing from the remote clock.

Recall that, in embodiments where the group coordinator generates playback timing for audio data based on clock timing from a remote clock, the group coordinator generates the playback timing for an individual frame (or packet) based on (i) a “timing offset” based on a difference between (a) a local clock at the group coordinator and (b) the clock timing information from the remote clock, and (ii) a “timing advance” comprising an amount of time that is greater than or equal to the sum of (a) the network transit time required for frames/packets transmitted from the group coordinator to arrive at all the group members and (b) the amount of time required for all of the group members to process frames and/or packets comprising audio data received from the group coordinator for playback. And further recall that the group coordinator transmits the generated playback timing to all of the group members in the playback group tasked with playing the audio data in synchrony.

In this scenario, to play an individual frame (or packet) of audio data in synchrony with the one or more other group members, the group coordinator subtracts the “timing offset” from the playback timing for that individual frame (or packet) to generate a “local” playback time for playing audio based on the audio data within that individual frame (or packet). After generating the “local” playback time for playing the portion(s) of the audio data within the individual frame (or packet), the group coordinator plays the portion(s) of the audio data in the individual frame (or packet) when the local clock that the group coordinator is using to play the audio data reaches the “local” playback time for that individual frame (or packet). By subtracting the “timing offset” from the playback timing to generate the “local” playback time for an individual frame, the group coordinator effectively plays the portion(s) of audio data in that frame/packet with reference to the clock timing from the remote clock.

h. Playing Audio Content using Remote Playback Timing and Local Clock Timing

Recall that, in some embodiments, the group coordinator transmits the audio data and the playback timing for the audio data to one or more group members. If the group member that receives (i.e., the receiving group member) the audio data and playback timing from the group coordinator is the same group member that provided clock timing information to the group coordinator that the group coordinator used for generating the playback timing, then the receiving group member in this instance plays audio data using the playback timing received from the group coordinator (i.e., remote playback timing) and the group member's own clock timing (i.e., local clock timing). Because the group coordinator used clock timing from a clock at the receiving group member to generate the playback timing, the receiving group member also uses the clock timing from its local clock to play the audio data. In this manner, the receiving group member plays audio data using the remote playback timing (i.e., from the group coordinator) and the clock timing from its local clock (i.e., its local clock timing).

To play an individual frame (or packet) of the audio data in synchrony with the group coordinator (and every other group member that receives the playback timing from the group coordinator and clock timing from the receiving group member), the receiving group member (i) receives the frames (or packets) comprising the portions of the audio data from the group coordinator, (ii) receives the playback timing for the audio data from the group coordinator (e.g., in the frame and/or packet headers of the frames and/or packets comprising the portions of the audio data or perhaps separately from the frames and/or packets comprising the portions of the audio data), and (iii) plays the portion(s) of the audio data in the individual frame (or packet) when the local clock that the receiving group member used to generate the clock timing reaches the playback time specified in the playback timing for that individual frame (or packet) received from the group coordinator.

Because the group coordinator uses the “timing offset” (which is the difference between the clock timing at the receiving group member and the clock timing at the group coordinator in this scenario) when generating the playback timing, and because this “timing offset” already accounts for differences between timing at the group coordinator and the receiving group member, the receiving group member in this scenario plays individual frames (or packets) comprising portions of the audio data when the receiving group member's local clock (that was used to generated the clock timing) reaches the playback time for an individual frame (or packet) specified in the playback timing for that individual frame (or packet).

And because the receiving group member plays frames (or packets) comprising portions of the audio data according to the playback timing, and because the group coordinator plays frames (or packets) comprising the same portions of the audio data according to the playback timing and the determined “timing offset,” the receiving group member and the group coordinator play frames (or packets) comprising the same audio data in synchrony, i.e., at the same time or at substantially the same time.

i. Playing Audio Content using Remote Playback Timing and Remote Clock Timing

Recall that, in some embodiments, the sourcing playback device (e.g., which in many cases may be the group coordinator) transmits the audio data and the playback timing for the audio data to one or more other playback devices in the synchrony group. And further recall that, in some embodiments, the network device providing the clock timing can be a different device than the playback device providing the audio data and playback timing (i.e., the sourcing playback device, which in many cases may be the group coordinator). Playback devices that receive the audio data, the playback timing, and the clock timing from one or more other devices are configured to playback the audio data using the playback timing from the device that provided the playback timing (i.e., remote playback timing) and clock timing from a clock at the device that provided the clock timing (i.e., remote clock timing). In this manner, the receiving group member in this instance plays audio data by using remote playback timing and remote clock timing.

To play an individual frame (or packet) of the audio data in synchrony with every other playback device tasked with playing audio data in the playback group, the receiving playback device (i) receives the frames (or packets) comprising the portions of the audio data, (ii) receives the playback timing for the audio data (e.g., in the frame and/or packet headers of the frames and/or packets comprising the portions of the audio data or perhaps separately from the frames and/or packets comprising the portions of the audio data), (iii) receives the clock timing, and (iv) plays the portion(s) of the audio data in the individual frame (or packet) when the local clock that the receiving playback device uses for audio data playback reaches the playback time specified in the playback timing for that individual frame (or packet), as adjusted by a “timing offset.”

In operation, after the receiving playback device receives clock timing, the receiving device determines a “timing offset” for the receiving playback device. This “timing offset” comprises (or at least corresponds to) a difference between the “reference” clock that was used to generate the clock timing and a “local” clock at the receiving playback device that the receiving playback device uses to play the audio data. In operation, each playback device that receives the clock timing from another device calculates its own “timing offset” based on the difference between its local clock and the clock timing, and thus, the “timing offset” that each playback device determines is specific to that particular playback device.

In some embodiments, when playing back the audio data, the receiving playback device generates new playback timing (specific to the receiving playback device) for individual frames (or packets) of audio data by adding the previously determined “timing offset” to the playback timing for each received frame (or packet) comprising portions of audio data. With this approach, the receiving playback device converts the playback timing for the received audio data into “local” playback timing for the receiving playback device. Because each receiving playback device calculates its own “timing offset,” each receiving playback device's determined “local” playback timing for an individual frame is specific to that particular playback device.

And when the “local” clock that the receiving playback device is using for playing back the audio data reaches the “local” playback time for an individual frame (or packet), the receiving playback device plays the audio data (or portions thereof) associated with that individual frame (or packet). As described above, in some embodiments, the playback timing for a particular frame (or packet) is in the header of the frame (or packet). In other embodiments, the playback timing for individual frames (or packets) is transmitted separately from the frames (or packets) comprising the audio data.

Because the receiving playback device plays frames (or packets) comprising portions of the audio data according to the playback timing as adjusted by the “timing offset” relative to the clock timing, and because the device providing the playback timing generated the playback timing for those frames (or packets) relative to the clock timing and plays frames (or packets) comprising the same portions of the audio data according to the playback timing and its determined “timing offset,” the receiving playback device and the device that provided the playback timing (e.g., the group coordinator in some embodiments) play frames (or packets) comprising the same portions of the audio data in synchrony with each other, i.e., at the same time or at substantially the same time.

### V. Example Embodiments Related to Wireless Transmission of Audio/Visual Content

FIG. 7A shows an example system 700 configured for wireless streaming of audio/visual content according to some embodiments.

System 700 includes a display device 702, a Blu Ray player 720, a cable box 722, a game console 724, a computing device 750, and one or more playback devices 760. The communication links shown between the devices in system 700 may be wired or wireless communications links.

The display device 702 may be a television or any other type of device configured to display video data, e.g., a monitor, projector, or similar display device. Display device 702 includes one or more wireless interfaces 704 (e.g., WiFi and/or Bluetooth interfaces), HDMI A/V input 706 with Audio Return Channel (ARC), and HDMI interfaces 708-712. HDMI interfaces 708-712 may include HDMI-ARC in some embodiments. In operation, the HDMI links may be physical HDMI links or wireless HDMI links. In some embodiments, the interfaces 706, 708, 710, 712, and 752 (and corresponding links 732, 734, 736, and 738) may operate according to a wired or wireless protocol other than HDMI that is sufficient for transmitting audio/video content, such as FireWire, USB-C, Thunderbolt, WiFi, Ethernet, Bluetooth, or any other suitable protocol now known or later developed.

In operation, display device 702 is configured to receive audio/video (A/V) content comprising audio data and video data corresponding to the audio data from any of (i) Blu Ray player 720 via HDMI link 738, (ii) cable box 722 via HDMI link 736, (iii) game console 724 via HDMI link 734, and (iv) content services 770 (e.g., from the Internet), computing device 750, playback device(s) 760, or another computing device (not shown) via wireless interface(s) 704. Display device 702 is also configured to receive at least the video data of the A/V content from computing device 750 via HDMI link 732, although display device 702 may receive both the audio data and video data of the A/V content from computing device 750 via HDMI link 732.

The Blu Ray player 720, cable box 722, game console 724, and content services 770 are all sources of A/V content that comprises audio data and video data. In addition to the Blu Ray player 720, cable box 722, game console 724, and content services 770, the display device 702 may additionally or alternatively be configured to receive A/V content from any other A/V content source now known or later developed.

In some embodiments where the display device 702 receives A/V content from any of HDMI interfaces 708-712 or wireless interface(s) 704, the display device 702 is additionally configured to transmit the audio data of the A/V content to the computing device 750 via link 732. In embodiments where the display device 702 receives A/V content from the computing device 750, the display device need not additionally transmit the audio data of the A/V content back to the computing device 750 via link 732. However, the display device 702 may transmit the audio data of the A/V content back to the computing device 750 via link 732 in some embodiments.

Computing device 750 comprises HDMI (ARC) interface 752 and wireless interface(s) 754. In some embodiments, computing device 750 is a playback device that includes one or more speakers, such as a home theater soundbar or other playback device. In some embodiments, computing device 750 is the same as or similar to any of the playback devices disclosed and described herein. In some embodiments, the computing device 750 comprises one or more processors and tangible, non-transitory computer-readable media with instructions stored in the computer-readable media, where the instructions, when executed by the one or more processors, cause the computing device 750 to perform one or more of the features and/or functions disclosed and described herein.

In some embodiments, computing device 750 is configured to perform one or more (or all) functions of a group coordinator for a group of playback devices, such as playback device(s) 760, e.g., by performing any one or more (or all) of the group coordinator functions disclosed and described herein, including but not limited to (i) generating clock timing, (ii) sourcing audio data, (iii) generating playback timing for audio data, (iv) distributing clock timing, audio data, and playback timing to playback devices in a playback group, and/or (v) playing audio data in synchrony with playback devices in the playback group, including playing the audio data in lip-synchrony with display of corresponding video data by the display device 702.

The playback device(s) 760 may be the same as or similar to any of the playback devices disclosed and described herein, including but not limited to a home theater soundbar or other playback device. In operation, the playback device(s) 760 are configured to play audio based on (i) clock timing received from a reference clock, (ii) audio data, and (iii) playback timing for the audio data.

In some embodiments, the computing device 750 is configured to operate in one of at least two media distribution modes: (1) a low latency mode and (2) a distributed buffering mode.

While operating in the low latency mode, the computing device 750 is configured to (i) generate playback timing for individual frames of the audio data, where the playback timing comprises, for an individual frame of audio data, an indication of a corresponding future time that is within a first duration of time from a current clock time of the computing device 750, and where the future time for the individual frame specifies a time at which the playback device(s) 760 are to play the individual frame of audio data in lip-synchrony with the video data associated with the audio data, and (ii) transmit the playback timing and the audio data to the playback device(s) 760 for playback according to the playback timing. In some embodiments, the computing device 750 may additionally transmit clock timing information to the playback device(s) 760 while operating in the low latency mode. In operation, the first duration of time used in the low latency mode is very short, e.g., on the order of between 5 and 100 milliseconds.

In operation, the computing device 750 is configured to operate in the low latency mode in scenarios where the computing device 750 receives audio data from the display device 702 via link 732. In such scenarios, the display device 702 (i) receives A/V content from a media source other than the computing device 750 (e.g., any source received via HDMI interfaces 708, 710, 712 or wireless interface(s) 704), (ii) displays the video data of the A/V content, and (iii) transmits the audio data of the A/V content to the computing device 750 via HDMI ARC link 732.

In such scenarios, the computing device 750 must process and audio data received at HDMI (ARC) interface 752 and distribution the audio data to the playback device(s) 760 fast enough so that the playback device(s) 760 have time to receive, process, and play the audio data in lip-synchrony with the corresponding video data played by the display device 702. In embodiments where computing device 750 is also a playback device, then the computing device 750 also plays the audio data in synchrony with the playback device(s) 760 and in lip-synchrony with the playback of the corresponding video data of the A/V content by the display device 702.

For example, in some embodiments, the computing device 750 is configured to operate in the low latency mode when the audio data of the A/V content is sourced from any of the Blu Ray player 720, cable box 722, or game console 724. The computing device 750 may also operate in the low latency mode when the audio data of the A/V content is sourced from a content service 770 in scenarios where the display device 702 receives the A/V content from the content service 770 via wireless interface(s) 704 and then provides the audio data of the A/V content to the computing device 750 via the HDMI ARC link 732.

While operating in the distributed buffering mode, the computing device 750 is configured to (i) generate playback timing for individual frames of the audio data, where the playback timing comprises, for an individual frame of audio data, an indication of a corresponding future time that is within a second duration of time from a current clock time of the computing device 750, where the second duration of time is greater than the first duration of time (used while operating in the low latency mode), and where the future time for the individual frame specifies a time at which the playback device(s) 760 are to play the individual frame of audio data in lip-synchrony with playback of the video data associated with the audio data by the display device 702, and (ii) transmit the playback timing and the audio data to the playback device(s) 760 for playback according to the playback timing. In some embodiments, the computing device 750 may additionally transmit clock timing information to the playback device(s) 760 while operating in the distributed buffering mode. In operation, the second duration of time is longer than the first duration of time, e.g., on the order of between about 50 milliseconds to 30 seconds in some embodiments.

In operation, the computing device 750 is configured to operate in the distributed buffering mode in scenarios where the computing device 750 (i) receives A/V content, (ii) transmits the video data of the A/V content to the display device 702 via link 732 for playback, and (iii) transmits the audio data of the A/V content to the playback device(s) 760 for playback.

In such scenarios, the computing device 750 is able to transmit the audio data of the A/V content to the playback device(s) 760 for playback very quickly after receipt of the A/V content while buffering the video data of the A/V content for up to a few seconds (and perhaps longer) before transmitting the video data to the display device 702 for playback in lip synchrony with the playback of the corresponding audio data by the playback device(s) 760.

The playback device(s) 760 are, in turn, able to buffer the audio data for several seconds (and perhaps longer) before playing back the audio data. This approach enables all of the playback device(s) 760 in a wireless home theater configuration to receive and process received audio data in sufficient time before having to play the audio data in lip synchrony with playback of the corresponding video data by the display device 702. This additional buffering time accommodates wireless home theater configurations with many more satellite playback devices 760 compared to some existing wireless home theater configurations, e.g., up to 10, 15, 20 or even more separate wireless satellite speakers.

For example, in some embodiments, the computing device 750 is configured to operate in the distributed buffering mode when the computing device 750 receives A/V content from Internet-accessible content sources 770.

Whether operating in the low latency or distributed buffering mode, the computing device 750 is configured to generate playback timing according to any of the playback timing generation methods described herein. Additionally, whether in the low latency or distributed buffering modes, the playback device(s) 760 are configured to use the clock timing, audio data, and playback timing to play the audio data in lip synchrony with playback of the video data of the A/V content by the display device 702. In embodiments where the computing device 750 is or at least comprises a playback device, the computing device 750 may additionally play the audio data according to the playback timing. The playback device(s) 760, individually or in combination with the computing device 750, are configured to play audio data based on clock timing and playback timing according to any of the playback methods disclosed and described herein.

In some embodiments, the first duration of time (in the low latency mode) is coextensive with at least a portion of the second duration of time (in the distributed buffering mode). For example, at initial startup of playback while in the distributed buffering mode, the future time (in the playback timing) may only be a few milliseconds ahead of the current clock time of the computing device 750. But as playback continues, the future time (in the playback timing) may grow to several seconds (e.g., ˜15-30 seconds) ahead of the current clock time of the computing device 750 as the computing device 750 (i) receives the A/V content, (ii) generates playback timing and transmits the audio data and playback timing to the playback device(s) 760 reasonably quickly after receipt so that the playback device(s) 760 can buffer each frame of audio data until the playback time for that frame, and (iii) buffers the video data of the A/V content before transmitting the video data to the display device 702 for playback. This approach works best when the computing device 750 receives the A/V content at a data rate (i.e., a receive rate) that is faster than the playback rate, thereby enabling the computing device 750 to buffer several seconds (and perhaps up to several minutes) of video data while transmitting the video data to the display device 702 for playback.

For example, in some embodiments, the first duration of time (used with the low latency mode) is between 5 milliseconds and 100 milliseconds, and the second duration of time (used with the distributed buffering mode) is between 50 milliseconds and 30 seconds. The second duration of time may be 50 milliseconds at initial startup of playback but may grow to 30 seconds (or perhaps more) during playback, depending on how much faster the computing device 750 receives the A/V content from the content service 770 as compared to the playback rate of the A/V content.

In some embodiments, the computing device 750 is additionally configured to switch between the low latency mode and the distributed buffering mode based on whether the computing device 750 is either (i) providing video data to the display device 702, and thus able to control when the display device 702 plays the video data (or at least control when the video data is provided to the display device 702 for playback) or (ii) receiving audio data from the display device 702, and thus required to process and distribute the audio data to the playback device(s) 760 as quickly as possible so that the audio data can be played in lip synchrony with playback of the corresponding video data by the display device 702.

For example, in some embodiments, while operating in the low latency mode, the computing device 750 is configured switch from operating in the low latency mode to operating in the distributed buffering mode after determining that the computing device 750 is receiving a stream of A/V content from a content service 770 via the Internet such that the computing device 750 is able to build up a buffer video data of the A/V content while transmitting the video data to the display device 702 for playback and transmit audio data corresponding to the video data to the playback device(s) 760 a few seconds (or even a few minutes) in advance of when the audio data will need to be played in lip synchrony with the video data.

Similarly, in some embodiments, while operating in the distributed buffering mode, the computing device 750 is configured to switch from operating in the distributed buffering mode to operating in the low latency mode after determining that the computing device 750 is receiving audio data of the A/V content from the display device 702. Switching to operation in the low latency mode causes the computing device 750 to transmit the audio data to the playback device(s) 760 with playback timing that causes the playback device(s) 760 to play the audio data as quickly possible to maintain lip synchrony with playback of the corresponding video by the display device 702 as compared to the distributed buffering mode. In some embodiments, the computing device 750 is configured to determine that it should switch from operating in the distributed buffering mode to operating in the low latency mode based on (i) receiving audio data from the display device 702 via the HDMI ARC link 732 between the display device 702 and the computing device 750 or (ii) receiving a Consumer Electronics Control (CEC) command from the display device 702 via link 732, where the command indicates that computing device 750 should switch to playing audio data that the display device 702 is transmitting via link 732.

FIG. 7B shows an example system 701 configured for wireless streaming of audio/visual content according to some embodiments.

FIG. 7B is substantially similar to FIG. 7A except that rather than Blu Ray player 720, cable box 722, and game console 724 connecting to display device 702 as in system 700 of FIG. 7A, Blu Ray player 720, cable box 722, and game console 724 in system 701 of FIG. 7B instead connect directly to computing device 750. In particular, Blu Ray player 720 is connected to HDMI A/V input 756 via link 738, cable box 722 is connected to HDMI A/V input 757 via link 736, and game console 724 is connected to HDMI A/V input 758 via link 734. The communication links shown between the devices in system 701 may be wired or wireless communications links.

In configuration 701, computing device 750 is configured to operate in the low latency mode in the same manner as described above when the computing device 750 is receiving audio data from the display device 702 via the HDMI ARC link 732. Such a scenario may occur when the display device 702 is sourcing A/V content directly from Internet-accessible content sources 770 via wireless interface(s) 704 rather than from the content sources 770 via the computing device 750. In configuration 701, the computing device 750 is also configured to operate in the low latency mode in the same manner described above when the computing device 750 is sourcing A/V content from the game console 724 and/or from the cable box 722 (at least when the A/V content from the cable box 722 is a live broadcast).

The computing device 750 in configuration 701 is configured to operate in the distributed buffering mode in the same manner described above when the computing device 750 is sourcing A/V content from an Internet-accessible content service 770, the Blu Ray player 720, and the cable box 722 (at least when the A/V content from the cable box 722 is on-demand content).

In some of embodiments of configurations 700 and 701, the display device 702 (rather than the computing device 750) may alternatively distribute audio data to the playback device(s) 760 via a wireless transmission (e.g., WiFi, Bluetooth, or other suitable wireless protocol) over communications link 730.

For example, in configuration 700 (FIG. 7A), when the display device 702 receives A/V content from any of the Blu Ray player 720, the cable box 722, game console 724, or from content services 770 (directly rather than via computing device 750), the display device 702 may transmit the audio data to the playback device(s) 760 via wireless interface(s) 704. Similarly, in configuration 701 (FIG. 7B), when the display device 702 receives A/V content from content services 770 directly rather than via computing device 750, the display device 702 may transmit the audio data to the playback device(s) 760 via wireless interface(s) 704.

In such configurations, the display device 702 may also transmit the audio data to the computing device 750 via the HDMI ARC link 752 so that the computing device 750 can also play the audio data, at least in scenarios where the computing device 750 is or at least comprises a playback device configured to play the audio data in synchrony with the other playback device(s) 760.

In some alternative embodiments where the display device 702 transmits the audio data to the playback device(s) 760 via wireless interface(s) 704, the playback device(s) are additionally configured to switch between operating in either an immediate playback mode or a playback timing mode based at least in part on whether the playback device(s) 760 are receiving audio data from (i) the display device 702 or (ii) the computing device 750.

For example, while operating in the playback timing mode, the playback device(s) 760 is/are configured to (i) receive a stream of frames comprising audio data and playback timing for the audio data from the computing device 750, where the playback timing for an individual frame of audio data corresponds to a time at which the playback device(s) 760 is/are to play the audio data of the individual frame in lip-synchrony with video data associated with the audio data, (ii) buffer the frames of audio data (and playback timing) received from the computing device 750, and (iii) play individual frames of audio data in lip-synchrony with playback of the associated video by the display device 702 according to each frame's playback timing received from the computing device 750.

And while operating in the immediate playback mode, the playback device(s) 760 is/are configured to (i) receive a stream of frames comprising audio data from the display device 702, where the audio data is associated with video data played by the display device 702, and (ii) play the audio data upon receipt from the display device 702 in lip-synchrony with playback of the associated video by the display device 702. In some embodiments, playing the audio data upon receipt form the display device 702 comprises the playback device(s) 760 playing frames of audio data as quickly as possible after receipt and without reference to playback timing. In operation, playing the audio data upon receipt may include some nominal buffering of the audio data to facilitate formation of audio samples for playback and general management of the audio data flow. But in immediate playback mode, the playback device(s) 760 play the audio as quickly as reasonably possible after receipt.

In some embodiments, while operating in the playback timing mode, the playback device(s) 760 is/are configured to switch from operating in the playback timing mode to operating in the immediate playback mode after detecting a first event corresponding to the playback device(s) 760 receiving audio data from the display device 702. For example, in some embodiments, the first event comprises the playback device(s) 760 receiving a command to switch from operating in the playback timing mode to operating in the immediate playback mode. In some embodiments, the first event comprises the playback device(s) 760 detecting receipt of at least a portion of a stream of frames comprising audio data from the display device 702 via the wireless link 730 between the display device 702 and the playback device(s) 760.

In some embodiments, when a playback device 760 switches from operating in the playback timing mode to operating in the immediate playback mode, the playback device 760 additionally flushes the audio data buffered at the playback device that was received from the computing device 750 while the playback device 760 was operating in the playback timing mode.

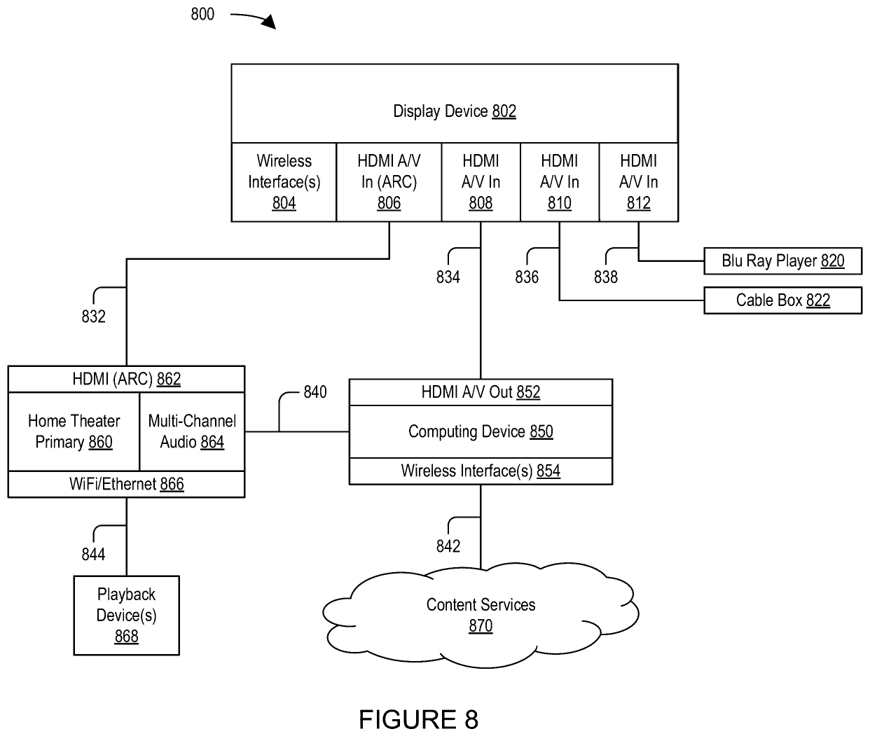

FIG. 8 shows an example system 800 configured for wireless streaming of audio/visual content according to some embodiments.

System 800 includes display device 802, computing device 850, Blu Ray player 820, cable box 822, playback device(s) 868, and home theater primary 860. Display device 802, Blu Ray player 820, cable box 822, and playback device(s) 868 in system 800 are the same or similar to display device 702, Blu Ray player 720, cable box 722, and playback device(s) 760 in systems 700 and 701 (FIGS. 7A-B). Home theater primary 860 is a component not shown in systems 700 and 701. Computing device 850 performs many of the same functions as computing device 750 (FIGS. 7A-B) but also some different functions as described below. The communication links shown between the devices in system 800 may be wired or wireless communications links.

Home theater primary 860 comprises HDMI (ARC) interface 862, multi-channel audio interface 864, and wireless interface(s) 866. In operation, home theater primary 860 is a playback device that includes one or more speakers, such as a home theater soundbar or other playback device. In some embodiments, home theater primary 860 is the same as or similar to any of the playback devices disclosed and described herein. In some embodiments, the home theater primary 860 comprises one or more processors and tangible, non-transitory computer-readable media with instructions stored in the computer-readable media, where the instructions, when executed by the one or more processors, cause the home theater primary 860 to perform one or more of the features and/or functions disclosed and described herein.

In some embodiments, home theater primary 860 is configured to perform one or more (or all) functions of a group coordinator for a group of playback devices, such as playback device(s) 868, e.g., by performing any one or more (or all) of the group coordinator functions disclosed and described herein, including but not limited to (i) generating clock timing, (ii) sourcing audio data, (iii) generating playback timing for audio data, (iv) distributing clock timing, audio data, and playback timing to playback devices in a playback group, and/or (v) playing audio data in synchrony with playback devices in the playback group, including playing the audio data in lip-synchrony with display of corresponding video data by the display device 802.

The playback device(s) 868 may be the same as or similar to any of the playback devices disclosed and described herein. In operation, the playback device(s) 868 are configured to play audio based on (i) clock timing received from a reference clock, (ii) audio data, and (iii) playback timing for the audio data.

In some embodiments, the home theater primary 860 is configured to operate in one of at least two media distribution modes: (1) a low latency mode and (2) a distributed buffering mode. In operation, the home theater primary 860 operates in the low latency and distributed buffering modes in the substantially the same manner as computing device 750 (FIGS. 7A-B).

While operating in the low latency mode, the home theater primary 860 is configured to (i) generate playback timing for individual frames of the audio data, where the playback timing comprises, for an individual frame of audio data, an indication of a corresponding future time that is within a first duration of time from a current clock time of the home theater primary 860, and where the future time for the individual frame specifies a time at which the playback device(s) 868 are to play the individual frame of audio data in lip-synchrony with the video data associated with the audio data, and (ii) transmit the playback timing and the audio data to the playback device(s) 868 for playback according to the playback timing. In some embodiments, the home theater primary 860 may additionally transmit clock timing information to the playback device(s) 868 while operating in the low latency mode.

In operation, the home theater primary 860 is configured to operate in the low latency mode in scenarios where the home theater primary 860 receives audio data from the display device 802 via the HDMI ARC connection 832. For example, in some embodiments, the home theater primary 860 receives audio data from the display device 802 via the HDMI ARC connection 832 (and thus operates in the low latency mode) when the display device 802 sources the A/V content from any of (i) the Blu Ray player 820, (ii) the cable box 822, (iii) a game console (not shown), or (iv) the content service 870 in scenarios where the display device 802 receives the A/V content via wireless interface(s) 804 and then provides the audio data of the A/V content to the home theater primary 860 via the HDMI ARC link 832.

In the low latency mode, the home theater primary 860 must process the audio data received from the display device 802 at HDMI (ARC) interface 862 via link 832 and distribute the processed audio data to the playback device(s) 868 via link 844 fast enough so that the playback device(s) 868 have time to receive, process, and play the audio data in lip-synchrony with the corresponding video data played by the display device 802. In operation, home theater primary 860 also plays the audio data in synchrony with the playback device(s) 868 and in lip-synchrony with playback of the corresponding video data by the display device 802.

While operating in the distributed buffering mode, the home theater primary 860 is configured to (i) generate playback timing for individual frames of the audio data, where the playback timing comprises, for an individual frame of audio data, an indication of a corresponding future time that is within a second duration of time from a current clock time of the home theater primary 860, where the second duration of time is greater than the first duration of time (used while operating in the low latency mode), and where the future time for the individual frame specifies a time at which the playback device(s) 868 is/are to play the individual frame of audio data in lip-synchrony with the video data associated with the audio data, and (ii) transmit the playback timing and the audio data to the playback device(s) 868 for playback according to the playback timing. In some embodiments, the home theater primary 860 may additionally transmit clock timing information to the playback device(s) 868 while operating in the distributed buffering mode.

In operation, the home theater primary 860 is configured to operate in the distributed buffering mode in scenarios where the computing device 850 (i) receives A/V content (from the content services 870 or from another A/V content source), (ii) transmits the video data of the A/V content to the display device 802 via link 834 for playback, and (iii) transmits the audio data of the A/V content to the home theater primary 860 via link 840 for distribution to and playback in synchrony by the playback device(s) 868. In this scenario, the home theater primary 860 receives the audio data from the computing device 850, generates playback timing for the audio data, and transmits the audio data and playback timing for the audio data to the playback device(s) 868 for playback in lip synchrony with playback of the corresponding video data by the display device 802.

In operation, the home theater primary 860 is able to transmit the audio data of the A/V content to the playback device(s) 868 for playback very quickly after receipt of the audio data from the computing device 850 while the computing device 850 buffers the a few seconds (or up to a few minutes) of video data of the A/V content while transmitting the video data to the display device 802 for playback in lip synchrony with playback of the corresponding audio data by the playback device(s) 868 and the home theater primary 860.

The playback device(s) 868 are, in turn, able to buffer the audio data for several seconds (or even several minutes) before playing back the audio data according to the playback timing received from the home theater primary 860. This approach enables the home theater primary 860 and all of the playback device(s) 868 in configuration 800 to receive and process received audio data in sufficient time before having to play the audio data in lip synchrony with playback of the corresponding video data by the display device 802.

For example, in some embodiments, the home theater primary 860 is configured to operate in the distributed buffering mode when the computing device 850 receives A/V content from Internet-accessible content sources 870.

Whether operating in the low latency or distributed buffering mode, the home theater primary 860 is configured to generate playback timing according to any of the playback timing generation methods described herein. Additionally, whether in the low latency or distributed buffering modes, the playback device(s) 868 are configured to use the clock timing, audio data, and playback timing to play the audio data in lip synchrony with playback of the video data of the A/V content by the display device 802. The home theater primary 860 additionally plays the audio data according to the playback timing. The playback device(s) 868, individually or in combination with the home theater primary 860, are configured to play audio data based on clock timing and playback timing according to any of the playback methods disclosed and described herein.

In some embodiments, the computing device 850 additionally generates playback timing for the video data, where the playback timing for an individual frame of video indicates a time (relative to the clock time of the computing device 850 or perhaps the home theater primary 860) at which the display device 802 is to play the frame of video data. The computing device 850 also transmits the video data and the playback timing for the video data to the display device 802. In some embodiments, the computing device 850 (or perhaps the home theater primary 860) also provides clock timing information to the display device 802. The display device 802 in some embodiments also uses the clock timing and the playback timing for the video data to play the video data in lip synchrony with playback of the audio data by the home theater primary 860 and the playback devices 868 in a manner similar to how individual playback devices use clock timing information and playback timing for audio data to play audio data in synchrony with each other, as described herein. However, the display device 802 can instead play the video data upon receipt rather than using clock timing and playback timing to play the video data.

In some embodiments, the first duration of time (in the low latency mode) is coextensive with at least a portion of the second duration of time (in the distributed buffering mode). For example, at initial startup of playback while in the distributed buffering mode, the future time (in the playback timing) may only be a few milliseconds ahead of the current clock time of the home theater primary 860. But as playback continues, the future time (in the playback timing) may grow to several seconds (e.g., ˜15-30 seconds, or even a few minutes) ahead of the current clock time of the home theater primary 860 as the home theater primary 860 (i) receives the audio data from the computing device 850 via link 840, (ii) generates playback timing and transmits the audio data and playback timing to the playback device(s) 868 reasonably quickly after receipt so that the playback device(s) 868 can buffer the audio data until playing each frame of audio at the frame's playback time. This approach works best when the computing device 850 receives the A/V content at a data rate that is faster than the playback rate (by the display device 802, home theater primary 860 and playback device(s) 868), thereby enabling the computing device 850 to buffer several seconds (or maybe even several minutes) of video data while transmitting the video data to the display device 802 for playback.

For example, in some embodiments, the first duration of time (used with the low latency mode) is between 5 milliseconds and 100 milliseconds, and the second duration of time (used with the distributed buffering mode) is between 50 milliseconds and 30 seconds. The second duration of time may be 50 milliseconds at initial startup of playback but may grow to 30 seconds (or perhaps more) during playback, depending on how much faster the computing device 850 receives the A/V content from the content service 870 as compared to the playback rate of the A/V content.

In some embodiments, the home theater primary 860 is additionally configured to switch between operating in the low latency mode and operating in the distributed buffering mode based on whether (i) the computing device 850 is providing video data to the display device 802 and audio data to the home theater primary 860, thereby enabling the computing device 850 to control when the display device 802 plays the video data (or at least control when the video data is provided to the display device 802 for playback) or (ii) the home theater primary 860 is receiving audio data from the display device 802, and thus is required to process and distribute the audio data to the playback device(s) 868 as quickly as possible so that the audio data is played in lip synchrony with playback of the corresponding video data by the display device 802.

For example, in some embodiments, while operating in the low latency mode, the home theater primary 860 is configured switch from operating in the low latency mode to operating in the distributed buffering mode after determining that the home theater primary 860 is receiving audio data from the computing device 850 via link 840.

Similarly, in some embodiments, while operating in the distributed buffering mode, the home theater primary 860 is configured to switch from operating in the distributed buffering mode to operating in the low latency mode after determining that the home theater primary 860 is receiving audio data from the display device 802 via the HDMI ARC link 832. Switching to operation in the low latency mode causes the home theater primary 860 to transmit the audio data to the playback device(s) 868 with playback timing that causes the playback device(s) 868 to play the audio data as quickly possible to maintain lip synchrony with playback of the corresponding video by the display device 802 as compared to the distributed buffering mode.

In some embodiments, the home theater primary 860 is configured to determine that it should switch from operating in the distributed buffering mode to operating in the low latency mode based on (i) receiving audio data from the display device 802 via the HDMI ARC link 832 between the display device 802 and the home theater primary 860 or (ii) receiving a Consumer Electronics Control (CEC) command from the display device 802 via link 832 that instructs the home theater primary 860 to play audio data that the display device 802 is transmitting via link 832.

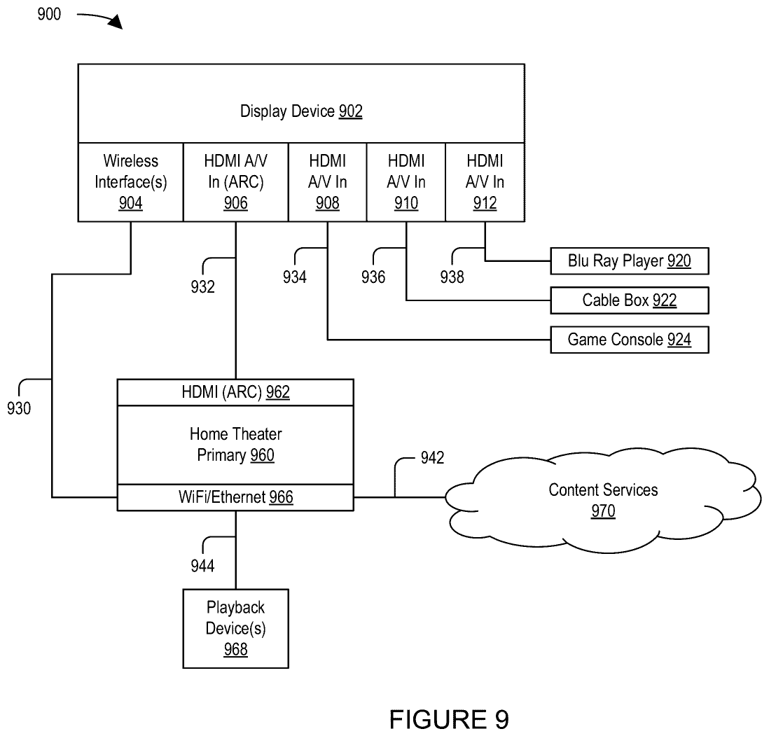

FIG. 9 shows an example system 900 configured for wireless streaming of audio/visual content according to some embodiments.

System 900 includes display device 902, Blu Ray player 920, cable box 922, game console 924, playback device(s) 968, and home theater primary 960. Display device 902, Blu Ray player 920, cable box 922, game console 924, and playback device(s) 968 in system 900 are the same or substantially the same as display device 702, Blu Ray player 720, cable box 722, and playback device(s) 760 in systems 700 and 701 (FIGS. 7A-B). Home theater primary 960 is configured to perform at least some features of home theater primary 860 and computing devices 750 and 850 in FIGS. 7A-B and 8 as described herein. The communication links shown between the devices in system 900 may be wired or wireless communications links.

Home theater primary 960 comprises HDMI (ARC) interface 962 and wireless interface(s) 966. In operation, home theater primary 960 is a playback device that includes one or more speakers, such as a home theater soundbar or other playback device. In some embodiments, home theater primary 960 is the same as or similar to any of the playback devices disclosed and described herein. In some embodiments, the home theater primary 960 comprises one or more processors and tangible, non-transitory computer-readable media with instructions stored in the computer-readable media, where the instructions, when executed by the one or more processors, cause the home theater primary 960 to perform one or more of the features and/or functions disclosed and described herein.

In some embodiments, home theater primary 960 is configured to perform one or more (or all) functions of a group coordinator for a group of playback devices, such as playback device(s) 968, e.g., by performing any one or more (or all) of the group coordinator functions disclosed and described herein, including but not limited to (i) generating clock timing, (ii) sourcing audio data, (iii) generating playback timing for audio data, (iv) distributing clock timing, audio data, and playback timing to playback devices in a playback group, and/or (v) playing audio data in synchrony with playback devices in the playback group, including playing the audio data in lip-synchrony with display of corresponding video data by the display device 902.

The playback device(s) 968 may be the same as or similar to any of the playback devices disclosed and described herein. In operation, the playback device(s) 968 are configured to play audio based on (i) clock timing received from a reference clock, (ii) audio data, and (iii) playback timing for the audio data.

In some embodiments, the home theater primary 960 is configured to operate in one of at least two media distribution modes: (1) a low latency mode and (2) a distributed buffering mode. In operation, the home theater primary 960 operates in the low latency and distributed buffering modes in the substantially the same manner as computing device 750 (FIGS. 7A-B).

While operating in the low latency mode, the home theater primary 960 is configured to (i) generate playback timing for individual frames of the audio data, where the playback timing comprises, for an individual frame of audio data, an indication of a corresponding future time that is within a first duration of time from a current clock time of the home theater primary 960, and where the future time for the individual frame specifies a time at which the playback device(s) 960 is/are to play the individual frame of audio data in lip-synchrony with the video data associated with the audio data, and (ii) transmit the playback timing and the audio data to the playback device(s) 968 for playback according to the playback timing. In some embodiments, the home theater primary 960 may additionally transmit clock timing information to the playback device(s) 968 while operating in the low latency mode.

In operation, the home theater primary 960 is configured to operate in the low latency mode in scenarios where the home theater primary 860 receives audio data from the display device 902 via the HDMI ARC connection 932. For example, in some embodiments, the home theater primary 960 receives audio data from the display device 902 via the HDMI ARC connection 932 (and thus operates in the low latency mode) when the A/V content is sourced from any of (i) the Blu Ray player 920, (ii) the cable box 922, (iii) the game console 924, or (iv) the content service 970 in scenarios where the display device 902 receives the A/V content via wireless interface(s) 904 and then provides the audio data of the A/V content to the home theater primary 960 via the HDMI ARC link 932.

In the low latency mode, the home theater primary 960 must process the audio data received from the display device 902 at HDMI (ARC) interface 962 via link 932 and distribute the processed audio data to the playback device(s) 968 via link 944 fast enough so that the playback device(s) 968 have time to receive, process, and play the audio data in lip-synchrony with the corresponding video data played by the display device 902. In operation, home theater primary 960 also plays the audio data in synchrony with the playback device(s) 968 and in lip-synchrony with playback of the corresponding video data by the display device 902.

While operating in the distributed buffering mode, the home theater primary 960 is configured to (i) generate playback timing for individual frames of the audio data, where the playback timing comprises, for an individual frame of audio data, an indication of a corresponding future time that is within a second duration of time from a current clock time of the home theater primary 960, where the second duration of time is greater than the first duration of time (used while operating in the low latency mode), and wherein the future time for the individual frame specifies a time at which the playback device(s) 968 is/are to play the individual frame of audio data in lip-synchrony with the video data associated with the audio data, and (ii) transmit the playback timing and the audio data to the playback device(s) 968 for playback according to the playback timing. In some embodiments, the home theater primary 960 may additionally transmit clock timing information to the playback device(s) 968 while operating in the distributed buffering mode.

In operation, the home theater primary 960 is configured to operate in the distributed buffering mode in scenarios where the home theater primary 960 (i) receives A/V content (from the content services 970 or from another A/V content source), (ii) transmits the video data of the A/V content to the display device 902 via link 834 for playback, and (iii) transmits the audio data of the A/V content to the playback device(s) 968 via link 944 for playback. In this scenario, while receiving the A/V content, the home theater primary 960, generates playback timing for the audio data, and transmits the audio data and playback timing for the audio data to the playback device(s) 868 for playback in lip synchrony with playback of the corresponding video data by the display device 902.

In operation, the home theater primary 960 is able to transmit the audio data of the A/V content to the playback device(s) 968 for playback very quickly after receipt while the home theater primary 960 builds up a buffer of a few seconds (or perhaps a few minutes) of video data while transmitting the video data to the display device 902 for playback in lip synchrony with playback of the corresponding audio data by the playback device(s) 968 and the home theater primary 960. The home theater primary 960 is able to buffer a few seconds (or a few minutes) of video while transmitting the video data to the display device 902 for playback when the receipt rate of the A/V content from the content source is faster than the playback rate of the A/V content by the display device 902, home theater primary 960, and playback device(s) 968.

The playback device(s) 968 are, in turn, able to buffer several seconds (or several minutes) of audio data while playing back individual frames of audio data according to each frame's playback timing received from the home theater primary 960. This approach enables the home theater primary 960 and all of the playback device(s) 968 in configuration 900 to receive and process received audio data in sufficient time before having to play the audio data in lip synchrony with playback of the corresponding video data by the display device 902.

For example, in some embodiments, the home theater primary 960 is configured to operate in the distributed buffering mode when the home theater primary 960 receives A/V content from Internet-accessible content sources 870.

Whether operating in the low latency or distributed buffering mode, the home theater primary 960 is configured to generate playback timing according to any of the playback timing generation methods described herein. Additionally, whether the home theater primary 960 is operating in the low latency or distributed buffering modes, the playback device(s) 968 are configured to use the clock timing, audio data, and playback timing to play the audio data in lip synchrony with playback of the video data of the A/V content by the display device 902. The home theater primary 960 additionally plays the audio data according to the playback timing. The playback device(s) 968, individually or in combination with the home theater primary 960, are configured to play audio data based on clock timing and playback timing according to any of the playback methods disclosed and described herein.

In some embodiments, the home theater primary 960 additionally generates playback timing for the video data, where the playback timing for an individual frame of video indicates a time (relative to the clock time of the home theater primary 960) at which the display device 902 is to play the frame of video data. The home theater primary 960 also transmits the video data and the playback timing for the video data to the display device 902. In some embodiments, the home theater primary 960 also provides clock timing information to the display device 902. The display device 902 in some embodiments also uses the clock timing and the playback timing for the video data to play the video data in lip synchrony with playback of the audio data by the home theater primary 960 and the playback devices 968 in a manner similar to how individual playback devices use clock timing information and playback timing for audio data to play audio data in synchrony with each other, as described herein. However, the display device 902 can instead play the video data upon receipt rather than using clock timing and playback timing to play the video data, with the home theater primary 960 controlling when to provide individual frames of video to the display device 902.

In some embodiments, the first duration of time (in the low latency mode) is coextensive with at least a portion of the second duration of time (in the distributed buffering mode). For example, at initial startup of playback while in the distributed buffering mode, the future time (in the playback timing) may only be a few milliseconds ahead of the current clock time of the home theater primary 960. But as playback continues, the future time (in the playback timing) may grow to several seconds (e.g., ˜15-30 seconds or even a few minutes) ahead of the current clock time of the home theater primary 960 as the home theater primary 960 (i) receives the audio data, (ii) generates playback timing and transmits the audio data and playback timing to the playback device(s) 968 reasonably quickly after receipt so that the playback device(s) 968 can buffer the audio data until playing each frame of audio at its playback time. As mentioned earlier, this approach works best when the home theater primary 960 receives the A/V content at a data rate that is faster than the playback rate (by the display device 902, home theater primary 960 and playback device(s) 968), thereby enabling the home theater primary 960 to buffer several seconds (or maybe even several minutes) of video data before transmitting the video data to the display device 902 for playback.

For example, in some embodiments, the first duration of time (used with the low latency mode) is between 5 milliseconds and 100 milliseconds, and the second duration of time (used with the distributed buffering mode) is between 50 milliseconds and 30 seconds. The second duration of time may be 50 milliseconds at initial startup of playback but may grow to 30 seconds (or perhaps more) during playback, depending on how much faster the home theater primary 960 receives the A/V content from the content service 970 as compared to the playback rate of the A/V content.

In some embodiments, the home theater primary 960 is additionally configured to switch between operating in the low latency mode and operating in the distributed buffering mode based on whether (i) the home theater primary 960 is providing video data to the display device 902 and audio data to the playback device(s) 968, thereby enabling the home theater primary 960 to control when the display device 902 plays the video data (or at least control when the video data is provided to the display device 902 for playback) or (ii) the home theater primary 960 is receiving audio data from the display device 902, and thus is required to process and distribute the audio data to the playback device(s) 968 as quickly as possible so that the audio data is played in lip synchrony with playback of the corresponding video data by the display device 902.

For example, in some embodiments, while operating in the low latency mode, the home theater primary 960 is configured switch from operating in the low latency mode to operating in the distributed buffering mode after determining that the home theater primary 960 is receiving A/V content from content source 970.

Similarly, in some embodiments, while operating in the distributed buffering mode, the home theater primary 860 is configured to switch from operating in the distributed buffering mode to operating in the low latency mode after determining that the home theater primary 960 is receiving audio data from the display device 902 via the HDMI ARC link 932. Switching to operation in the low latency mode causes the home theater primary 960 to transmit the audio data to the playback device(s) 968 with playback timing that causes the playback device(s) 968 to play the audio data as quickly possible to maintain lip synchrony with playback of the corresponding video by the display device 902 as compared to the distributed buffering mode.

In some embodiments, the home theater primary 960 is configured to determine that it should switch from operating in the distributed buffering mode to operating in the low latency mode based on (i) receiving audio data from the display device 902 via the HDMI ARC link 932 between the display device 902 and the home theater primary 960 or (ii) receiving a Consumer Electronics Control (CEC) command from the display device 902 via link 932.

### VII. Examples of Experience and Environment Sharing

In various examples, the systems and methods described above for sharing experiences and/or environments can enable richer user interactions with social media content than conventional approaches. Moreover, the disclosed systems and methods enable social media providers to provide additional types of media and experiences relative to conventional approaches. For example, rather than posting a playlist of songs that a provider likes to listen to, the provider can share with subscribers the songs they are listening to in real-time in addition to information about the provider's state and/or environment (i.e., the provider's moodscape), such as lighting, scents, temperature, humidity, etc.). In turn, the disclosed systems and methods can configure each subscriber's environment to match or approximate to the provider's environment by, for example, adjusting the lighting, scents, temperature, humidity, etc. of the provider's environment. Moreover, a provider's stream of content and moodscape parameters can be stored and consumed by subscribers at a later time. As described in further detail below, a multitude of moodscape adjustments are enabled by this architecture.

Systems and methods for sharing moodscape parameters via one or more media playback systems are disclosed. In some examples, the media playback system comprises at least one network interface, at least one processor, one or more playback devices, such as audio/video playback devices, lighting devices, humidifiers, etc., one or more sensors for detecting moodscape parameters (e.g., a provider's state or condition, such as mood or emotional state, environmental or contextual data, provider-selected and/or -generated content, and so on. The media playback system further comprises data storage having instructions stored thereon that, when executed by the one or more processors, cause the media playback system to perform operations comprising: receiving, via the at least one network interface, one or more moodscape input parameters, the moodscape comprising one or more of audio, lighting, visual display, scent, temperature, etc. characteristics of a space and tending to generate or reflect a certain mood, attitude, emotional characteristic, etc. In some embodiments, the one or more moodscape input parameters comprise one or more of a) indications of a provider mood, emotional state, or physical state (e.g., physiological sensor data such as brainwave data, heart rate, respiratory rate, perspiration, body temperature, voice analysis, sleep/wake determination); b) indications of provider sensor or contextual data (e.g., ambient conditions associated with provider such as temperature, humidity, lighting conditions, colors, luminance, ambient sounds, weather conditions, scents, media settings (e.g., EQ levels), etc.); c) provider-selected media content (e.g., audio, video, extended reality (AR/MR/VR) content); or d) provider-generated content (e.g., ambient sounds, provider spoken word audio, provider point of view video).

In some cases, the one or more moodscape input parameters comprise a predefined set of parameters available for on-demand playback and may be based on real-time data regarding remote activity (e.g., provider activity such as provider's current media stream). Based on the one or more moodscape input parameters and one or more system characteristics of the media playback system, the media playback system maps the one or more moodscape input parameters to one or more playback device outputs by, for example, a) identifying available playback devices of the media playback system (e.g., audio playback devices, video playback devices, lighting devices, scent-producing devices, temperature-control devices, and associated characteristics of these devices); b) applying one or more user-provided restrictions (e.g., no adult content, excluding certain lights/scents, volume restrictions, etc.); and/or applying one or more contextual restrictions (e.g., based on time of day, room/location of particular playback devices, etc.). Subsequently, the media playback system causes the one or more playback devices of the media playback system to play back content based on the playback device outputs. In some cases, the media playback system transmits a request for a particular moodscape prior to receiving the one or more moodscape input parameters. The request for the particular moodscape can be generated in response to presentation of a user interface representing a plurality of available moodscapes to the user for selection, the plurality of available moodscapes including the particular moodscape requested by the user and based on one or more of: a) indications of a user mood, emotional state, or physical state (e.g., physiological sensor data such as brainwave data, heart rate, respiratory rate, perspiration, body temperature, voice analysis, sleep/wake determination); b) indications of user sensor or contextual data (e.g., ambient conditions associated with the user such as temperature, humidity, lighting conditions, colors, luminance, ambient sounds, weather conditions, scents, media settings (e.g., audio EQ levels), etc.); c) user media content information (e.g., user listening/viewing history, favorited media content, etc.); and/or user voice input. Techniques for sharing media settings (e.g., EQ levels) are described in U.S. Pat. No. 9,367,283 issued on Jun. 14, 2016, entitled “Audio Setting,” which is herein incorporated by reference in its entirety.

In some examples, the disclosed technology enables a provider to author a time-based moodscape and, in effect, act as an experiential or emotional “DJ” for their subscribers. For example, the provider's emotional state can be ascertained or inferred from one or more sensors (e.g., a biometric data sensor) while the provider is consuming content, such as a song, set of songs (e.g., album, playlist), film, etc. In this manner, a timeline of the provider's emotional state and/or context (e.g., environmental data such as temperature, weather data, time of day, etc.) while consuming the underlying content is recorded. A media playback system can then use this “emotional timeline,” or timed sequences of emotional input parameters, to enable a subscriber to experience the same or similar emotional timeline by mapping changes or transitions in the provider's emotional state and/or context to the subscriber's profile (e.g., listening history, emotional mood history, and/or other user metadata or preferences) and available devices (e.g., playback devices, lights, display devices, thermostats, etc.) and determining how to affect the same or similar emotional timeline for the subscriber. In some examples, the content and moodscape alterations used to create the emotional timeline for the subscriber may be different than the content and moodscape alterations used to generate the original emotional timeline (i.e., the provider's emotional timeline). Accordingly, the subscriber may experience the same or similar emotional timeline while consuming different content and experience different changes to their environment. Techniques for determining, changing and/or influencing a user's experience or emotional state are described in International Application No. PCT/US2021/071260, filed on Aug. 24, 2021, entitled “Mood Detection and/or Influence via Audio Playback Devices” and U.S. patent application Ser. No. 17/302,690, filed on May 10, 2021, entitled “Playback of Generative Media Content,” each of which is herein incorporated by reference in its entirety.

By mapping the provider's emotional timeline to moodscape transitions for a subscriber, the disclosed techniques allow the subscriber to experience an emotional journey substantially similar to what the provider experienced at a past time or is currently experiencing in near real-time. In some instances, generative audio may be used to fill in emotional gaps along the journey when the appropriate traditional or prerendered media content cannot be identified for that user. Techniques for generating audio—including, for instance, algorithmically generated audio—are described in International Application No. PCT/US2021/072454, filed on Nov. 17, 2021, entitled “Playback of Generative Media Content” and U.S. patent application Ser. No. 17/302,690, filed on May 10, 2021, entitled “Playback of Generative Media Content,” each of which is herein incorporated by reference in its entirety.

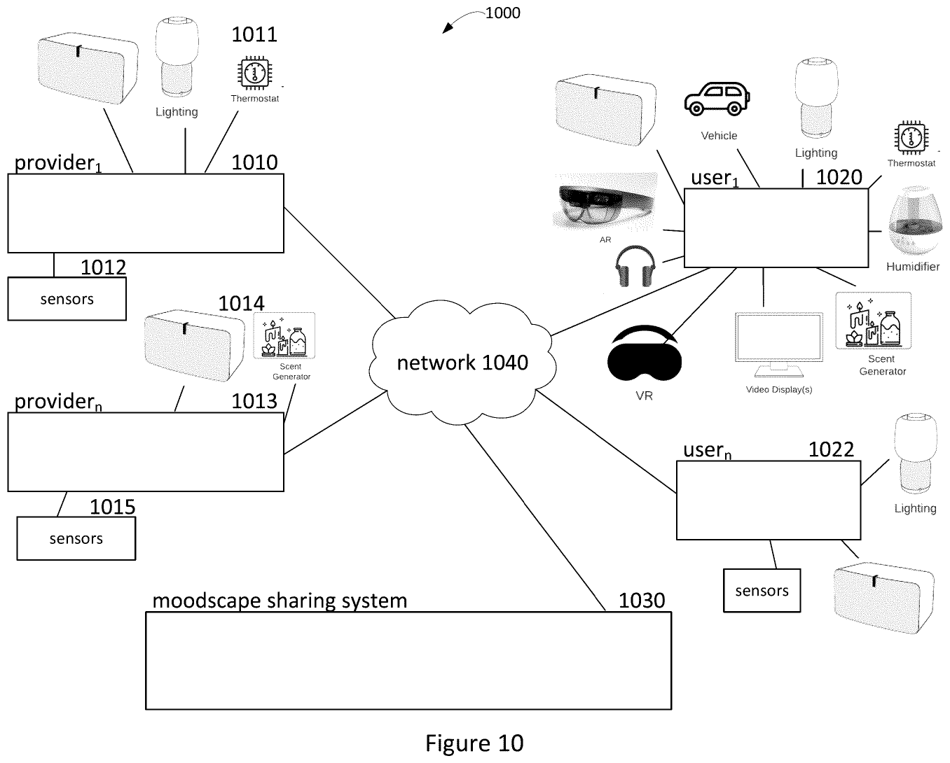

FIG. 10 is a schematic view of a media playback environment 1000 for sharing moodscapes in accordance with examples of the disclosed technology. In the illustrated example, environment 1000 includes provider systems 1010 and 1013, user systems 1020 and 1022, a moodscape sharing system 1030, and network 1040. A first provider system 1010 has a number of associated playback devices 1011 (including a media content playback device, a lighting system, and a thermostat) and sensors 1012. Accordingly, the first provider system 1010 can collect and provide information relating to playback of content, lighting, thermostat data, and information collected from any of the sensors 1012. In some examples, the sensors may include sensors for measuring the provider's mood or emotional state, such as sensors for detecting brainwave data, heart rate, respiratory rate, perspiration, body temperature, a voice analyzer, a sensor for determining whether the provider is awake or asleep. The sensors may further include sensors for measuring ambient conditions, such as temperature, humidity, lighting conditions, lighting colors, luminance, ambient sounds, weather conditions, aromas, etc. The sensors may also include a microphone for capturing provider-generated content, such as spoken word audio, a provider point of view video (e.g., video and audio captured from a camera worn by the provider). A second provider system 1013 has a number of associated playback devices 1014 (including a media content playback device and a scent generator) and sensors 1015. Accordingly, the second provider system can collect and provide information relating to the playback of content and information relating to generating scents and information collected from sensors 1015, such as the sensors described above or any other types of sensors. One of ordinary skill in the art will recognize that provider systems can include any number and combinations of playback devices and sensors, including wearable and non-wearable devices and sensors.

The illustrated environment 1000 further includes a first user system 1020, which includes a number of associated playback devices, including a media content playback device, a vehicle, a lighting system, a thermostat, a humidifier, a scent generator system, a video display system, a virtual reality system, a pair of headphones, and an augmented reality system. Accordingly, the first user system can receive content along with parameters for each of these devices from one or more providers and configure these devices in accordance with the provided parameters to modify these devices, for example, during playback of content. For example, the first user system could receive content corresponding to what the provider is currently watching along with the temperature of the room in which the provider is watching. Accordingly, the first user system could receive and display the content on the video display system(s) while controlling the thermostat to match the temperature of the provider's environment. As another example, if the user is currently in a vehicle, video and/or audio content being consumed by the provider could be streamed via display and speakers in the vehicle and the temperature inside the vehicle (or inside a zone in which the user is positioned in the vehicle) could be adjusted to match the temperature of the provider's environment. A second user system 1022 includes an associated lighting system, media content playback device, and sensors. Accordingly, the second user system 1022 can be adjusted to match the lighting of a provider's environment and to playback content. Moreover, the second user system may use the associated sensors to detect differences between a provider's environment and notify a corresponding user of adjustments the user can make (e.g., manually) to playback devices that may not be subject to automated control by the system itself, such as a notification to adjust the heat or humidity in a room, a notification to burn a particular type of candle or incense, and so on. In some examples, the sensors may be used as part of an active feedback system in which devices are automatically adjusted such that the particular devices in the user's environment are substantially simulating corresponding provider parameters within the operational capabilities of the device. For instance, a provider parameter(s) may indicate an overall lighting brightness in the environment of 500 lumens and a color temperature of 2700K. An initial output sent to a corresponding light or set of lights in the user environment to simulate the provider light parameter may result in a 300 lumens with color temperature 5000K. The user system, using data obtained via the sensors, may adjust the output sent to the individual lights to simulate (or at least substantially simulate) the provider light parameters. The system can continue to monitor user devices via the sensors such that the user devices continue to simulate (or at least substantially simulate) the provider parameters within operational capabilities of the device(s). One of ordinary skill in the art will recognize that user systems can include any number and combinations of playback devices and sensors, including wearable and non-wearable devices and sensors.

Moodscape sharing system 1030 provides an intermediary system that can be used to, for example, store and manage subscription information, store recorded provider experiences, store user preferences, relay moodscape parameters and requests between providers and users, and so on. Each of the systems in environment 1000 may communicate directly or via one or more networks, such as network 1040, which may include any type of network, such a local area network, a wide area network, a wireless network, the Internet, or any combination of networks. One of ordinary skill in the art will recognize that a provider system may perform as a user system and vice versa. For example, a user subscribed to one provider may also share content and parameters subscribed to by one or more users.

In some examples, one or more users can subscribe to a provider (or media content, moodscapes, etc. associated with the provider) via data stored on a distributed ledger, such as a blockchain. For instance, one or more users can own, possess, or otherwise access blockchain data such as a token (e.g., a non-fungible token (NFT)) or a smart contract that allows the user(s) to subscribe or otherwise access a particular moodscape, media content, generative artificial intelligence (GAI) content or models, radio station, and/or collections of media content. In some examples, data associated with the environment 1000 (e.g., provider devices, provider sensors, provider preferences, user devices, user sensors, user preferences, etc.) can be stored on and/or associated with blockchain data such as one or more NFTs. Techniques for generating media content via GAI based on blockchain data, providing access to GAI content via blockchain tokens, orchestration of devices, blockchain data (e.g., tokens, smart contracts) and GAI content, models, etc. are described in International Application No. PCT/US2023/066776, filed on May 18, 2022, entitled “GENERATING DIGITAL MEDIA BASED ON BLOCKCHAIN DATA,” and incorporated by reference herein in its entirety.

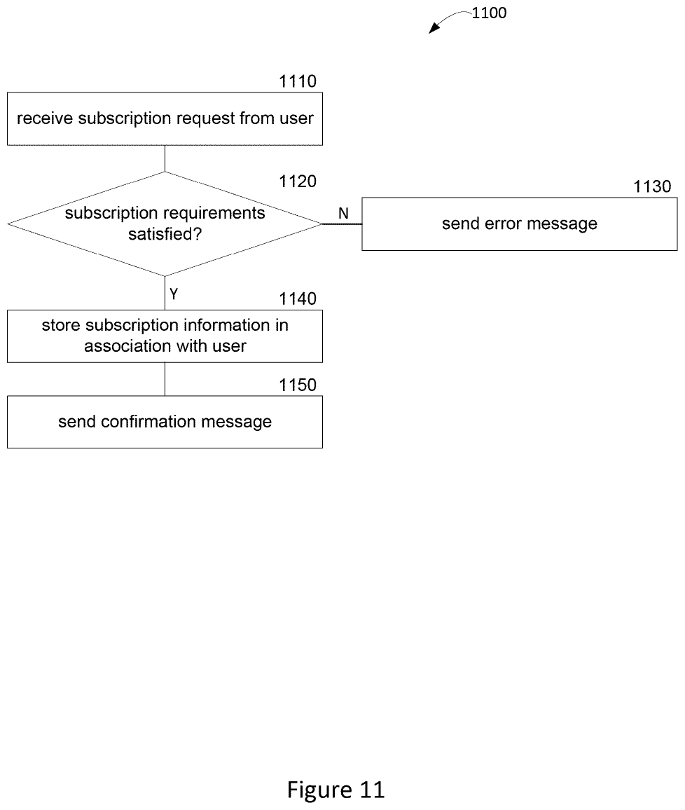

FIGS. 11-13 illustrate example methods in accordance with the present technology. The methods 1100, 1200, and 1300 can be implemented by any of the devices described herein, or any other devices now known or later developed. Various embodiments of the methods 1100, 1200, and 1300 include one or more operations, functions, or actions illustrated by blocks. Although the blocks are illustrated in sequential order, these blocks may also be performed in parallel, and/or in a different order than the order disclosed and described herein. Also, the various blocks may be combined into fewer blocks, divided into additional blocks, and/or removed based upon a desired implementation.

In addition, for the methods 1100, 1200, and 1300 and for other processes and methods disclosed herein, the flowcharts show functionality and operation of possible implementations of some embodiments. In this regard, each block may represent a module, a segment, or a portion of program code, which includes one or more instructions executable by one or more processors for implementing specific logical functions or steps in the process. The program code may be stored on any type of computer readable medium, for example, a storage device including a disk or hard drive. The computer readable medium may include non-transitory computer readable media, for example, such as tangible, non-transitory computer-readable media that stores data for short periods of time like register memory, processor cache, and Random-Access Memory (RAM). The computer readable medium may also include non-transitory media, such as secondary or persistent long-term storage, like read only memory (ROM), optical or magnetic disks, compact disc read only memory (CD-ROM), for example. The computer readable media may also be any other volatile or non-volatile storage systems. The computer readable medium may be considered a computer readable storage medium, for example, or a tangible storage device. In addition, for the methods and for other processes and methods disclosed herein, each block in FIGS. 11-13 may represent circuitry that is wired to perform the specific logical functions in the process.

FIG. 11 illustrates an example method 1100 for processing a subscription request received from a user. The subscription request may be received by, for example, a provider system or a moodscape sharing system. The method 1100 begins at block 1110, which involves receiving a subscription request from a user for a particular social media provider. The subscription request may include an indication of the moodscape parameters that the user is interested in subscribing to in addition to any user preference or restriction information, such as preferred locations or environments for particular times, content restrictions, and so on. For example, if the user's environment includes controllable lighting and a scent generator, then the user may wish to subscribe to lighting and scent parameters. Conversely, if the user's environment does not include a humidifier, the user may not wish to subscribe to humidifier parameters. In decision block 1120, if subscription requirements are satisfied, then the method continues at block 1140, otherwise the method continues at block 1130. For example, if the subscription requires payment or age verification and these requirements are not satisfied, the subscription request may be rejected. Similarly, if the subscription request does not include a request for any parameters that the social media provider does not provide, then the subscription request may be rejected. In some cases, a subscription may not include any subscription requirements. In block 1130, the method sends an error message to the user indicating why the subscription request was rejected. In block 1140, the method stores subscription information included with the request in association with the user. The subscription information may include moodscape parameters to which the user is subscribed, acceptable content ratings for receiving content (e.g., G, PG, PG-13, R, E, E10+, T, M, etc.), contextual restrictions, and so on. Furthermore, the subscription information may include subscription information for different environments for a user. For example, a user may provide subscription information for their bedroom, their work environment, their car, and so on. In this manner, the system can filter experience and environment information from a provider to correspond to the devices associated with each of the user's environments. In this manner, the disclosed technique can reduce the amount of data transmitted to and/or processed by user systems based on the available devices, thereby reducing the load on any intervening networks. In block 1150, the method sends a confirmation message to the user confirming their subscription. One of ordinary skill in the art will recognize that a user can modify or otherwise update or cancel a subscription by sending an updated request to modify or cancel the subscription.

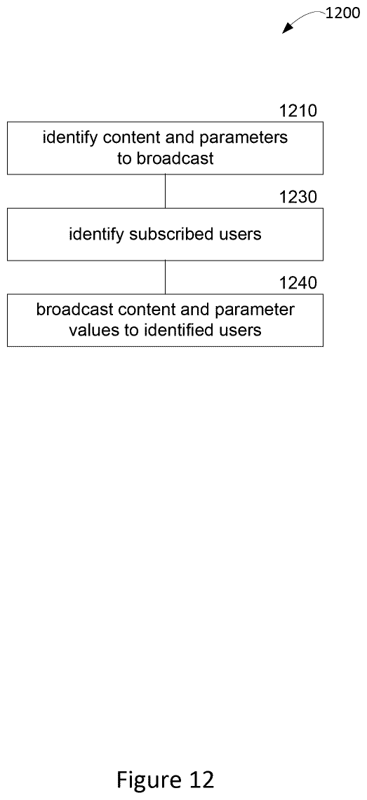

FIG. 12 illustrates an example method 1200 for broadcasting content and parameters from providers to subscribed users and may be performed, for example, by a provider system, a moodscape sharing system, and so on. The method 1200 begins at block 1210, which involves identifying moodscape parameters to broadcast to the subscribed users, such as content that the provider is consuming (e.g., audio the provider is listening to, a game the provider is playing, a video the provider is watching, and so on) along with any available environmental parameters. The method may identify the available environmental parameters based on a manual selection by the provider, a previous selection stored as part of a “selection manifest,” by accessing a device capability manifest that identifies, for each device associated with the system, the moodscape parameters available to be shared with other users, and so on.

In block 1220, the method obtains values for each of the identified parameters by, for example, querying one or more devices or sensors for a corresponding value.

In block 1230, the method identifies users who have subscribed to receive the identified content or one or more of the identified moodscape parameters. For example, if the content rating is inconsistent with a subscription rating (e.g., if a user has opted into receiving only content rated G or PG and the content the provider is consuming is rated PG-13) then the content may not be broadcast to the user. Similarly, if the user subscribed to lighting and AR parameters but the provider is not broadcasting lighting or AR content, then the user may not be identified as a user to broadcast content to. In some cases, a user may wish to receive environmental or experience parameters even if they cannot consume the content the provider is broadcasting to allow the user to feel a sense of a shared experience or environment with the provider.

In block 1240, the method broadcasts the content and parameter values to the identified users. For example, the method may involve broadcasting all of the content and parameter values to each user for filtering on the user side, filtering by a provider system or moodscape sharing system based on user subscription information and sending individual broadcasts to each user, etc. In some cases, each parameter is represented by a unique identifier and a corresponding set of one or more values. In some cases, the content and parameter values are broadcast in real time as the provider is experiencing underlying content. In some cases, the content and parameters can be recorded while the provider is experiencing the content to create a timeline for one or more parameters and the content, which can be provided to subscribers in the future. In this manner, a subscriber who was unable to share the experience with the provider in real-time or wants to share that experience again can recreate the provider's moodscape at a later date. In some cases, the provider may represent a group of people, such as a team, band, cast, group of friends, etc. The disclosed techniques can generate group-based moodscape by, for example, collecting moodscape parameter values from one or more individuals in the group and generating an average or weighted average of the moodscape parameter values (e.g., arithmetic mean, geometric mean, mood, median). The group-based moodscape values can then be provided to subscribers and related systems and playback devices. In some cases, the subscribers may switch between moodscapes generated by any combination of individuals within the group, such as a particular performer or instrument section in an orchestra, a particular player or position group on a sports team, and so on. In some cases, the provider may not be a person but a particular location, such as a tourist attraction, media venue, sports venue, spa, relaxing environment, etc. In some examples, rather than broadcasting underlying content, the method may employ one or more techniques for accessing or mirroring remote queues and managing subscriptions thereto, such as any of the various techniques described in U.S. Pat. No. 10,587,693, issued on Mar. 10, 2020, entitled “Mirrored Queues,” U.S. Pat. No. 9,891,880, issued on Feb. 13, 2018, entitled “Information Display Regarding Playback Queue Subscriptions,” and U.S. Pat. No. 9,537,852, issued on Jan. 3, 2017, entitled “Cloud Queue Access Control,” each of which is herein incorporated by reference in its entirety.

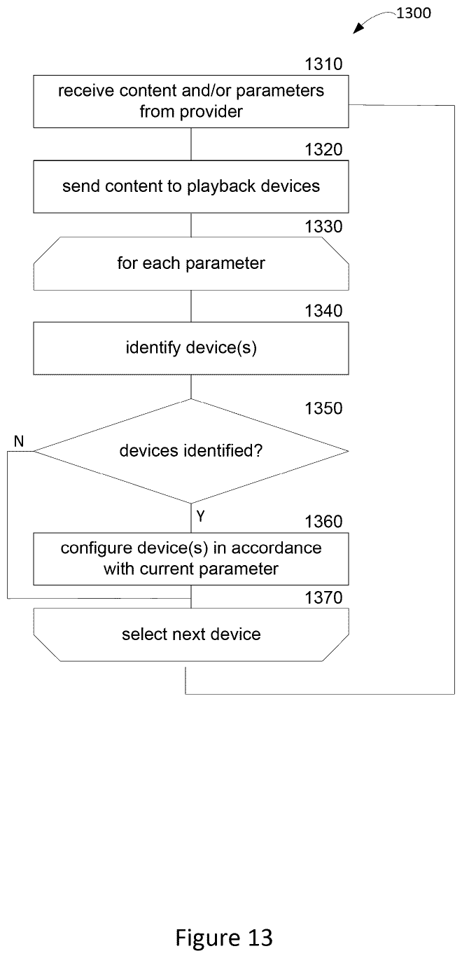

FIG. 13 illustrates an example method 1300 for receiving content and parameters and configuring associated playback devices. The method 1300 begins at block 1310, which involves receiving moodscape parameters from a provider (directly or indirectly), such as media content, experience parameters (e.g., provider mood, emotional state), environmental parameters (e.g., lighting, ambient noise, temperature), and so on. In block 1320, the method sends the content (if any) to one or more playback devices (e.g., video display device, audio playback device, etc.) for playback. In blocks 1330-1370, the method loops through each of the parameters and configures any associated playback devices in accordance with a corresponding parameter value. In block 1340, the method identifies any devices associated with the current parameter. In some cases, a user may associate each of one or more devices with one or more parameters. In some cases, devices may be factory-set to be associated with one or more parameters. In some examples, individual devices can be queried to determine which, if any, parameters that device is (or can be) associated with. In some cases, a user system may maintain a mapping between devices and parameters, which can be used to determine which parameter values should be sent to which devices.

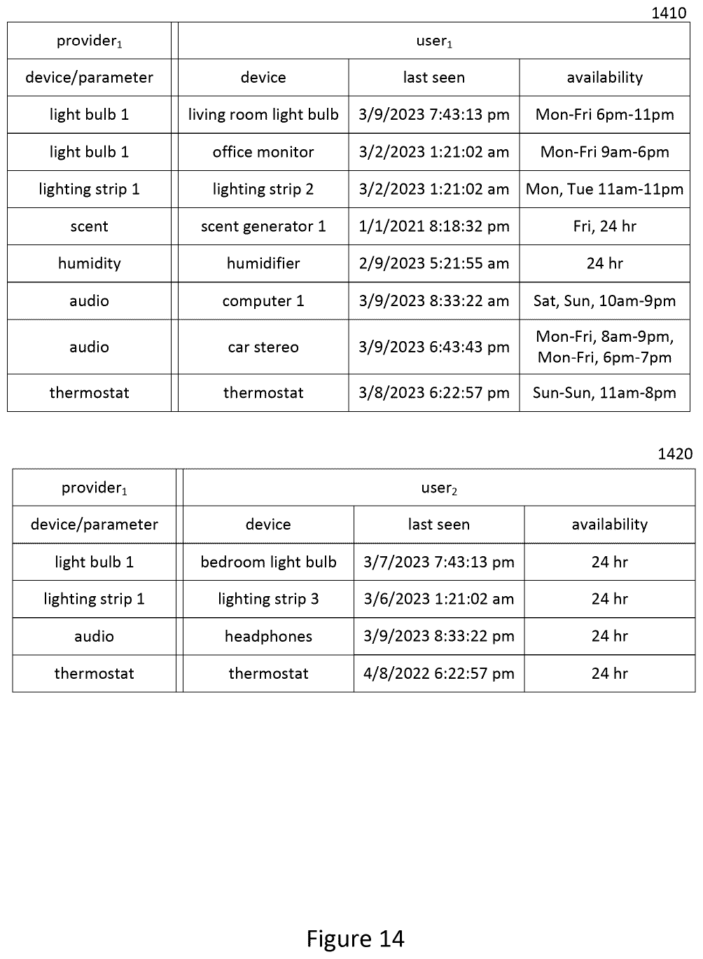

FIG. 14 is a table diagram representing mappings, between provider devices and/or parameters and a user's devices, which can be used, for example, to determine which parameter values should be sent to which user systems, in accordance with some embodiments of the disclosed technology. In this example, table 1410 includes mappings between a provider environment (provider1) and a user environment (user1). As illustrated by table 1410, provider1 is capable of providing parameters from multiple devices that can be received and interpreted or simulated by playback devices of user1, including a light bulb (“light bulb 1”), a lighting strip (“lighting strip 1”), a scent parameter (“scent”), a humidity parameter (“humidity”), audio parameters (including audio data) (“audio”), and a thermostat (“thermostat”). Table 1410 also includes, for each of the provider's available devices/parameters, one or more corresponding playback devices that may be available to user1 and that can be used to simulate the output from the provider's device (or corresponding parameter). For example, the provider's “light bulb 1” can be simulated on the user's end using a device or system labeled “living room light bulb” (e.g., a smart bulb installed in the user's living room) and/or a device or system labeled “office monitor” (e.g., a computer monitor in the user's office). As another example, the provider's “audio” can be simulated on the user's end using a device or system labeled “computer 1” (e.g., the user's desktop or laptop computer) and/or a device or system labeled “car stereo” (e.g., the car the user users to commute to and from work).

As another example, table 1420 includes mappings between provider1 and a second user environment (user2). As illustrated by table 1420, user2 has registered fewer devices capable of simulating devices/parameters from provider1. Accordingly, table 1420 includes fewer mappings between the devices/parameters of provider1 and the playback devices of user2. In this case provider1 is capable of providing parameters from multiple devices that can be received and interpreted or simulated by devices of user2, including “light bulb 1,” “lighting strip 1,” “audio,” and “thermostat.” In this case, because user2 does not have (or has not registered) a playback device capable of simulating humidity, table 1420 does not include a mapping for the “humidity” parameter.

In addition to providing these mappings, tables 1410 and 1420 also include information that can be used to determine when the relevant device or parameter information should be transmitted to a user system. In this example, tables 1410 and 1420 include a “last seen” column and an “availability” column. The “last seen” column identifies, for each playback device, the last time the playback device interacted with the moodscape sharing system (e.g., by interacting with a simulation of a provider's environment, by pinging the system, etc.). In some examples, the system may use these values to “prune” playback devices (e.g., de-register a playback device) after a predetermined period (e.g., one month, six weeks, one year, etc.). After a playback device has been pruned, parameter or device information associated with that playback device can be dropped from transmission to the user system (if no other user playback device uses that information). In this manner, the system can reduce the amount of information that is transmitted to user systems, thereby reducing the amount of network traffic and resources needed to simulate a provider's environment. The “availability” column provides a range of days and times when the corresponding user playback device is available to be used to simulate a provider's environment. For example, user1's “computer 1” is available to simulate provider audio on Saturdays and Sundays from 10 am to 9 pm while user's car stereo is available from Monday through Friday from 8 am to 9 pm and 6 pm to 7 pm. Accordingly, if a user playback device is not available to simulate a particular device or parameter in the provider's environment, that information can be eliminated from transmission to the user's environment, thereby reducing the amount of network traffic and resources needed to simulate a provider's environment. One of ordinary skill in the art will recognize that mappings between provider and user environment may be stored in any number of ways and may include more or less information. Moreover, users and/or providers may periodically register or de-register devices or parameters from a mapping and/or change “availability” values. Additionally, individual playback devices may periodically poll or ping the system to update their “last seen” values. In this manner, the mappings may be updated to represent the current environments and corresponding devices.

In some examples, the method 1300 includes regular queries (e.g., once every 1s, 5s, 10s, 30s, 60s, 120s) of the devices identified in block 1340 for updated status information and/or availability. For instance, in some examples, a device (e.g., illumination device, humidifier, video display device) identified in block 1340 may have been initially available for use in the method 1300, but no longer available due to going offline, being employed by the user or another user for a different purpose, restricted for use during certain hours of the day, etc. Conversely, a device initially determined in block 1340 to be unavailable may later become available during the operation of the method 1300.

Moreover, in some examples, a device may be identified as suitable to be a target device for a provider but still require permission or intervention from the end user. For instance, the device mapping may indicate that a user's outdoor light could be necessary to fully simulate a provider lightscape, but stored instructions indicate that a user's permission is needed to access and employ the outdoor lighting. In another example, the device mapping may indicate a parameter that it is currently raining in the provider's location and, perhaps, the provider herself is being rained on. In this scenario, the user may herself be outside in the vicinity of a home sprinkler system and the method 1300 may further include requesting permission to activate a particular zone of the home sprinkler system adjacent to the user to simulate the rainy conditions on the provider side.

In decision block 1350, if any devices were identified, then the method continues at block 1360, otherwise the method continues at block 1370. In block 1360 the method configures each of the identified devices in accordance with the value of the current parameter by, for example, transmitting the parameter value to the device or a request to set the parameter to the corresponding value. In some cases, if the parameter cannot be set automatically, the method may prompt the user to set the parameter manually. In some examples, a user device may be used to simulate a provider parameter that is different from its intended purpose. For instance, the device mapping may indicate a lighting scene with a particular color and brightness that cannot be simulated by a light bulb or other lighting element in the user's environment. The method 1300 instead can employ a display device adjacent to the user to simulate the provider lighting scene. As one example, the device mapping may indicate that the user environment should be lit with purple light with a brightness of approximately 500 lumens. Based on the availability of a television in the user's vicinity and knowledge of the television's manufacturer, model, and/or output characteristics (along with the ambient light in the room), the method 1300 can include causing a particular output on the television to be displayed (e.g., a purple static image) having a brightness that achieves the corresponding provider mapped parameter. In block 1370, if there are additional parameters to process then the method loops back to block 1330 to select the next parameter, otherwise the method loops back to block 1310 to receive or process a subsequent block of content and parameters.

### Multi-Device Playback of Generative Media Content

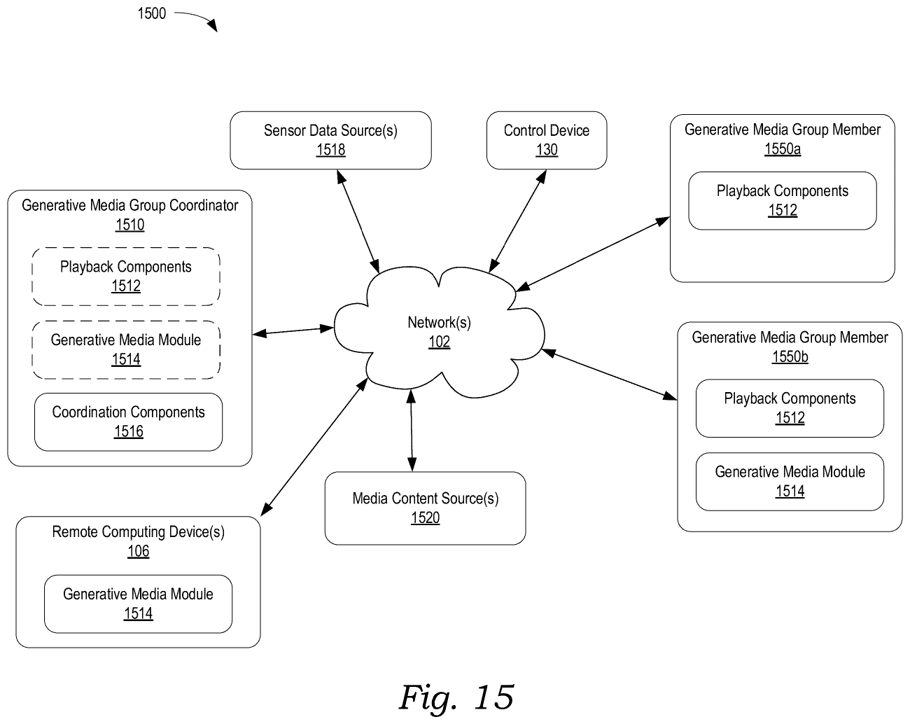

FIG. 15 is a functional block diagram of a system 1500 for playback of generative media content. As noted previously, generative media content can include any media content (e.g., audio, video, audio-visual output, tactile output, or any other media content) that is dynamically created, synthesized, and/or modified by a non-human, rule-based process such as an algorithm or model. This creation or modification can occur for playback in real-time or near real-time. Additionally or alternatively, generative media content can be produced or modified asynchronously (e.g., ahead of time before playback is requested), and the particular item of generative media content may then be selected for playback at a later time. As used herein, a “generative media module” includes any system, whether implemented in software, a physical model, or combination thereof, that can produce generative media content based on one or more inputs. In some examples, such generative media content includes novel media content that can be created as wholly new or can be created by mixing, combining, manipulating, or otherwise modifying one or more pre-existing pieces of media content. As used herein, a “generative media content model” includes any algorithm, schema, or set of rules that can be used to produce novel generative media content using one or more inputs (e.g., sensor data, artist-provided parameters, media segments such as audio clips or samples, etc.). Among examples, a generative media module can use a variety of different generative media content models to produce different generative media content. In some instances, artists or other collaborators can interact with, author, and/or update generative media content models to produce particular generative media content. Although several examples throughout this discussion refer to audio content, the principles disclosed herein can be applied in some examples to other types of media content, e.g., video, audio-visual, tactile, or otherwise.

As shown in FIG. 15, the system 1500 includes a generative media group coordinator 1510, which is in communication with generative media group members 1550a and 1550b, as well as with sensor data source(s) 1518, media content source(s) 1520, and a control device 130. Such communication can be carried out via network(s) 102, which as noted above can include any suitable wired or wireless network connections or combinations thereof (e.g., WiFi network, a Bluetooth, a Z-Wave network, a ZigBee, an Ethernet connection, a Universal Serial Bus (USB) connection, etc.).

One or more remote computing device(s) 106 can also be in communication with the group coordinator 1510 and/or group members 1550a and 1550b via the network(s) 102. In various examples, the remote computing device(s) 106 can be cloud-based servers associated with a device manufacturer, media content provider, voice-assistant service, or other suitable entity. As shown in FIG. 15, the remote computing device(s) 106 can include a generative media module 1514. As described in more detail elsewhere herein, the remote computing device(s) 106 can produce generative media content remotely from the local devices (e.g., coordinator 1510 and members 1550a and 1550b). The generative media content can then be transmitted to one or more of the local devices for playback. Additionally or alternatively, the generative media content can be produced wholly or in part via the local devices (e.g., group coordinator 1510 and/or group members 1550a and 1550b). In some examples, the group coordinator 1510 can itself be a remote computing device such that it is communicatively coupled to the group members 1550a and 1550b via a wide area network and the devices need not be co-located within the same environment (e.g., household, business location, etc.).

a. Example Generative Media Group Operation

In the illustrated example, a generative media group includes a generative media group coordinator 1510 (also referred to herein as a “coordinator device 1510”) and first and second generative media group members 1550a and 1550b (also referred to herein as “first member device 1550a,” “second member device 1550b,” and, collectively, “member devices 1550”). Optionally, one or more remote computing devices 106 can also form part of the generative media group. In operation, these devices can communicate with one another and/or with other components (e.g., sensor data source(s) 1518, control device 130, media content source(s) 1520, or any other suitable data sources or components) to facilitate the production and playback of generative media content.

In various examples, some or all of the devices 1510 and/or 1550 can be co-located within the same environment (e.g., within the same household, store, etc.). In some examples, at least some of the devices 1510 and/or 1550 can be remote from one another, for example within different households, different cities, etc.

The coordinator device 1510 and/or the member devices 1550 can include some or all of the components of the playback device 110 or network microphone device 120 described above with respect to FIGS. 1A-1H. For example, the coordinator device 1510 and/or member devices 1550 can optionally include playback components 1512 (e.g., transducers, amplifiers, audio processing components, etc.), or such components can be omitted in some instances.

In some examples, the coordinator device 1510 is a playback device itself, and as such may also operate as a member device 1550. In other examples, the coordinator device 1510 can be connected to one or more member devices 1550 (e.g., via direct wired connection or via network 102) but the coordinator device 1510 does not itself play back generative media content. In various examples, the coordinator device 1510 can be implemented on a bridge-like device on a local network, on a playback device that is not itself part of the generative media group (i.e., the playback device does not itself play back the generative media content), and/or on a remote computing device (e.g., a cloud server).

In various examples, one or more of the devices can include a generative media module 1514 thereon. Such generative media module(s) 1514 can produce novel, synthetic media content based on one or more inputs, for example using a suitable generative media content model. As shown in FIG. 15, in some examples the coordinator device 1510 can include a generative media module 1514 for producing generative media content, which can then be transmitted to the member devices 1550a and 1550b for concurrent and/or synchronous playback. Additionally or alternatively, some or all of the member devices 1550 (e.g., member device 1550b as shown in FIG. 15) can include a generative media module 1514, which can be used by the member device 1550 to locally produce generative media content based on one or more inputs. In various examples, the generative media content can be produced via the remote computing device(s) 106, optionally using one or more input parameters received from local devices. This generative media content can then be transmitted to one or more of the local devices for coordination and/or playback.

In some examples, at least some of the member devices 1550 do not include a generative media module 1514 thereon. Alternatively, in some instances each member device 1550 can include a generative media module 1514 thereon, and can be configured to produce generative media content locally. In at least some examples, none of the member devices 1550 include a generative media module 1514 thereon. In such cases, generative media content can be produced by the coordinator device 1510. Such generative media content can then be transmitted to the member devices 1550 for concurrent and/or synchronous playback.

In the example shown in FIG. 15, the coordinator device 1510 additionally includes coordination components 1516. As described in more detail herein, in some instances the coordinator device 1510 can facilitate playback of generative media content via multiple different playback devices (which may or may not include the coordinator device 1510 itself). In operation, the coordination components 1516 are configured to facilitate synchronization of both generative media creation (e.g., using one or more generative media modules 1514, which may be distributed among the various devices) as well as generative media playback. For example, the coordinator device 1510 can transmit timing data to the member devices 1550 to facilitate synchronous playback. Additionally or alternatively, the coordinator device 1510 can transmit inputs, generative media model parameters, or other data relating to the generative media module 1514 to one or more member devices 1550 such that the member devices 1550 can produce generative media locally (e.g., using a locally stored generative media module 1514), and/or such that the member devices 1550 can update or modify the generative media modules 1514 based on the inputs received from the coordinator device 1510.

As described in more detail elsewhere herein, the generative media module(s) 1514 can be configured to produce generative media based on one or more inputs using a generative media content model. The inputs can include sensor data (e.g., as provided by sensor data source(s) 1518)), user input (e.g., as received from control device 130 or via direct user interaction with the coordinator device 1510 or member devices 1550), and/or media content source(s) 1520. For example, a generative media module 1514 can produce and continuously modify generative audio by adjusting various characteristics of the generative audio based on one or more input parameters (e.g., sensor data relating to one or more users relative to the devices 1510, 1550).

b. Example Media Content Source(s)

The media content source(s) 1520 can include, in various examples, one or more local and/or remote media content sources. For example, the media content source(s) 1520 can include one or more local audio sources 105 as described above (e.g., audio received over an input/output connection such as from a mobile device (e.g., a smartphone, a tablet, a laptop computer) or another suitable audio component (e.g., a television, a desktop computer, an amplifier, a phonograph, a Blu-ray player, a memory storing digital media files)). Additionally or alternatively, the media content source(s) 1520 can include one or more remote computing devices accessible via a network interface (e.g., via communication over the network(s) 102). Such remote computing devices can include individual computers or servers, such as, for example, a media streaming service server storing audio and/or other media content, etc.

In various examples, the media available via the media content source(s) 1520 can include pre-recorded audio segments in the form of complete sounds, songs, portions of songs (e.g., samples), or any audio component (e.g., pre-recorded audio of a particular instrument, synthetic beats or other audio segments, non-musical audio such as spoken word or nature sounds, etc.). In operation, such media can be utilized by the generative media modules 1514 to produce generative media content, for example by combining, mixing, overlapping, manipulating, or otherwise modifying the retrieved media content to produce novel generative media content for playback via one or more devices. In some examples, the generative media content can take the form of a combination of pre-recorded audio segments (e.g., a pre-recorded song, spoken word recording, etc.) with novel, synthesized audio being created and overlaid with the pre-recorded audio. As used herein, “generative media content” or “generated media content” can include any such combination.

c. Example Generative Media Modules

As noted above, the generative media module 1514 can include any system, whether instantiated in software, a physical model, or combination thereof, that can produce generative media content based on one or more inputs. In various examples, the generative media module 1514 can utilize a generative media content model, which can include one or more algorithms or mathematical models that determine the manner in which media content is generated based on the relevant input parameters. In some instances, the algorithms and/or mathematical models can themselves be updated over time, for example based on instructions received from one or more remote computing devices (e.g., cloud servers associated with a music service or other entity), or based on inputs received from other group member devices within the same or a different environment, or any other suitable input. In some examples, various devices within the group can have different generative media modules 1514 thereon—for example with a first member device having a different generative media module 1514 than a second member device. In other cases, each device within the group that has a generative media module 1514 can include substantially the same model or algorithm.

Any suitable algorithm or combination of algorithms can be used to produce generative media content. Examples of such algorithms include those using machine learning techniques (e.g., generative adversarial networks, neural networks, etc.), formal grammars, Markov models, finite-state automata, and/or any algorithms implemented within currently available offerings such as JukeBox by OpenAI, AWS DeepComposer by Amazon, Magenta by Google, AmperAI by Amper Music, etc. In various examples, the generative media module(s) 1514 can utilize any suitable generative algorithms now existing or developed in the future.

In line with the discussion above, producing the generative media content (e.g., audio content) can involve changing various characteristics of the media content in real time and/or algorithmically generating novel media content in real-time or near real-time. In the context of audio content, this can be achieved by storing a number of audio samples in a database (e.g., within media content source(s) 1520) that can be remotely located and accessible by the coordinator device 1510 and/or the member devices 1550 over the network(s) 102, or alternatively the audio samples can be locally maintained on the devices 1510, 1550 themselves. The audio samples can be associated with one or more metadata tags corresponding to one or more audio characteristics of the samples. For instance, a given sample can be associated with metadata tags indicating that the sample contains audio of a particular frequency or frequency range (e.g., bass/midrange/treble) or a particular instrument, genre, tempo, key, release date, geographical region, timbre, reverb, distortion, sonic texture, or any other audio characteristics that will be apparent.

In operation, the generative media modules 1514 (e.g., of the coordinator device 1510 and/or the second member device 1550b) can retrieve certain audio samples based on their associated tags and mix the audio samples together to create the generative audio. The generative audio can evolve in real time as the generative media module(s) 1514 retrieve audio samples with different tags and/or different audio samples with the same or similar tags. The audio samples that the generative media module(s) 1514 retrieve can depend on one or more inputs, such as sensor data, time of day, geographic location, weather, or various user inputs, such as mood selection or physiological inputs such as heart rate or the like. In this manner, as the inputs change, so too does the generative audio. For example, if a user selects a calming or relaxation mood input, then the generative media module(s) 1514 can retrieve and mix audio samples with tags corresponding to audio content that the user may find calming or relaxing. Examples of such audio samples might include audio samples tagged as low tempo or low harmonic complexity or audio samples that have been predetermined to be calming or relaxing and have been tagged as such. In some examples, the audio samples can be identified as calming or relaxing based on an automated process that analyzes the temporal and spectral content of the signals. Other examples are possible as well. In any of the examples herein, the generative media module(s) 1514 can adjust the characteristics of the generative audio by retrieving and mixing audio samples associated with different metadata tags or other suitable identifiers.

Modifying characteristics of the generative audio can include manipulating one or more of: volume, balance, removing certain instruments or tones, altering a tempo, gain, reverb, spectral equalization, timbre, or sonic texture of the audio, etc. In some examples, the generative audio can be played back differently at different devices, for example emphasizing certain characteristics of the generative audio at the particular playback device that is nearest to the user. For instance, the nearest playback device can emphasize certain instruments, beats, tones, or other characteristics while the remaining playback devices can act as background audio sources.

As described elsewhere herein, the media content module(s) 1514 can be configured to produce media intended to direct a user's mood and/or physiological state in a desired direction. In some examples the user's current state (e.g., mood, emotional state, activity level, etc.) is constantly and/or iteratively monitored or measured (e.g., at predetermined intervals) to ensure the user's current state is transitioning toward the desired state or at least not in a direction opposite the desired state. In such examples, the generative audio content can be varied to steer the user's current state towards the desired end state.

In any of the examples herein, the generative media module(s) can use hysteresis to avoid making rapid adjustments to the generative audio that could negatively impact the listening experience. For example, if the generative media module modifies the media based on an input of a user location relative to a playback device, when a user rapidly moves nearer to and farther from a playback device, the playback device could rapidly alter the generative audio in any of the manners described herein. Such rapid adjustments may be unpleasant to the user. In order to reduce these rapid adjustments, the generative media module 1514 can be configured to employ hysteresis by delaying the adjustments to the generative audio for a predetermined period of time when the user's movement or other activity triggers an adjustment. For instance, if the playback device detects that the user has moved within the threshold distance of the playback device, then instead of immediately performing one of the adjustments described above, the playback device can wait a predetermined amount of time (e.g., a few seconds) before making the adjustment. If the user remains within the threshold distance after the predetermined amount of time, then the playback device can proceed to adjust the generative audio. If, however, the user does not remain within the threshold distance after the predetermined amount of time, then the generative media module(s) 1514 can refrain from adjusting the generative audio. The generative media module(s) 1514 can similarly apply hysteresis to the other generative media adjustments described herein.

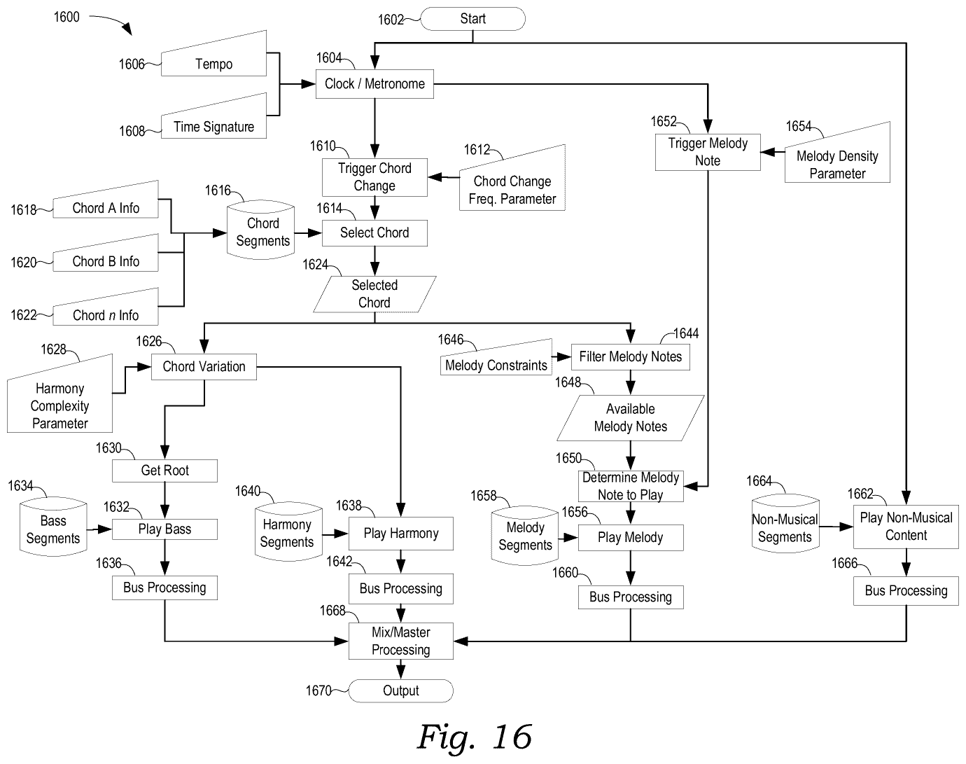

FIG. 16 illustrates a flow chart of a process 1600 for producing generative audio content using a variety of input parameters. In various examples, one or more of these input parameters can be modified based on user input. For example, an artist may select the various parameters, constraints, or available audio segments shown in FIG. 15, and these selections may in turn determine, at least in part, the final output of generative audio content. As noted previously, such a generative media module may be stored and operated on one or more playback devices for local playback (e.g., via the same playback device and/or via other playback devices communicatively coupled over a local area network). Additionally or alternatively, such a generative media module may be stored and operated on one or more remote computing devices, with the resulting output transmitted over a wide area network to one or more remote devices for playback.

As illustrated, the process begins in block 1602 and proceeds to the clock/metronome in block 1604, at which the tempo 1606 and time signature 1608 inputs are received. The tempo 1606 and time signature 1608 can be selected by an artist or may be automatically determined or generated using a model. The process continues to block 1610 at which a chord change can be triggered, and which receives a chord change frequency parameter 1612 as an input. An artist may choose to have a higher chord change frequency in music intended for a higher energy experience (e.g., dance music, uplifting ambient music, etc.). Conversely, a lower chord change frequency may be associated with lower energy output (e.g., calming music).

At block 1614, a chord is selected from the available chord segments 1616. A plurality of chord information parameters 1618, 1620, 1622 can also be provided as input to the chord segments 1616. These inputs can be used to determine the particular chord to be played next and output as block 1624. In some examples, the artist can provide information for each chord such as weightings, how often that particular chord should be used, etc.

Next, in block 1626, a chord variation is selected, based at least in part on the harmony complexity parameter which serves as an input. The harmony complexity parameter 1628 can be tuned or selected by an artist or may be determined automatically. In general, a higher harmony complexity parameter may be associated with higher energy audio output, and a lower harmony complexity parameter may be associated with lower energy audio output. In some cases, harmony complexity parameters can include inputs such as chord inversions, voicings, and harmony density.

In block 1630, the process gets the root of the chord, and in block 1632 selects the bass segment to play from among the available bass segments 1634. These bass segments are then subject to bus processing 1636, at which equalization, filtering, timing, and other processing can be performed.

Returning to the chord variation in block 1626, the process separately continues to block 1638 to play the harmony selected from among the available harmony segments 1640. This harmony segment is then subject to bus processing 1642. As with the bass bus processing, the harmony segment bus processing 1642 can involve equalization, filtering, timing, and other processing can be performed.

Returning to the selected chord 1624, the process separately continues to filter melody notes in block 1644, which utilizes an input of melody constraints 1646. The output in block 1648 is the available melody notes to play. The melody constraints 1646 can be provided by the artist, and may, for example, specify which notes to play or not to play, restrict the melody range, or provide other such constraints, which may depend on the particular selected chord 1624.

In block 1650, the process determines which melody note (from among the available melody notes 1648) to play. This determination can be made automatically based on model values, artist-provided inputs, a randomization effect, or any other suitable input. In the illustrated example, one input is from the trigger melody note block 1652, which in turn is based on the melody density parameter 1654. The artist can provide the melody density parameter 1654, which determines in part how complex and/or high-energy the audio output is. Based on that parameter, a melody note may be triggered more or less frequently and at particular times, using block 1652 which is input to block 1650 to determine which melody note to play. In various examples, the output of block 1650 can be provided as an input to block 1650 in the form of a feedback loop, such that the next melody note selected in block 1650 depends at least in part on the last selected melody note in block 1650. The melody segment is then selected in block 1656 from among the available melody segments 1658, and is then subject to bus processing 1660.

Returning to the start in block 1602, the process separately proceeds to block 1662 to play non-musical content. This may be, for example, nature sounds, spoken-word audio, or other such non-musical content. Various non-musical segments 1664 can be stored and available to be played. These non-musical content segments can also be subject to bus processing in block 1666.

The outputs of these various paths (e.g., the selected bass segment(s), harmony segment(s), melody segment(s), and/or non-musical segment(s)) can each be subject to separate bus processing before being combined at block 1668 via mixing and mastering processing. Here the combined levels can be set, various filters can be applied, relative timing can be established, and any other suitable processing steps performed before the generative audio content is output in block 1670. In various examples, some of the paths may be omitted altogether. For example, the generative media module may omit the option of playing back non-musical content alongside the generative musical content. The process 1600 shown in FIG. 16 is exemplary only, and one of skill in the art will appreciate that suitable modifications can be made the process 1600 shown here, and additionally there are numerous suitable alternative processes that can be used for producing generative media content.

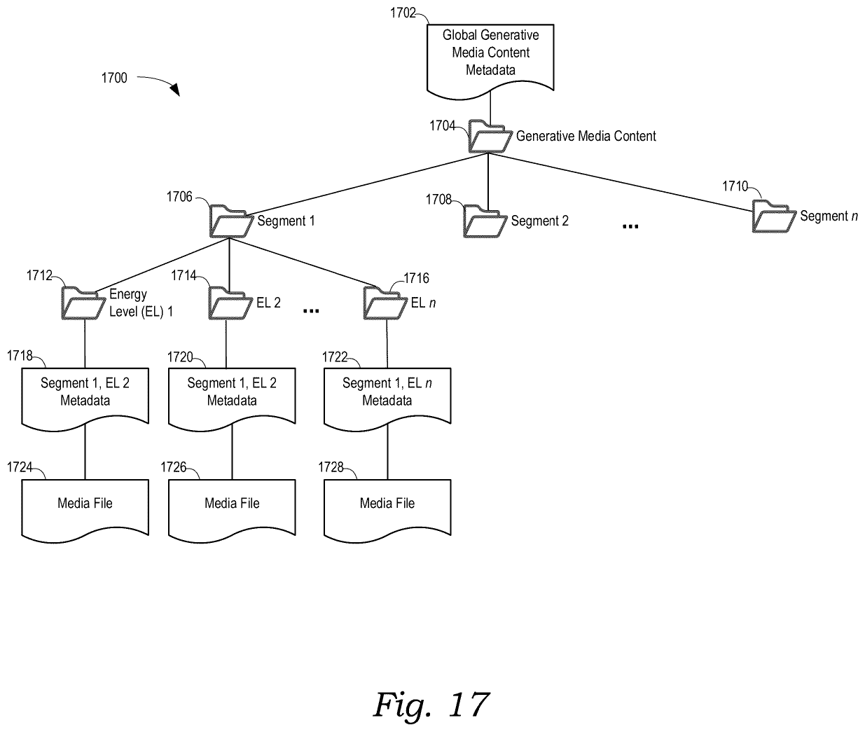

FIG. 17 is an example architecture for storing and retrieving generative media content. In this example, the generative media content includes a variety of discrete tracks (each having multiple variations associated with energy level or another parameter), which can be selected and played back in various orders and groupings depending on the particular input parameters.

As illustrated, the generative media content 1704 can be stored as one or more audio files that are associated with global generative media content metadata 1702. Such metadata can include, for example, the global tempo (e.g., beats per minute), global trigger frequency (e.g., how often to check for a change in input parameter(s)), and/or global crossfade duration (e.g., time to fade between the different selected energies).

Among the generative media content 1704 are a plurality of different tracks 1706, 1708, and 1710. In operation, these tracks can be selected and played back in various arrangements (e.g., randomized grouping with some overlay, or played back according to a predetermined sequence, etc.). In some examples, the generative media content 1704 including the tracks 1706, 1708, 1710 can be stored locally via one or more playback devices, while one or more remote computing devices can periodically transmit updated versions of the tracks, generative media content, and/or global generative media content metadata. In some examples, the remote computing devices can be polled or queried periodically by the playback device(s), and in response to the queries or polls, the remote computing devices can supply updates to the generative media module stored on the local playback device(s).

For each track, there may be corresponding subsets of that track corresponding to different energy levels. For example, a first energy level (EL) of track 1 at 1712, a second energy level of track 1 at 1714, and an n energy level of track 1 at 1716. Each of these can include both metadata (e.g., metadata 1718, 1720, 1722) and particular media files (e.g., media files 17217, 1726, 1728) corresponding to the particular energy level. In some examples, each track may include a plurality of media files (e.g., media file 1724) arranged in a particular manner, the arrangement and combination of which may be desired by the corresponding metadata (e.g., metadata 1718). The media file can be, for example, in any suitable format that can be played back via the playback device and/or streamed to a playback device for playback. In some examples, one or more of the media files 1724, 1726, 1728 can be outputs of the generative model depicted in FIG. 16. The metadata can include, for example, tempo (if different from global tempo), trigger frequency (if different from global trigger frequency), sequence information (e.g., whether to play particular files in order, randomly, or by percent weighting), crossfade duration (if different from global crossfade), spatial information (e.g., for rending audio content in space using multiple transducers), polyphony information (e.g., allowing multiple audio files to play at once in this segment), and/or level (e.g., level adjustment in dB, or random within a predefined range).

In operation, one or more input parameters (e.g., number of people present in a room, time of day, etc.) can be used to determine a target energy level. This determination can be made using a playback device and/or one or more remote computing devices. Based on this determination, particular media files can be selected that correspond to the determined energy level. The generative media module can then arrange and play back those selected tracks according to the generative content model. This can involve playing the selected tracks back in a particular pre-defined order, playing them back in a random or pseudo-random order, or any other suitable approach. The tracks can be played back in a manner that is at least partially overlapping in some examples. It can be useful to vary the amount of overlap between tracks such that casual listeners do not hear a repeating loop of audio content, but instead perceive the generative audio as an endless stream of audio without repetition.

Although the example shown in FIG. 17 utilizes energy level as a parameter to distinguish different generative audio content, in various examples the particular variations or permutations of generative audio content can vary along other dimensions (e.g., genre, time of day, associated user task, etc.).

d. Example Sensor Data Source(s) and Other Input Parameters

As noted previously, the generative media module(s) 1514 can produce generative media based at least in part on input parameters that can include sensor data (e.g., as received from sensor data source(s) 1518) and/or other suitable input parameters. With respect to sensor input parameters, the sensor data source(s) 1518 can include data from any suitable sensor, wherever located with respect to the generative media group and whatever values are measured thereby. Examples of suitable sensor data includes physiological sensor data such as data obtained from biometric sensors, wearable sensors, etc. Such data can include physiological parameters like heart rate, breathing rate, blood pressure, brainwaves, activity levels, movement, body temperature, etc.

Suitable sensors include wearable sensors configured to worn or carried by a user, such as a headset, watch, mobile device, brain-machine interface (e.g., Neuralink), headphone, microphone, or other similar device. In some examples, the sensor can be a non-wearable sensor or fixed to a stationary structure. The sensor can provide the sensor data, which can include data corresponding to, for example, brain activity, voice, location, movement, heart rate, pulse, body temperature, and/or perspiration. In some examples, the sensor can correspond to a plurality of sensors. For example, as explained elsewhere herein, the sensor may correspond to a first sensor worn by a first user, a second sensor worn by a second user, and a third sensor not worn by a user (e.g., fixed to a stationary or structure). In such examples, the sensor data can correspond to a plurality of signals received from each of the first, second, and third sensors.

The sensor can be configured to obtain or generate information generally corresponding to a user's mood or emotional state. In one example, the sensor is a wearable brain sensing headband, which is one of many examples of the sensor described herein. Such a headband can include, for example, an electroencephalography (EEG) headband having a plurality of sensors thereon. In some examples, the headband can correspond to any of the Muse™ headbands (InteraXon; Toronto, Canada). The sensors can be positioned at varying locations around an inner surface of the headband, e.g., to correspond to different brain anatomy (e.g., the frontal, parietal, temporal, and sphenoid bones) of the user. As such. each of the sensors can receive different data from the user. Each of the sensors can correspond to individual channels that can be streamed from the headband to the system devices 1510 and/or 1550. Such sensor data can be used to detect a user's mood, for example by classifying the frequencies and intensities of various brainwaves or by performing other analyses. Additional details of using a brain-sensing headband for generative audio content can be found in commonly owned U.S. Application No. 62/706,544, filed Aug. 24, 2020, titled MOOD DETECTION AND/OR INFLUENCE VIA AUDIO PLAYBACK DEVICES, which is hereby incorporated by reference in its entirety.

In some examples, the sensor data source(s) 1518 include data obtained from networked device sensor data (e.g., Internet-of-Things (IoT) sensors such as networked lights, cameras, temperature sensors, thermostats, presence detectors, microphones, etc.). Additionally or alternatively, the sensor data source(s) 1518 can include environmental sensors (e.g., measuring or indicating weather, temperature, time/day/week/month, etc.).

In some examples, the generative media module 1514 can utilize input in the form of playback device capabilities (e.g., number and type of transducers, output power, other system architecture), device location (e.g., either location relative to other playback devices, relative to one or more users). Additional examples of creating and modifying generative audio as a result of user and device location are described in more detail in commonly owned U.S. Application No. 62/956,771, filed Jan. 3, 2020, titled GENERATIVE MUSIC BASED ON USER LOCATION, which is hereby incorporated by reference in its entirety. Additional inputs can include a device state of one or more devices within the group, such as a thermal state (e.g., if a particular device is in danger of overheating, the generative content can be modified to reduce temperature), battery level (e.g., bass output can be reduced in a portable playback device with low battery levels), and bonding state (e.g., whether a particular playback device is configured as part of a stereo pair, bonded with a sub, or as part of a home theatre arrangement, etc.). Any other suitable device characteristic or state may similarly be used as an input for production of generative media content.

Another example input parameter includes user presence—for example when a new user enters a space playing back generative audio, the user's presence can be detected (e.g., via proximity sensors, a beacon, etc.) and the generative audio can be modified as a response. This modification can be based on number of users (e.g., with ambient, meditative audio for 1 user, relaxing music for 2-4 users, and party or dance music for greater than 4 users present). The modification can also be based on the identity of the user(s) present (e.g., a user profile based on the user's characteristics, listening history, or other such indicia).

In one example, a user can wear a biometric device that can measure various biometric parameters, such as heart rate or blood pressure, of the user and report those parameters to the devices 1510 and/or 1550. The generative media modules 1514 of these devices 1510 and/or 1550 can use these parameters to further adapt the generative audio, such as by increasing the tempo of the music in response to detecting a high heart rate (as this may indicate that the user is engaging in a high motion activity) or decreasing the tempo of the music in response to detecting a high blood pressure (as this may indicate that the user is stressed and could benefit from calming music).

In yet another example, one or more microphones of a playback device (e.g., microphones 115 of FIG. 1F) can detect a user's voice. The captured voice data can then be processed to determine, for example, a user's mood, age, or gender, to identify a particular user from among several users within a household, or any other such input parameter. Other examples are possible as well.

e. Example Coordination Among Group Members

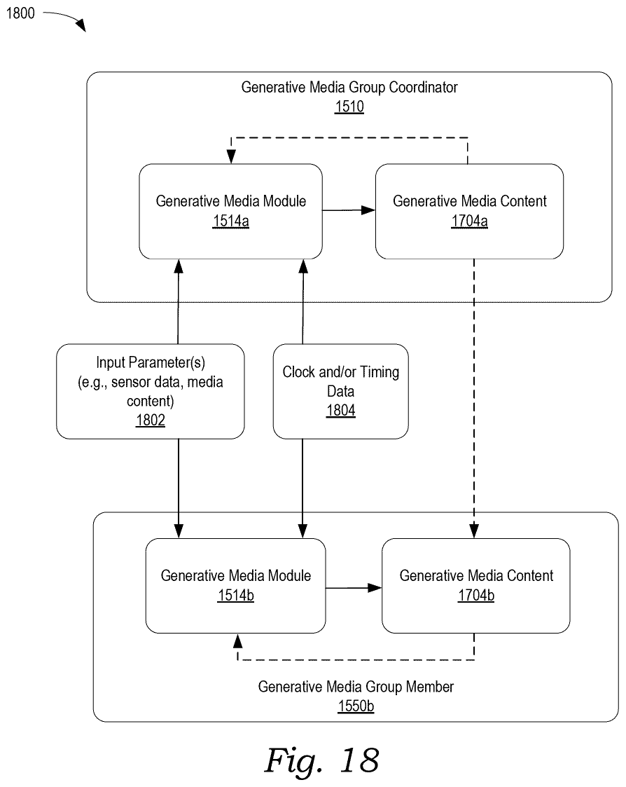

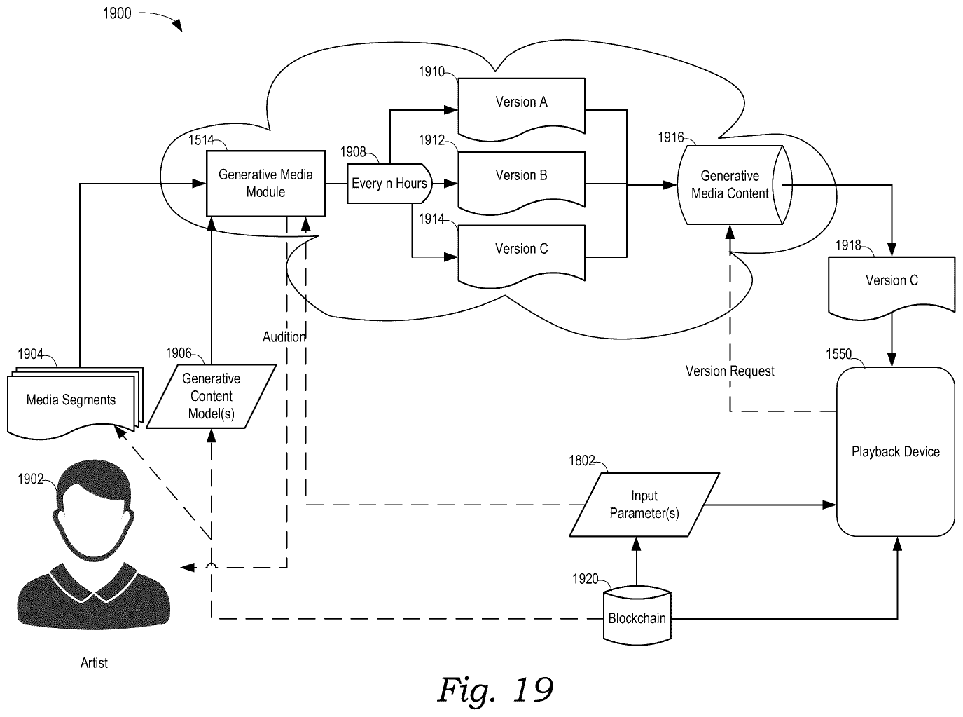

FIG. 18 is a functional block diagram illustrating data exchange in a system for playback of generative media content. For purposes of explanation, the system 1800 shown in FIG. 18 includes interactions between a coordinator device 1510 and a member device 1550b. However, the interactions and processes described herein can be applied to interactions involving a plurality of additional coordinator devices 1510 and/or member devices 1550. As shown in FIG. 18, the coordinator device 1510 includes a generative media module 1514a that receives inputs including input parameters 1802 (e.g., sensor data, media content, model parameters for the generative media module 1514a, or other such input) as well as clock and/or timing data 1804. In various examples, the clock and/or timing data 1804 can include synchronization signals to synchronize playback and/or to synchronize generative media being produced by various devices within the group. In some examples, the clock and/or timing data 1804 can be provided by an internal clock, processor, or other such component housed within the coordinator device 1510 itself. In some examples, the clock and/or timing data 1804 can be received via a network interface from remote computing devices.

Based on these inputs, the generative media module 1514a can output generative media content 1704a. Optionally, the output generative media content 1704a can itself serve as an input to the generative media module 1514a in the form of a feedback loop. For example, the generative media module 1514a can produce subsequent content (e.g., audio frames) using a model or algorithm that depends at least in part on the previously generated content.

In the illustrated example, the member device 1550b likewise includes a generative media module 1514b, which can be substantially the same as the generative media module 1514a of the coordinator device 1510, or may differ in one or more aspects. The generative media module 1514b can likewise receive input parameter(s) 1802 and clock and/or timing data 1804. These inputs can be received from the coordinator device 1510, from other member devices, from other devices on a local network (e.g., a locally networked smart thermostat supplying temperature data), and/or from one or more remote computing devices (e.g., a cloud server providing clock and/or timing data 1804, or weather data, or any other such input). Based on these inputs, the generative media module 1514b can output generative media content 1704b. This produced generative media content 1704b can optionally be fed back into the generative media module 1514b as part of a feedback loop. In some examples, the generative media content 1704b can include or consist of generative media content 1704a (produced via the coordinator device 1510) which has been transmitted over a network to the member device 1550b. In other cases, the generative media content 1704b can be produced independently and separately of the generative media content 1704a produced via the coordinator device 1510.

The generative media content 1704a and 1704b can then be played back, either via the devices 1510 and 1550b themselves, and/or as played back by other devices within the group. In various examples, the generative media content 1704a and 1704b can be configured to be played back concurrently and/or synchronously. In some instances, the generative media content 1704a and 1704b can be substantially identical or similar to one another, with each generative media module 1514 utilizing the same or similar algorithms and the same or similar inputs. In other instances, the generative media content 1704a and 1704b can differ from one another while still being configured for synchronous or concurrent playback.

f. Example Generative Media Using Distributed Architectures

As noted previously, generation of media content can be computationally intensive, and in some cases may be impractical to perform wholly on local playback devices alone. In some examples, a generative media module of a local playback device can request generative media content from a generative media module stored on one or more remote computing devices (e.g., cloud servers). The request can include or be based on particular input parameters (e.g., sensor data, user inputs, contextual information, etc.). In response to the request, the remote generative media module can stream particular generative media content to the local device for playback. The particular generative media content provided to the local playback device can vary over time, with the variation depending on the particular input parameters, the configuration of the generative media module, or other such parameter. Additionally or alternatively, the playback device can store discrete tracks for playback (e.g., with different variations of tracks associated with different energy levels, as depicted in FIG. 17). The remote computing device(s) may then periodically provide new files for updated tracks to the local playback device for playback, or alternatively may provide an update to the generative media module that determines when and how to play back the particular files that are stored locally on the playback device.

In this manner, the tasks required to produce and play back generative audio are distributed among one or more remote computing device(s) and one or more local playback devices. By performing at least some of the computationally intensive tasks associated with generating novel media content to the remote computing devices, and optionally by reducing the need for real-time computation, overall efficiency can be improved. By generating, via remote computing devices, a discrete number of alternative tracks or track variation according to a particular media content model ahead of playback, the local playback device may request and receive particular variations based on real-time or near-real-time input parameters (e.g., sensor data). For example, the remote computing devices can generate different versions of the media content, and the playback device can request particular versions in real-time based on input parameters. The result is playback of suitable generative media content based on real-time or near-real-time input parameters (e.g., sensor data) without requiring de novo generation of such media content to be performed in real time.

FIG. 19 is a schematic diagram of an example distributed generative media playback system 1900. As illustrated, an artist 1902 can supply a plurality of media segments 1904 and one or more generative content models 1906 to a generative media module 1514 stored via one or more remote computing devices. The media segments can correspond to, for example, particular audio segments or seeds (e.g., individual notes or chords, short tracks of n bars, non-musical content, etc.). In some examples, the generative content models 1906 can also be supplied by the artist 1902. This can include providing the entire model, or the artist 1902 may provide inputs to the model 1906, for example by varying or tuning certain aspects (e.g., tempo, melody constraints, harmony complexity parameter, chord change density parameter, etc.).

The generative media module 1514 can receive both the media segments 1904 and one or more input parameters 1802 (as described elsewhere herein). Based on these inputs, the generative media module 1514 can output generative media. As shown in FIG. 19, the artist 1902 can optionally audition the generative media module 1514, for example by receiving exemplary outputs based on the inputs provided by the artist 1902 (e.g., the media segments 1904 and/or generative content model(s) 1906). In some cases, the audition can play back to the artist 1902 variations of the generative media content depending on a variety of different input parameters (e.g., with one version corresponding to a high energy level intended to produce an exciting or uplifting effect, another version corresponding to a low energy level intended to produce a calming effect, etc.). Based on the outputs via this audition step, the artist 1902 may dynamically update the media segments 1904 and/or settings of the generative content model(s) 1906 until the desired outputs are achieved.

In the illustrated example, there can be an iteration at block 1908 every n hours (or minutes, days, etc.) at which the generative media module 1514 can produce a plurality of different versions of the generative media content. In the illustrated example, there are three versions: version A in block 1910, version B in block 1912, and version C in block 1914. These outputs are then stored (e.g., via the remote computing device(s)) as generative media content 1916. A particular one of the versions (version C as block 1918 in this example) can be transmitted (e.g., streamed) to the local playback device 1550 for playback. In some examples, the particular versions can correspond to the tracks 1706, 1708, and 1710 shown in FIG. 17.

Although three versions are shown here by way of example, in practice there may be many more versions of generative media content produced via the remote computing devices. The versions can vary along a number of different dimensions, such as being suitable for different energy levels, suitable for different intended tasks or activities (e.g., studying versus dancing), suitable for different time of day, or any other appropriate variations.

In the illustrated example, the playback device 1550 can periodically request a particular version of the generative media content from the remote computing device(s). Such requests can be based on, for example, user inputs (e.g., user selection via a controller device), sensor data (e.g., number of people present in a room, background noise levels, etc.), or other suitable input parameter. As illustrated, the input parameter(s) 1802 can optionally be provided to (or detected by) the playback device 1550. Additionally or alternatively, the input parameter(s) 1802 can be provided to (or detected by) the remote computing device(s) 106. In some examples, the playback device 1550 transmits the input parameters to the remote computing device(s) 106, which in turn provide a suitable version to the playback device 1550, without the playback device 1550 specifically requesting a particular version.

g. Example Methods for Generation of Digital Content Based on Blockchain Data

As noted previously, in some instances, a system for generating and playing back generative media content can interact with blockchain data (or data stored via other distributed ledger technology). For example, as shown in FIG. 19, a blockchain layer 1920 can be utilized to provide data as an input to other components of the generative media playback system 1900, such as the playback device 1550, the input parameters 1802, the media segments 1904, the generative content model(s) 1906, and/or the generative media module 1514. In various instances, the blockchain layer 1920 can store data that can be used as one or more input parameters 1802, data that contains or can be used to obtain or affect particular media segments 1904, data that contains or can be used to obtain or affect particular generative content model(s) 1906, and/or data that contains or can be used to obtain or affect particular generative media modules 1514. Additionally, some or all of these components may communicate with the blockchain layer 1920 to write data to the blockchain, record transactions, or otherwise interact with the blockchain layer 1920. For example, the playback device 1550 may record transactions that reflect the playback of particular tracks on the blockchain layer 1920. Data stored via the blockchain layer 1920 can include particular input parameters 1802, or data stored via the blockchain layer 1920 can be used to generate suitable input parameters 1802. Similarly, particular media segments 1904, generative content models 1906, generative media modules 1514, input parameters 1802, or other suitable data can be written to the blockchain layer 1920 to create an immutable record of such content, transactions, or other data. Additional details regarding utilization of blockchain technology (or other suitable distributed ledger technology) in the creation and playback of generative media content are described in more detail below.

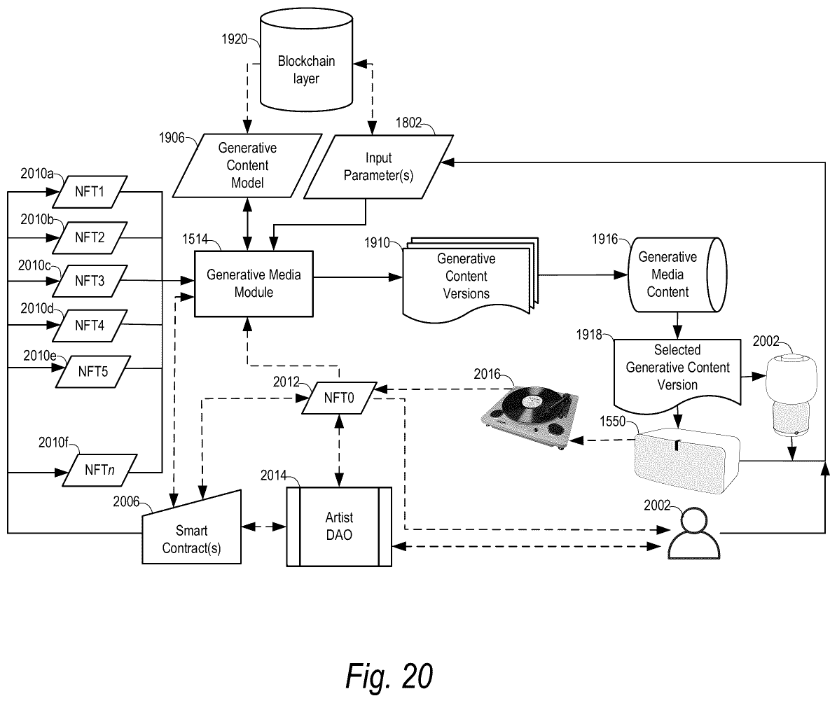

FIG. 20 is a schematic diagram of another example distributed generative media playback system 2000. As shown, the system 2000 includes or communicates with a blockchain layer 1920, for example to obtain, generate, or store input parameters 1802, generative content models 1906, or other data or parameters used in the creation and playback of generative media content.

Examples of such blockchain layers 1920 include public distributed ledgers such as Ethereum, Bitcoin, Solana, Avalanche, Polygon, and many others. Although a blockchain layer 1920 is illustrated, in various examples any suitable distributed ledger technology may be used, including private or semi-private blockchains, as well as non-blockchain implementations such as directed acyclic graphs (DAGs) (e.g., Nano, IOTA, etc.). In various examples, participants using a blockchain layer 1920 can transact with one another in a peer-to-peer manner, and operation of the blockchain layer 1920 can be distributed such that no one central entity controls operation of the network. Such distributed ledgers can be used to track the creation, exchange, and redemption of certain real-world assets, such as currency. This approach enables robust auditing of asset transactions due to the practical immutability of data stored on a blockchain. Currency is only one of various assets that may be desirable to track on a distributed ledger. Other types of assets may differ from currency with respect to one or more behaviors that govern asset creation, exchange, and/or redemption. Moreover, different blockchain architectures may differ with respect to policies and protocols, and further with respect to the tools used to program asset behaviors.

In general, a distributed ledger in which each unit of an asset is represented by some form of digital token can be programmed to endow that token with a set of behaviors appropriate for the asset it represents. By way of example, “fungible” behavior enables an asset to be exchanged with other assets of the same class. Every unit of a given denomination of currency (e.g., a dollar) is fungible, because it has the same value as every other unit of the same denomination. A property title, by contrast, is “non-fungible” because its value depends on the size, location, and other aspects of the specified property. For each asset represented as a token, the appropriate fungible or non-fungible behavior is programmed into that token's class in the virtual ledger that tracks the asset.

According to some embodiments, tokens transacted via the blockchain layer 1920 can be non-fungible. Such non-fungible tokens (NFTs) can be unique and non-interchangeable for any other token. The NFT may comprise and/or be associated with a unique digital artwork and/or music, domain name, a digital collectible (e.g., CryptoKitties, memes), an event ticket, part of a virtual world, a digital object used in games, an avatar or character, an item having utility (e.g., a specific function such as providing voting or governance rights), etc. In various examples, the NFTs may themselves include the relevant data (e.g., the raw audio data for a music NFT may be stored on-chain), or the NFT may include a pointer (e.g., URL or URI) that directs to data stored elsewhere (e.g., audio data stored on a server maintained by the issuer of the music NFT).

Such tokens, whether fungible or non-fungible, may be stored by users via a digital wallet. A digital wallet can be a device, physical medium, program, or service that stores the public and/or private keys for blockchain transactions. In some instances, a digital wallet can store multiple public/private key pairs for various different blockchains, such that a user can store assets associated with different blockchains in a single wallet. Examples include MetaMask, Phantom, Coinbase Wallet, Ledger Nano, etc. In operation, a user can sign blockchain transactions via the wallet using the appropriate private key (or authorizing the wallet to sign the transaction with the private key). The transaction will then be confirmed if the transaction signature is valid, and then added to a corresponding block in the blockchain. In some examples, a wallet identifier may itself be used as an input parameter to a generative model, independent of any tokens held in the particular wallet.

In various implementations, the blockchain layer 1920 can be configured to execute transactions automatically under one or more conditions. Such self-executing transactions can be referred to as “smart contracts.” A smart contract may comprise computer code stored on the blockchain that is configured to execute only in specified circumstances and in specified manners. For example, a smart contract can be configured such that a particular transaction executes when a threshold is exceeded, at a certain time, based on one or more other transactions, or any other suitable criteria. In some examples, a generative media module 1514 and/or a generative content model 1906 can be implemented in the form of a smart contract, such that interacting with the smart contract through the blockchain layer 1920 causes the smart contract to output generative media content, a generative content model, or data or instructions that can be used to produce such a generative media content or a generative content model.

One organizational structure unique to blockchains is a decentralized autonomous organization (DAO). A DAO is typically a community-led entity with no central authority. Such DAOs may be fully autonomous and transparent, with smart contracts providing the foundational rules and executing the agreed-upon decisions. Community votes may be cast via token holders using on-chain transactions. Based on the outcome of particular votes, smart contracts can execute certain transactions or other code to implement the decisions of the DAO members. Typically, DAOs issue tokens to users, either in exchange for currency investment or donations, or without compensation (e.g., via an “air drop”). Token holders typically then retain certain voting rights, which may be proportional to their holdings. In some instances, token holders also receive financial proceeds, such as a share of transaction fees collected by the DAO.

In the example system 2000 shown in FIG. 20, the generative media module 1514 can receive a number of different inputs and output one or more generative content versions 1910 in response. These content versions 1910 are stored in generative media content store 1916, from which a particular selected generative content version 1918 can be chosen for playback via playback device 1550 or other output device (e.g., a light component of the generative media content version 1918 can cause the illumination device 2002 to output light in accordance with the generative media content version 1918, such as having a particular hue, color temperature, brightness, on/off or other pattern, etc.). The inputs to the generative media module 1514 include the generative content model 1906 and input parameter(s) 1802, similar to the approach described previously with respect to FIG. 19. As also noted previously, in some instances the generative content model 1906 can be stored via the blockchain layer 1920 or can be obtained from data stored via the blockchain layer 1920. Similarly, one or more of the input parameter(s) 1802 can include or be based on data stored via the blockchain layer 1920. For example, blockchain data can be used in the generative media module 1514 to produce suitable output, such as the “sonification” of data streams (e.g., a real-time feed of cryptocurrency price values or other data may be turned into a corresponding sound output). In some instances, the blockchain data can include data provided by one or more “oracles,” which are typically third-party services that provide smart contracts with external information (e.g., price feeds, weather data, election results, etc.). In some examples, the generative media module 1906 and/or the generative media content 1916 may be stored locally via the playback device 1550, in which case the input parameters 1802 may be streamed to the playback device 1550 for use in generating new versions 1910 of the generative media content 1916.

Additionally or alternatively, the generative media module 1514 can receive, as an input, the output of one or more smart contracts 2006. In some instances, the generative media module 1514 may itself take the form of a smart contract, such that the program code is stored on the blockchain and runs automatically under certain conditions (e.g., a user 2008 interacts with the smart contract 2006 and in response particular generative media content is transmitted to a specified destination). In some examples, the generative media module 1514 may run locally or via remote servers (rather than as a smart contract on a blockchain), but may communicate with the smart contract 2006 either to receive input parameters 1802 therefrom, or to provide a suitable output to the smart contract 2006. For example, particular generative media content output by the generative media module 1514 can be used to generate one or more NFTs via the smart contract 2006. In some implementations, each particular version of the generative content produced by the generative media module 1514 can have a corresponding NFT, such that each NFT produced by the smart contract 2006 based on input from the generative media module 1514 is unique. This is illustrated graphically in FIG. 20 with a plurality of discrete NFTs 2010a-f labeled NFT1-NFTn that may be produced via smart contract 2006. These NFTs 2010 can additionally be provided as inputs to the generative media module 1514. For example, the generative media module 1514 may produce dynamically distinct content based at least in part on the particular NFTs 2010 with which it interacts. Additionally or alternatively, a user 2008 may only be able to access the particular generative media module 1514 if the user holds the appropriate NFT 2010 in her digital wallet.

In some examples, one or more of the NFTs 2010 are existing NFTs owned by individual third-party persons or entities (e.g., persons or entities not associated with the user 2008) and accessible, perhaps on a temporary basis, by the generative media module 1514. In certain examples, one or more of the NFTs 2010 do not comprise audio data, but instead comprise other data types (e.g., video, image, or other data) that can be “sonified” or otherwise translated by the generative media module 1514 (or another suitable component) into a form that can be used to generate media content.

In the illustrated example, the smart contract 2006 can also output NFT 2012, labeled NFT0, which may be held by the user 2008. Additionally, this NFT 2012 can interact with, or be generated via, the artist DAO 2014, which in turn may communicate with one or more smart contracts 2006. As noted previously, DAOs are typically community-led organizations in which members hold tokens (e.g., NFT 2012) designating membership, providing voting or other governance rights, and optionally entitling the token holders to economic benefits such as proceeds from future DAO revenue. In some examples, the artist DAO 2014 may hold certain music royalties which, when collected, can be distributed in part to holders of the appropriate NFTs or other tokens (e.g., user 2008 may receive economic benefits from the artist DAO 2014 based at least in part on the user's ownership of the NFT 2012).

Optionally, data corresponding to the NFT 2012 can be stored or embedded via physical media. For example, as shown in FIG. 20, data corresponding to the NFT 2012 can be embedded on a vinyl record 2016 (e.g., via a unique QR code, a code embedded in grooves of the vinyl record 2016), or any other suitable technique for storing data via the physical media (e.g., NFC or other RF tag). Although a vinyl record 2016 is illustrated, in various examples the physical substrate can take any number of forms, for example a playback device, a physical card or ticket, a poster, etc.

The inclusion of blockchain layer 1920, smart contract(s) 2006, DAO 2014, and/or NFTs 2010 and 2012 can provide several benefits for the generative media playback system 2000. For example, by associating particular NFTs with generative media content (e.g., soundscapes), the user 2008 can obtain a personalized experience that is also potentially transferrable via the distributed peer-to-peer transaction mechanism of the blockchain layer 1920. One problem with this approach, however, is that the data contained in the NFT is typically static, which is antithetical to the dynamic, contextually aware nature of a generative soundscape or other generative media content. Another problem associated with NFTs is link rot, in which the data in the NFT is rendered obsolete because the locators in the NFT no longer refer to the artwork associated with the NFT. One way to mitigate the possibility of link rot is to store generative media content or a generative media engine in a blockchain layer 1920. Additionally, in some instances the artwork may itself be embedded into the NFT (e.g., the artwork data is stored on-chain rather than on a separate server).

In some instances, the NFTs 2010 can include the particular seeds used by the generative media module 1514. Examples of such seeds include media segments 1904 of FIG. 19, tracks, energy levels, or metadata of FIG. 17, or any of the various components shown in FIG. 16). Optionally, the properties of the particular NFT (at least with respect to its use by the generative media module 1514) may depend on its transaction history. For example, depending on when an NFT was last transacted, or on how many transactions it has been subjected to, the particular seed associated with that NFT may vary dynamically. Additionally or alternatively, different combinations of NFTs 2010 connected to the generative media module 1514 can result in different content versions 1910 being produced, such that the particular generative media output will depend on which NFTs 2010 are used as inputs.

In some examples, additional data associated with the generative media playback system 2000 can be stored via the blockchain layer 1920. For example, the listening history of the user 2008 can be stored to the blockchain layer 1920 to provide an immutable record of listening history. This can include listening history of generative media content or non-generative content (e.g., standard pre-recorded audio tracks or other content). In some instances, “followers” of a particular user 2008 can subscribe to that user's listening history by accessing the data stored via the blockchain layer 1920. As blockchains are typically permissionless and transparent, followers may be free to access the listening history (or other content data associated with a particular network address). In yet another example, a follower may subscribe to the generative media content of a particular user 2008, such that while the generative media content for the user 2008 is created dynamically based on the various inputs, this same media content can be available for other followers to enjoy.

Consider, for example, an artist who wants to create a particular soundscape using a generative media module 1514. The artist's fans may listen to the soundscape in real-time or nearly real-time via blockchain data. In some instances, the followers may utilize their own local generative media modules 1514 (or those running on other devices) that then use inputs, pointers, or other data from the artist's generative media module 1514 to produce corresponding generative media content. In at least some examples, such local generative media modules 1514 may also utilize additional local inputs (e.g., particular playback device characteristics, local sensor data, etc.) such that the artist's generative media content is merged with that produced by the user's own local generative media module 1514 to produce somewhat altered generative media content that nonetheless reflects the artist's intention. Optionally, an artist's followers may be required to hold a particular NFT or other token to access that artist's generative media content. In yet another example, a particular curated playlist or radio station may be accessible only to users who hold a particular NFT or token.

h. Example Methods for Generation and Playback of Generative Audio

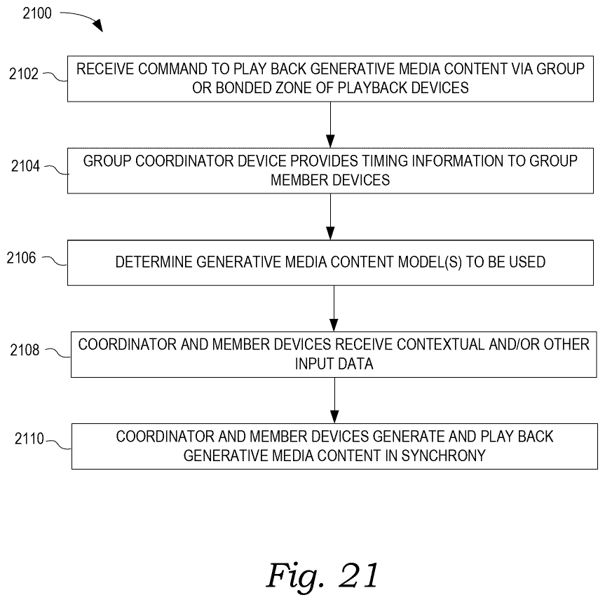

FIGS. 21-26 are flow diagrams of example methods for playing back generative audio content via multiple discrete playback devices. The methods 2100, 2200, 2300, 2400, 2500, 2600 can be implemented by any of the devices or systems described herein, or any other devices or systems now known or later developed.

Various examples of the methods 2100, 2200, 2300, 2400, 2500, 2600 include one or more operations, functions, or actions illustrated by blocks. Although the blocks are illustrated in sequential order, these blocks may also be performed in parallel, and/or in a different order than the order disclosed and described herein. Also, the various blocks may be combined into fewer blocks, divided into additional blocks, and/or removed based upon a desired implementation.

In addition, for the methods 2100, 2200, 2300, 2400, 2500, 2600, and for other processes and methods disclosed herein, the flowcharts show functionality and operation of possible implementations of some examples. In this regard, each block may represent a module, a segment, or a portion of program code, which includes one or more instructions executable by one or more processors for implementing specific logical functions or steps in the process. The program code may be stored on any type of computer readable medium, for example, such as a storage device including a disk or hard drive. The computer readable medium may include non-transitory computer readable media, for example, such as tangible, non-transitory computer-readable media that stores data for short periods of time like register memory, processor cache, and Random-Access Memory (RAM). The computer readable medium may also include non-transitory media, such as secondary or persistent long-term storage, like read only memory (ROM), optical or magnetic disks, compact disc read only memory (CD-ROM), for example. The computer readable media may also be any other volatile or non-volatile storage systems. The computer readable medium may be considered a computer readable storage medium, for example, or a tangible storage device. In addition, for the methods and for other processes and methods disclosed herein, each block in FIGS. 21-26 may represent circuitry that is wired to perform the specific logical functions in the process.

With reference to FIG. 21, the method 2100 begins at block 2102, which involves receiving a command to play back generative media content via a group or bonded zone of playback devices. Such a command can be received via, for example a control device 130 or other suitable user input.

At block 2104, the method 2100 involves a group coordinator device providing timing information to generative group member devices. The timing information can include contextual timing data (e.g., time data associated with sensor input or other user input), generative media playback timing data (e.g., time stamps and synchronization data to facilitate synchronous playback of generative media), and/or media content stream timing data based on a common clock.

At block 2106, the method optionally includes determining generative media content model(s) to be used to produce generative media. Such models can be implemented in, for example, the media content module(s) 1514 described above with respect to FIGS. 15-19. In some examples, each of the member devices can utilize the same or substantially the same generative media content models, while in other cases some or all of the member devices can utilize generative media content models that differ from one another. For example, a first generative media content model can produce rhythmic beats, while a second generative media content model can produce ambient nature sounds. When played back concurrently, the generative audio produced by these different generative media content models can produce a pleasing listener experience for the users. In some examples, the selection of a particular generative media content model can itself be based on one more input parameters, such as device capabilities, device location, number of users present, user sensor data, etc.

In block 2108, the method 2100 includes the coordinator device and member device(s) receiving contextual and/or other input data. For example, the input data can include sensor data, user inputs, context data, or any other relevant data that can be utilized as an input for a generative media content model.

The method 2100 continues in block 2110 with the coordinator and member devices generating and playing back generative media content in synchrony.

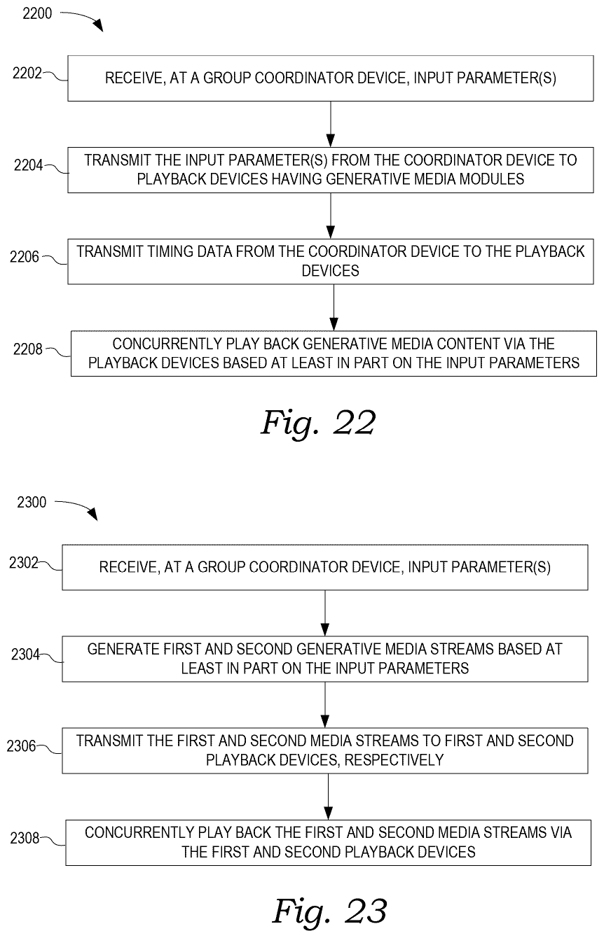

FIG. 22 illustrates another method 2200 for playing back generative audio content via multiple playback devices. The method 2200 begins in block 2202 with receiving, at a group coordinator device, one or more input parameters. As noted previously, the input parameters can include sensor data, user input, contextual data, or any other input that can be used by a generative media module to produce generative audio for playback.

In block 2204, the coordinator device transmits the input parameters to one or more discrete playback devices having generative media modules thereon. For example, the coordinator device can obtain sensor data and other input parameters and transmit these to a plurality of discrete playback devices within an environment or even distributed among multiple environments. In some examples, these input parameters can include features of the generative content model(s) themselves, for example providing instructions to update the generative media modules stored by locally by one or more of the discrete playback devices.

In block 2206, the method involves transmitting timing data from the coordinator device to the playback devices. The timing data can include, for example clock data or other synchronization signals configured to facilitate coordination of the production of generative media content as well as synchronous playback of that generative media content via the discrete playback devices.

The method 2200 continues in block 2208 with concurrently playing back generative media content via the playback devices based at least in part on the input parameters. As discussed previously, the various playback devices may play back the same generative audio or each may play back distinct generative audio that, when played back synchronously, produces a desired psychoacoustic effect for the users present.

In the example of FIG. 22, the generative media content can be produced locally by discrete playback devices, which each play back creating their own generative audio content in parallel with one another. In an alternative method 2300 shown in FIG. 23, the generative media content is produced at the coordinator device, which then transmits the generative media content along with timing data to the discrete playback devices for synchronous playback.

In block 2302, the method 2300 involves receiving, at a group coordinator device, one or more input parameters. Examples of the input parameters are described elsewhere herein, and include sensor data, user input, contextual data, or any other input that can be used by a generative media module to produce generative audio for playback.

In block 2304, the coordinator device generates first and second generative media streams based at least in part on the input parameters, and in block 2306 the first and second media streams are transmitted to first and second discrete playback devices, respectively. For example, the coordinator device can generate two streams that form different channels of generative audio, for example with a left channel to be played back by a first playback device and a corresponding right channel to be played back by a second playback device. Additionally or alternatively, the two streams can be distinct audio tracks that nonetheless can be played back synchronously, such as rhythmic beats in one stream and ambient nature sounds in the other stream. Multiple other variations are possible. Although this example describes two streams for two playback devices, in various other examples there may be one stream or more than two streams that can be provided to any number of playback devices for synchronous playback. In at least some examples, one or more of the playback devices can be positioned in different environments far apart from one another (e.g., in different households, different cities, etc.).

In block 2308, the first playback device plays back the first generative media stream and the second playback device concurrently plays back the second generative media stream. In some examples, this concurrent playback can be facilitated by use of timing data received from the coordinator device.

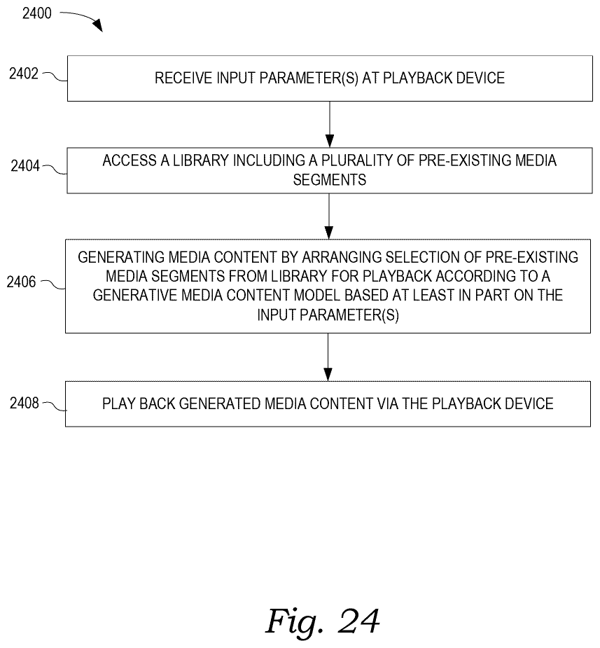

FIG. 24 illustrates another example method 2400 for generation and playback of generative media content. As described above, it can be beneficial to perform at least a portion of the processing required to produce generative media content using one or more remote computing devices (e.g., cloud-based servers) so as to reduce the computational demands placed on local playback devices and/or to perform operations that would not be feasible using the components of the local playback devices. The method 2400 begins in block 2402 with receiving, at a playback device, one or more input parameters. As noted previously, the input parameters can include sensor data, user input, contextual data, or any other input that can be used by a generative media module to produce generative audio for playback.

In block 2404, the method 2400 involves accessing a library that includes a plurality of pre-existing media segments. For example, a plurality of discrete media segments (e.g., audio tracks) can be stored on the playback device, and can be arranged and/or mixed for playback according to a generative content model. Additionally or alternatively, the library can be stored on one or more remote computing devices, with individual media segments being transmitted from the remote computing device(s) to the playback device for playback.

The method 2400 continues in block 2406 with generating media content by arranging a selection of the pre-existing media segments from the library for playback according to a generative media content model and based, at least in part, on the input parameters. As described elsewhere herein, a generative media content model can receive the one or more input parameters as an input. Based on the input, and using the generative media content model, particular generative media content can be output. Among examples, the generative media content can include an arrangement of the pre-existing media segments, for example arranging them in a particular order, with or without overlap between the particular media segments, and/or with additional processing or mixing steps performed to produce the desired output.

In block 2408, the playback device plays back the generated media content. In various examples, this playback can be performed concurrently and/or synchronously with additional playback devices.

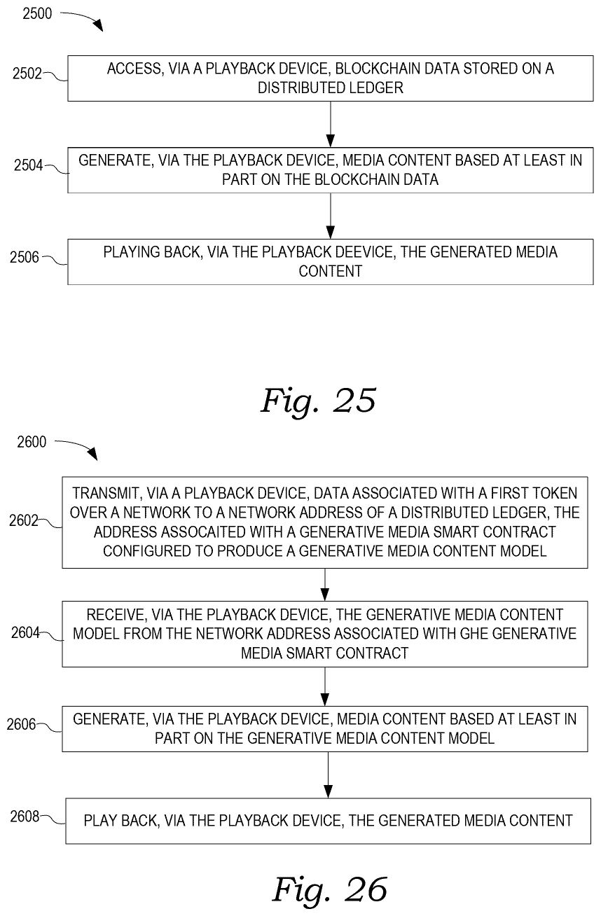

FIG. 25 illustrates another example method 2500 for generation and playback of generative media content. As described above, it can be beneficial to incorporate or rely upon blockchain data to produce generative media content. The method 2500 begins in block 2502 with accessing, via a playback device, blockchain data stored via a distributed ledger. The distributed ledger can be a public blockchain such as Ethereum, Bitcoin, Solana, etc., or may optionally be a private or semi-private blockchain or non-blockchain ledger. The blockchain data can include one or more pre-existing media segments or other seeds to be used in producing generative media content. In some examples, such data is stored directly on the blockchain itself, while in other instances the blockchain can store a pointer (e.g., a URL or URI) that directs to the stored location of the media segments or other seed data. Optionally, the blockchain data takes the form of one or more non-fungible tokens (NFTs).

The method 2500 continues in block 2504 with generating, via the playback device, media content based at least in part on the blockchain data. In some examples, this generation can include accessing a library of pre-existing media segments that is stored on the playback device or other suitable storage location (e.g., remote server, other devices on a local network, etc.). In some instances, these media segments can be retrieved from the blockchain or other remote location and stored via the playback device. The playback device may then arrange a selection of pre-existing media segments from the library for playback according to a generative media content model. This selection can be based at least in part on the blockchain data. For example, as described elsewhere herein, the generative media content model may communicate with a smart contract or a decentralized autonomous organization (DAO) in a manner that affects the particular generative media content that is output by the model. In some instances, particular NFTs or other tokens can affect the output of the generative media content model. Such NFTs or other tokens may, in some instances, be used in combination, such that the particular combination of NFTs or other tokens produces a unique output via the generative media content model. In at least some instances, two or more blockchains can be utilized concurrently in this manner (e.g., the generative media content model can vary the output based on a user holding both a first NFT on the Solana network and a second NFT on the Ethereum network). In block 2506, the method 2500 involves playing back, via the playback device, the generated media content.

FIG. 26 illustrates another example method 2600 for generation and playback of generative media content. As noted above, smart contracts or other self-executing code can be used to produce, store, and playback generative media content. The method 2600 begins in block 2602 with transmitting, via a playback device, data associated with a first token over a network to a network address of a distributed ledger. The address can be associated with a generative media smart contract configured to produce a generative media content model. In some examples, the first token can be an NFT, and optionally a plurality of such tokens can be transmitted to the smart contract address.

In block 2604, the method 2600 involves receiving, via the playback device, the generative media content model from the network address associated with the generative media smart contract. For example, when the smart contract is executed, it can produce a particular generative media content model that is based at least in part on the data associated with the first token. This generative media content model can then be provided to a user for generation of novel media content that is tailored based on the first token data. In addition to the first token data, the smart contract may also produce different outputs based on other input parameters as described elsewhere (e.g., sensor data, playback device characteristic data, playback device state, user listening history data, etc.), provided that such data is provided to the smart contract address. Additionally or alternatively, the generative media content model provided to the user can output different media content based on one or more of these other input parameters.

Next, in block 2606, the playback device generates media content based at least in part on the generative media content model. In some examples, this generation can include accessing a library of pre-existing media segments that is stored on the playback device or other suitable storage location (e.g., remote server, other devices on a local network, etc.). The playback device may then arrange a selection of pre-existing media segments from the library for playback according to the generative media content model. In block 2608, the method 2600 involves playing back, via the playback device, the generated media content.

Various examples of generative media playback are described herein. One of ordinary skill in the art will understand that a wide variety of different generative media modules, algorithms, inputs, sensor data, and playback device configurations are contemplated and may be used in accordance with the present technology.

### VIII. Conclusion

The above discussions relating to playback devices, controller devices, playback zone configurations, and media content sources provide only some examples of operating environments within which functions and methods described below may be implemented. Other operating environments and configurations of media playback systems, playback devices, and network devices not explicitly described herein may also be applicable and suitable for implementation of the functions and methods.

The description above discloses, among other things, various example systems, methods, apparatus, and articles of manufacture including, among other components, firmware and/or software executed on hardware. It is understood that such examples are merely illustrative and should not be considered as limiting. For example, it is contemplated that any or all of the firmware, hardware, and/or software aspects or components can be embodied exclusively in hardware, exclusively in software, exclusively in firmware, or in any combination of hardware, software, and/or firmware. Accordingly, the examples provided are not the only ways) to implement such systems, methods, apparatus, and/or articles of manufacture.

Additionally, references herein to “embodiment” means that a particular feature, structure, or characteristic described in connection with the embodiment can be included in at least one example embodiment of an invention. The appearances of this phrase in various places in the specification are not necessarily all referring to the same embodiment, nor are separate or alternative embodiments mutually exclusive of other embodiments. As such, the embodiments described herein, explicitly and implicitly understood by one skilled in the art, can be combined with other embodiments.

The specification is presented largely in terms of illustrative environments, systems, procedures, steps, logic blocks, processing, and other symbolic representations that directly or indirectly resemble the operations of data processing devices coupled to networks. These process descriptions and representations are typically used by those skilled in the art to most effectively convey the substance of their work to others skilled in the art. Numerous specific details are set forth to provide a thorough understanding of the present disclosure. However, it is understood to those skilled in the art that certain embodiments of the present disclosure can be practiced without certain, specific details. In other instances, well known methods, procedures, components, and circuitry have not been described in detail to avoid unnecessarily obscuring aspects of the embodiments. Accordingly, the scope of the present disclosure is defined by the appended claims rather than the foregoing description of embodiments.

When any of the appended claims are read to cover a purely software and/or firmware implementation, at least one of the elements in at least one example is hereby expressly defined to include a tangible, non-transitory medium such as a memory, DVD, CD, Blu-ray, and so on, storing the software and/or firmware.

The disclosed technology is illustrated, for example, according to various examples described below. Various examples of examples of the disclosed technology are described as numbered examples (1, 2, 3, etc.) for convenience. These are provided as examples and do not limit the disclosed technology. It is noted that any of the dependent examples may be combined in any combination, and placed into a respective independent example. The other examples can be presented in a similar manner.

Example 1. A media playback system comprising: one or more playback devices; at least one network interface; at least one processor; and data storage having instructions stored thereon that, when executed by the one or more processors, cause the media playback system to perform operations comprising: receiving, via the at least one network interface, one or more moodscape input parameters; based on the one or more moodscape input parameters and one or more system characteristics of the media playback system, mapping the one or more moodscape input parameters to one or more playback device outputs; and causing the one or more playback devices of the media playback system to play back content based on the playback device outputs.

Example 2. The media playback system of any one of the preceding Examples, wherein the one or more moodscape input parameters comprise one or more of: indications of a provider mood, emotional state, or physical state (e.g., physiological sensor data such as brainwave data, heart rate, respiratory rate, perspiration, body temperature, voice analysis, sleep/wake determination); indications of provider sensor or contextual data (e.g., ambient conditions associated with provider such as temperature, humidity, lighting conditions, colors, luminance, ambient sounds, weather conditions, scents, etc.); provider-selected media content (e.g., audio, video, extended reality (AR/MR/VR) content); or provider-generated content (e.g., ambient sounds, provider spoken word audio, provider point of view video).

Example 3. The media playback system of any one of the preceding Examples, wherein the one or more moodscape input parameters comprise a predefined set of parameters available for on-demand playback.

Example 4. The media playback system of any one of the preceding Examples, wherein the one or more moodscape input parameters are based on real-time data regarding remote activity (e.g., provider activity such as provider's current audio stream).

Example 5. The media playback system of any one of the preceding Examples, wherein the operations further comprise, before receiving the one or more moodscape input parameters, transmitting, via the at least one network interface, a user request for a particular moodscape.

Example 6. The media playback system of any one of the preceding Examples, wherein the operations further comprise, before receiving the user request for a particular moodscape, presenting a plurality of available moodscapes to a user for selection, the plurality of available moodscapes including the particular moodscape requested by the user.

Example 7. The media playback system of any one of the preceding Examples, wherein the plurality of available moodscapes are based on one or more of: indications of a user mood, emotional state, or physical state (e.g., physiological sensor data such as brainwave data, heart rate, respiratory rate, perspiration, body temperature, voice analysis, sleep/wake determination); indications of user sensor or contextual data (e.g., ambient conditions associated with the user such as temperature, humidity, lighting conditions, colors, luminance, ambient sounds, weather conditions, scents, etc.); user media content information (e.g., user listening/viewing history, favorited media content, etc.); or user voice input.

Example 8. The media playback system of any one of the preceding Examples, wherein mapping the one or more moodscape input parameters to the one or more playback device outputs comprises identifying available playback devices of the media playback system (e.g., audio playback devices, video playback devices, lighting devices, scent-producing devices, temperature-control devices, and associated characteristics of these devices).

Example 9. The media playback system of any one of the preceding Examples, wherein mapping the one or more moodscape input parameters to the one or more playback device outputs comprises applying one or more user-provided restrictions (e.g., no adult content, excluding certain lights/scents, volume restrictions, etc.).

Example 10. The media playback system of any one of the preceding Examples, wherein mapping the one or more moodscape input parameters to the one or more playback device outputs comprises applying one or more contextual restrictions (e.g., based on time of day, room/location of particular playback devices, etc.).

Example 11. A method, performed by a media playback system comprising one or more playback devices, the method comprising: receiving, via at least one network interface, one or more moodscape input parameters; based on the one or more moodscape input parameters and one or more system characteristics of the media playback system, mapping the one or more moodscape input parameters to one or more playback device outputs; and causing the one or more playback devices of the media playback system to play back content based on the playback device outputs.

Example 12. The method of any one of the preceding Examples, wherein the one or more moodscape input parameters comprise one or more of: indications of a provider mood, emotional state, or physical state (e.g., physiological sensor data such as brainwave data, heart rate, respiratory rate, perspiration, body temperature, voice analysis, sleep/wake determination); indications of provider sensor or contextual data (e.g., ambient conditions associated with provider such as temperature, humidity, lighting conditions, colors, luminance, ambient sounds, weather conditions, scents, etc.); provider-selected media content (e.g., audio, video, extended reality (AR/MR/VR) content); or provider-generated content (e.g., ambient sounds, provider spoken word audio, provider point of view video).

Example 13. The method of any one of the preceding Examples, wherein the one or more moodscape input parameters comprise a predefined set of parameters available for on-demand playback.

Example 14. The method of any one of the preceding Examples, wherein the one or more moodscape input parameters are based on real-time data regarding remote activity (e.g., provider activity such as provider's current audio stream).

Example 15. The method of any one of the preceding Examples, further comprising, before receiving the one or more moodscape input parameters, transmitting, via the at least one network interface, a user request for a particular moodscape.

Example 16. The method of any one of the preceding Examples, further comprising, before receiving the user request for a particular moodscape, presenting a plurality of available moodscapes to a user for selection, the plurality of available moodscapes including the particular moodscape requested by the user.

Example 17. The method of any one of the preceding Examples, wherein the plurality of available moodscapes are based on one or more of: indications of a user mood, emotional state, or physical state (e.g., physiological sensor data such as brainwave data, heart rate, respiratory rate, perspiration, body temperature, voice analysis, sleep/wake determination); indications of user sensor or contextual data (e.g., ambient conditions associated with the user such as temperature, humidity, lighting conditions, colors, luminance, ambient sounds, weather conditions, scents, etc.); user media content information (e.g., user listening/viewing history, favorited media content, etc.); or user voice input.

Example 18. The method of any one of the preceding Examples, wherein mapping the one or more moodscape input parameters to the one or more playback device outputs comprises identifying available playback devices of the media playback system (e.g., audio playback devices, video playback devices, lighting devices, scent-producing devices, temperature-control devices, and associated characteristics of these devices).

Example 19. The method of any one of the preceding Examples, wherein mapping the one or more moodscape input parameters to the one or more playback device outputs comprises applying one or more user-provided restrictions (e.g., no adult content, excluding certain lights/scents, volume restrictions, etc.).

Example 20. The method of any one of the preceding Examples, wherein mapping the one or more moodscape input parameters to the one or more playback device outputs comprises applying one or more contextual restrictions (e.g., based on time of day, room/location of particular playback devices, etc.).

Example 21. Tangible, non-transitory computer-readable medium storing instructions that, when executed by one or more processors of a media playback system, cause the media playback system to perform operations comprising: receiving, via at least one network interface, one or more moodscape input parameters; based on the one or more moodscape input parameters and one or more system characteristics of the media playback system, mapping the one or more moodscape input parameters to one or more playback device outputs; and causing one or more playback devices of the media playback system to play back content based on the playback device outputs.

Example 22. The tangible, non-transitory computer-readable medium of any one of the preceding Examples, wherein the one or more moodscape input parameters comprise one or more of: indications of a provider mood, emotional state, or physical state (e.g., physiological sensor data such as brainwave data, heart rate, respiratory rate, perspiration, body temperature, voice analysis, sleep/wake determination); indications of provider sensor or contextual data (e.g., ambient conditions associated with provider such as temperature, humidity, lighting conditions, colors, luminance, ambient sounds, weather conditions, scents, etc.); provider-selected media content (e.g., audio, video, extended reality (AR/MR/VR) content); or provider-generated content (e.g., ambient sounds, provider spoken word audio, provider point of view video).

Example 23. The tangible, non-transitory computer-readable medium of any one of the preceding Examples, wherein the one or more moodscape input parameters comprise a predefined set of parameters available for on-demand playback.

Example 24. The tangible, non-transitory computer-readable medium of any one of the preceding Examples, wherein the one or more moodscape input parameters are based on real-time data regarding remote activity (e.g., provider activity such as provider's current audio stream).

Example 25. The tangible, non-transitory computer-readable medium of any one of the preceding Examples, wherein the operations further comprise, before receiving the one or more moodscape input parameters, transmitting, via the at least one network interface, a user request for a particular moodscape.

Example 26. The tangible, non-transitory computer-readable medium of any one of the preceding Examples, wherein the operations further comprise, before receiving the user request for a particular moodscape, presenting a plurality of available moodscapes to a user for selection, the plurality of available moodscapes including the particular moodscape requested by the user.

Example 27. The tangible, non-transitory computer-readable medium of any one of the preceding Examples, wherein the plurality of available moodscapes are based on one or more of: indications of a user mood, emotional state, or physical state (e.g., physiological sensor data such as brainwave data, heart rate, respiratory rate, perspiration, body temperature, voice analysis, sleep/wake determination); indications of user sensor or contextual data (e.g., ambient conditions associated with the user such as temperature, humidity, lighting conditions, colors, luminance, ambient sounds, weather conditions, scents, etc.); user media content information (e.g., user listening/viewing history, favorited media content, etc.); or user voice input.

Example 28. The tangible, non-transitory computer-readable medium of any one of the preceding Examples, wherein mapping the one or more moodscape input parameters to the one or more playback device outputs comprises identifying available playback devices of the media playback system (e.g., audio playback devices, video playback devices, lighting devices, scent-producing devices, temperature-control devices, and associated characteristics of these devices).

Example 29. The tangible, non-transitory computer-readable medium of any one of the preceding Examples, wherein mapping the one or more moodscape input parameters to the one or more playback device outputs comprises applying one or more user-provided restrictions (e.g., no adult content, excluding certain lights/scents, volume restrictions, etc.).

Example 30. The tangible, non-transitory computer-readable medium of any one of the preceding Examples, wherein mapping the one or more moodscape input parameters to the one or more playback device outputs comprises applying one or more contextual restrictions (e.g., based on time of day, room/location of particular playback devices, etc.).

1. A media playback system comprising:
one or more playback devices in a first environment;
at least one network interface;
at least one processor; and
data storage having instructions stored thereon that, when executed by the at least one processor, cause the media playback system to perform operations comprising:
receiving, via the at least one network interface over a wide area network, one or more input parameters wherein a first parameter of the one or more input parameters is indicative of an emotional state or a physical state of a provider in a second environment remote from the first environment, and wherein a second parameter of the one or more input parameters is associated with a characteristic of the second environment;
mapping, based on the first and second parameters, the one or more input parameters to operational capabilities associated with the one or more playback devices;
generating, based on the mapped operational capabilities, content that at least partially simulates the second environment; and
causing at least one of the one or more playback devices to play back the generated content in the first environment.

2. The media playback system of claim 1, wherein the one or more input parameters comprise one or more of:
indications of a provider mood, emotional state, or physical state;
indications of provider sensor or contextual data;
provider-selected media content; or
provider-generated content.

3. The media playback system of claim 1, wherein the one or more input parameters comprise a predefined set of parameters available for on-demand playback.

4. The media playback system of claim 1, wherein the one or more input parameters are based on real-time data regarding remote activity.

5. The media playback system of claim 1, wherein the operations further comprise, before receiving the one or more input parameters, transmitting, via the at least one network interface, a user request for a particular moodscape.

6. The media playback system of claim 5, wherein the operations further comprise, before receiving the user request for a particular moodscape, presenting a plurality of available moodscapes to a user for selection, the plurality of available moodscapes including the particular moodscape requested by the user.

7. The media playback system of claim 6, wherein the plurality of available moodscapes are based on one or more of:
indications of a user mood, emotional state, or physical state;
indications of user sensor or contextual data;
user media content information; or
user voice input.

8. The media playback system of claim 1, wherein mapping the one or more input parameters to operational capabilities associated with the one or more playback devices comprises identifying available playback devices of the media playback system.

9. The media playback system of claim 1, wherein mapping the one or more input parameters to operational capabilities associated with the one or more playback devices comprises applying one or more user-provided restrictions.

10. The media playback system of claim 1, wherein mapping the one or more input parameters to operational capabilities associated with the one or more playback devices comprises applying one or more contextual restrictions.

11. A method, performed by a media playback system comprising one or more playback devices in a first environment, the method comprising:
receiving, via at least one network interface over a wide area network, one or more input parameters, wherein a first parameter of the one or more input parameters is indicative of an emotional state or a physical state of a provider in a second environment remote from the first environment, and wherein a second parameter of the one or more input parameters is associated with a characteristic of the second environment;
mapping, based on the e scape first and second input parameters, the one or more input parameters to operational capabilities associated with the one or more playback devices;
generating, based on the mapped operational capabilities, content that at least partially simulates the second environment; and
causing at least one of the one or more playback devices to play back the generated content in the first environment.

12. The method of claim 11, wherein the one or more input parameters comprise one or more of:
indications of a provider mood, emotional state, or physical state;
indications of provider sensor or contextual data;
provider-selected media content; or
provider-generated content.

13. The method of claim 11, wherein the one or more input parameters comprise a predefined set of parameters available for on-demand playback.

14. The method of claim 11, wherein the one or more input parameters are based on real-time data regarding remote activity.

15. The method of claim 11, further comprising:
before receiving the one or more input parameters, transmitting, via the at least one network interface, a user request for a particular moodscape.

16. (canceled)

17. (canceled)

18. (canceled)

19. (canceled)

20. (canceled)

21. Tangible, non-transitory computer-readable media storing instructions that, when executed by one or more processors of a media playback system, cause the media playback system comprising one or more playback devices in a first environment to perform operations comprising:
receiving, via at least one network interface over a wide area network, one or more input parameters, wherein a first parameter of the one or more input parameters is indicative of an emotional state or a physical state of a provider in a second environment remote from the first environment, and wherein a second parameter of the one or more input parameters is associated with a characteristic of the second environment;
mapping, based on the first and second input parameters, the one or more input parameters to operational capabilities associated with the one or more playback devices;
generating based on the mapped operational capabilities, content that at least partially simulates the second environment; and
causing at least one of the one or more playback devices to play back the generated content in the first environment.

22. The tangible, non-transitory computer-readable median media of claim 21, wherein the one or more moodscape-input parameters comprise one or more of:
indications of a provider mood, emotional state, or physical state;
indications of provider sensor or contextual data;
provider-selected media content; or
provider-generated content.

23. The tangible, non-transitory computer-readable media of claim 21, wherein the one or more input parameters comprise a predefined set of parameters available for on-demand playback.

24. The tangible, non-transitory computer-readable media of claim 21, wherein the one or more input parameters are based on real-time data regarding remote activity.

25. The tangible, non-transitory computer-readable media of claim 21, wherein the operations further comprise, before receiving the one or more input parameters, transmitting, via the at least one network interface, a user request for a particular moodscape.

26. (canceled)

27. (canceled)

28. (canceled)

29. (canceled)

30. (canceled)
